(19) United States
(12) Patent Application Publication
(10) Pub. No.: US 2019/0159457 A1
(43) Pub. Date: May 30, 2019

(54) Combinatorial Compositions of Benzoxaboroles and Biologic Agents

(71) Applicant: Boragen, Inc., Durham, NC (US)

(72) Inventors: Chun Yu Liu, Durham, NC (US); Megan E. Lyman, Raleigh, NC (US); Stephen X. Yang, Durham, NC (US)

(21) Appl. No.: 16/205,416

(22) Filed: Nov. 30, 2018

Related U.S. Application Data
(60) Provisional application No. 62/593,220, filed on Nov. 30, 2017.

(51) Int. Cl. A01N 55/08; A01N 63/02

(52) U.S. Cl. CPC A01N 55/08; A01N 63/02

(57) ABSTRACT

Described herein are combinatorial compositions comprising a synthetic compound and a biological agent for beneficial effect. The synthetic compound may be a leucyl-tRNA synthetase inhibitor. The synthetic compound also may be a benzoxaborole. The combinatorial compositions may have a synergistic effect. The combinatorial composition has at least one biological agent, which may have a controlling or stimulatory effect and may be selected from a modified or un-modified microorganism, metabolite, or substituent thereof. The combinatorial composition may further comprise a second modified or un-modified microorganism, metabolite or substituent thereof, or energy source for either or both microorganism(s). Also described are methods for promoting plant performance and/or curatively or preventively controlling insects, nematodes, microorganisms, or phytopathogens on or in an animal or a plant, plant parts, harvested fruits, or vegetables.

### CROSS-REFERENCE TO RELATED APPLICATION

This application claims the benefit of U.S. Provisional Patent Application No. 62/593,220, filed on Nov. 30, 2017.

### TECHNICAL FIELD

The present invention relates to combinatorial compositions comprising a compound that is a leucyl-tRNA synthetase inhibitor and a biological agent for beneficial effect. The invention also relates to combinatorial compositions comprising a benzoxaborole and a biologic agent for beneficial effect. In some embodiments, the combinatorial compositions have a synergistic effect. In other embodiments, the combinatorial compositions may also have an additive effect. The combinatorial composition has at least one biological agent, which may have a controlling or stimulatory effect and may be selected from a modified or un-modified microorganism, metabolite, or substituent thereof. The composition comprises a compound, which may be an oxaborole, preferably a benzoxaborole. Further, the combinatorial composition may further comprise a second modified or un-modified microorganism, metabolite or substituent thereof, or energy source for either or both microorganism(s). Moreover, the invention relates to a method for promoting plant performance and/or curatively or preventively controlling insects, nematodes, microorganisms, fungi, or phytopathogens on or in an animal or a plant, plant parts, harvested fruits, or vegetables. The combinatorial compositions and methods described herein may be used in the treatment of a seed.

### BACKGROUND

Boron is a unique, and often misconstrued, element of the periodic table due to its powerfully effective and potentially highly toxicological properties. Initial innovation within boron chemistry was impaired due to the incapacity to prepare pure boron, especially in its crystalline form. Early characterization of boron-containing molecules was further stymied by contamination of the crystalline form by aluminum. While the use of boron, in the form of boric acid, is well known for its use in agriculture, the construction and characterization of more complex boron-containing molecules that are both safe and effective has been relatively unexplored. Only recently has boron been explored by skilled organo-metallic chemists for novel and useful applications across human and animal health and agriculture. For example, boron-containing molecules such as oxaboroles and benzoxaboroles demonstrate use as antimicrobials, antiparasitics, and antifungals. (See Publication No. WO2016128949 (antimicrobial), U.S. Pat. No. 9,617,285 (antiparasitic), and Publication No. WO2016164589 (antifungal)).

The creation and development of such boron-containing compounds has proven to be unpredictable. Even in the hands of experts, boron containing scaffolds present compounds that must be tested from toxicology, mode of action, and activity perspective. Moreover, where target compounds are made and tested, formulation of those compounds can be laborious due to issues such as pKa, pH, and solubility. The duplicitous nature of boron-containing compounds places their activity on a broad continuum; including those that are highly toxic, and those that are exceptionally benign. Thus, creation of novel and useful boron-containing compounds requires skilled attention to design, creation, formulation, as well as thoughtful screening to determine toxicity, mode of action, and efficacy.

Moreover, boron's ability to covalently bond with other molecules makes it both attractive and difficult to work with. Boron-containing molecules traditionally have suffered in creating commercially viable products due to synthetic and pharmacological uncertainties. However, these characteristics can be leveraged, in the right hands, to make great impact in the areas of crop protection, animal and human health.

Additionally, previous literature teaches the unique ability of boron-containing molecules to enhance efficacy of known active ingredients. (See, e.g. U.S. Pat. No. 9,737,075). While this synergy has been noted amongst other synthetic chemistries, any putative synergistic effect between boron-chemistry and biological agents is unknown. Moreover, the sometimes-toxic properties of boron-containing compounds may lead those of skill to predict that combinatorial compositions containing a boron-containing compound and a biologic may be impossible. For example, many boron-containing compounds exhibit antimicrobial and antifungal activity.

Within the field of plant health, fungal, bacterial, insect, and nematode plant pathogens lead to a wide range of diseases (e.g., rusts, spots, downy mildews, blasts, blotches, stripes, rots, smuts, pathogenic nematodes, erwinia, insects, etc.) across all crops, resulting in massive losses. Current solutions are limited; providing only a partial level of control (as with resistant cultivars), or adding significant costs relative to currently available, conventional, and outdated chemical pesticides. While breeding for resistance traits to specific crop/pathogen combinations in germplasm offers some hope in circumventing the problem, it is widely recognized that novel antifungals must be developed.

Antifungals, insecticides, and pesticides are costly to both purchase and use. In addition, they are often toxic and/or otherwise detrimental to off-target animals and/or vegetation near the site of application including runoff, thereby affecting the watershed. Moreover, many antifungals, insecticides, and pesticides lose efficacy over time, concomitantly with pathogens becoming resistant to treatment. It is beneficial to farmers, consumers, and the surrounding communities to use the minimum required dose of antifungals, insecticides, and/or pesticides to achieve maximum crop yield, while mitigating onset of resistance and environmental detriment.

The microbial environment of the soil and plant greatly impacts growth, susceptibility to, and control of, infection. As previously described, the addition of a biologic to a synthetic compound may provide a synergistic effect. (See e.g., U.S. Pat. No. 9,380,787). Such combinations are advantageous as they confer broad spectrum anti-pathogenic activity and may delay development of resistance in the plant and/or pathogen. However, it is just as well known that these types of combinations may detrimentally impact the effectiveness of both the synthetic compound or the biologic. The inability to predict superadditive combinations presents difficulty in the identification and development of such combinatorial compositions.

In animal health, ectoparasites and endoparsites such as fleas, lice, flies, mosquitoes, ticks, helminths, nematodes, and mites are problematic for man and animal alike. Such ecto- and endo parasites seriously impact productivity of the domesticated animal industry by reducing weight gain, causing poor quality hide, wool, and meat, and in some cases resulting in death. Ecto- and endoparasites are also responsible, in part, for the spread of disease and discomfort in food and companion animals as well as humans. Ectoparasites, in particular, are known to harbor and transmit a variety of microbial pathogens, including bacteria, viruses and protozoan parasites, many of which are pathogenic to humans, other warm-blooded mammals, and birds.

The medical importance of ectoparasiticide infestations has prompted the development of reagents capable of controlling such infestations. Commonly encountered methods to control ectoparasiticide infestations, for example, have generally focused on use of insecticides, which are often unsuccessful or unsatisfactory for one or more of the following reasons: (1) failure of owner or applicator compliance (frequent administration is required); (2) behavioral or physiological intolerance of the animal to the pesticide product or means of administration; (3) the emergence of ectoparasites resistant to the reagent; and (4) negative impact on the environment and/or toxicity.

Parasitic infections in animals, including humans, are responsible for significant suffering and economic loss globally. Specifically, endoparasitic infections, and in particular helminthiases, caused by nematodes (roundworms including filarial worms) and flatworms (cestodes, or tapeworms and trematodes, or flukes), can inflict significant disease through infection of, and damage to various organ systems, for example, the gastrointestinal tract, the lymphatic system, various tissues, the liver, lungs, heart and the brain with sequelae that include neurological and metabolic dysfunction, nutritional deficiencies, delayed growth, loss of productivity, and death.

In agriculture and horticulture, some nematodes are considered beneficial; however, predatory nematodes such as cutworms and root-knot nematodes attack and damage various plant parts including leaves, stems and roots, inflicting significant economic losses to this industry as well. A very limited number of antihelminthic agents have been developed recently that appear to address some of these shortcomings, and include the aminoacetonitrile derivatives (e.g., monepantel); spiroindoles (e.g., derquantel); and cyclooctadepsipeptides (e.g., emodepside). However, there is still a pressing need for additional antihelminthic agents with superior and/or varying attributes in terms of spectrum and activity, physical-chemical properties and drug-ability profile, mammalian safety, and more diverse and convenient treatment options to ensure long-term viability.

Similar to the soil and plant microbiome, the animal microbiome's effect on health is well known. Known supplements that encourage the population of a beneficial consortia of microbes (e.g., anti-pathogenic activity, stimulation of innate immunity, healthy colonizers of a healthy microbiome) are well known in the art, as are therapeutics derived from the identification and characterization of healthy microbiomes.

Combinatorial compositions of synthetic compounds and microbial species are relatively unexplored. Oxaboroles have previously been shown to have strong activity as anti-microbials, nematocides, anti-parasitics, and anti-fungals. However, the putative positive effect of combining an oxaborole, especially a benzoxaborole, with beneficial microbial species for controlling pathogenic organisms is unknown. Moreover, because oxaboroles may be toxic to such pathogens, their ability to be non-pathogenic to beneficial microorganisms has not been contemplated. (See Jelle Mertens & Liesbeth Van Laer & Peter Salaets & Erik Smolders, Phytotoxic Doses of Boron in Contrasting Soils Depend on Soil Water Content).

In summary, oxaboroles have demonstrated efficacy as antimicrobials, including both fungicides and antibiotics. Because biologics typically show bacterial and fungal activity, one might suspect combining oxaborole and biologics would produce a nonbeneficial result, especially wherein the oxaborole inhibits or is lethal to the biologic. Thus, combining a biologic with an oxaborole to produce a synergistically effective anti-pathogenic (e.g., antibacterial, antifungal, antiparasitic, insecticidal) composition is both unexpected and novel.

It is an object of the present disclosure to provide combinatorial compositions exhibiting control (e.g., curative, inhibitive, ameliorative, and/or preventative activity) of phytopathogens, fungi, pathogenic bacteria and/or microorganisms, and the like.

There is a need for combinatorial compositions comprising benzoxaborole and modified or unmodified microorganisms (or substituents thereof), and/or the metabolites made from those modified or unmodified microorganisms having anti-pathogenic effects. As described herein, benzoxaborole and biologic agent combinatorial compositions provide an effective plant and/or animal therapeutic.

### BRIEF SUMMARY OF THE INVENTION

In a first aspect of the invention, a combinatorial composition comprises a compound that is a leucyl-tRNA synthetase inhibitor and at least one biological agent. The combinatorial composition is effective for treating or controlling a pathogen.

In a feature of this aspect, the at least one biological agent is selected from the group including: Acetobacteraceae, Bacillacaeae, Bacteriodaceae, Bifidobacteriaceae, Burkholderiaceae, Clostridiaceae, Enterobacteriaceae, Eubacteriaceae, Lactobacillaceae, Methanobacteriaceae, Nocardiaceae, Paenibacillaceae, Pasteuriaceae, Prevotellaceae, Pseudomonadaceae, Rhizobiaceae, Ruminococcaceae, Saccharomycetaceae, Sphingomonadaceae, Streptoccaceae, and/or Clavicipitaceae, Cordycipitaceae, Entomophthoraceae, Hypocreaceae, Ophiocorycipitaceae, Phaeophaeriaceae, Synchytriaceae, and Trichocomaceaeand metabolites or secondary metabolites produced therefrom.

In another feature of this aspect, the at least one biological agent is selected from the group consisting of Bacteroides (e.g., Alistipes, Prevotella, Paraprevotella, Parabacteroides, Odoribacter), Bacillus, Bifidobacterium, Clostridioides, Eubacterium, Escherichia, Faecalibacterium, Haemophilus, Heliobacter (H. pylori), Lactobacillus, Prevotella, Streptococcus/Lactococcus. Alternaria, Ampelomyces, Aspergillus, Aureobasidium, Beauveria, Candida, Isaria, Lecanicillium, Metarhizium, Phlebiopsis, Ulocladium, Phytophthora, or Fallopia and metabolites or secondary metabolites produced therefrom.

In a further feature of this aspect, the at least one biological agent is selected from Bacillacaeae and metabolites or secondary metabolites produced therefrom. Moreover, in an additional feature, the at least one biological agent comprises a metabolite or a secondary metabolite. In yet another feature, the compound is a benzoxaborole.

In a feature of this aspect, the combinatorial composition can be used for treating of controlling, wherein treating or controlling comprises providing a curative, inhibitive, ameliorative, reduction in, or preventative activity for phytopathogens, including fungi, bacteria. microorganisms, insects, and/or nematodes.

In an additional feature of this aspect, with regard to the combinatorial composition, a ratio of a minimum inhibitory concentration (MIC) of one of the compound or the biological agent alone to the MIC of the compound or the biological agent in the combinatorial composition is greater than about 1.6.

In a second aspect of the invention, a combinatorial composition comprises a benzoxaborole and at least one biological agent. With regard to this aspect, the benzoxaborole of the combinatorial composition can have a structure, I:

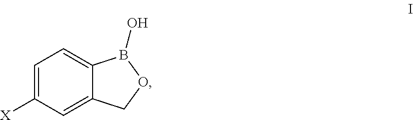

wherein X is a substituent having a Hammett sigma value for a meta substituent that is greater (more positive) than about −0.1, or a salt, agricultural chemical salt, pharmaceutical salt, stereoisomer, enantiomer, or tautomer thereof.

In a feature of this aspect, in the structure I, X is H, C1-C6 hydrocarbyl or a halogen or a salt, agricultural chemical salt, pharmaceutical salt, stereoisomer, enantiomer, or tautomer thereof.

In a further feature of this aspect, in the structure I, X is a halogen or hydrogen or a salt, agricultural chemical salt, pharmaceutical salt, stereoisomer, enantiomer, or tautomer thereof. With regard to this feature, the halogen can be Cl, Br, I, or F or a salt, agricultural chemical salt, pharmaceutical salt, stereoisomer, enantiomer, or tautomer thereof.

In another feature of this aspect, the at least one biological agent is selected from the group including: Acetobacteraceae, Bacillacaeae, Bacteriodaceae, Bifidobacteriaceae, Burkholderiaceae, Clostridiaceae, Enterobacteriaceae, Eubacteriaceae, Lactobacillaceae, Methanobacteriaceae, Nocardiaceae, Paenibacillaceae, Pasteuriaceae, Prevotellaceae, Pseudomonadaceae, Rhizobiaceae, Ruminococcaceae, Saccharomycetaceae, Sphingomonadaceae, Streptoccaceae, and/or Clavicipitaceae, Cordycipitaceae, Entomophthoraceae, Hypocreaceae, Ophiocorycipitaceae, Phaeophaeriaceae, Synchytriaceae, and Trichocomaceae, and a metabolites or a secondary metabolites produced therefrom.

In an additional feature of this aspect, the at least one biological agent is selected from the group including Bacteroides (e.g., Alistipes, Prevotella, Paraprevotella, Parabacteroides, Odoribacter), Bacillus, Bifidobacterium, Clostridioides, Eubacterium, Escherichia, Faecalibacterium, Haemophilus, Heliobacter (H. pylori), Lactobacillus, Prevotella, Streptococcus/Lactococcus. Alternaria, Ampelomyces, Aspergillus, Aureobasidium, Beauveria, Candida, Isaria, Lecanicillium, Metarhizium, Phlebiopsis, Ulocladium, Phytophthora, or Fallopia and metabolites or secondary metabolites produced therefrom.

In yet another feature of this aspect, the at least one biological agent is selected from the group consisting of a metabolite or secondary metabolite produced from one or more of the following: Acetobacteraceae, Bacillacaeae, Bacteriodaceae, Bifidobacteriaceae, Burkholderiaceae, Clostridiaceae, Enterobacteriaceae, Eubacteriaceae, Lactobacillaceae, Methanobacteriaceae, Nocardiaceae, Paenibacillaceae, Pasteuriaceae, Prevotellaceae, Pseudomonadaceae, Rhizobiaceae, Ruminococcaceae, Saccharomycetaceae, Sphingomonadaceae, Streptoccaceae, Propionibacteriaceae, Syncephalastraceae, Fucaceae, Caulerpaceae, Chlorellaceae, Durvillaeaceae, Lessoniaceae, Ulvaceae, Gelidiaceae, Gracilariaceae, Himanthaliaceae, Cystocloniaceae, Solieriaceae, Laminariaceae, Dictyotaceae, Sargassaceae, Spirulinaceae, and/or Clavicipitaceae, Cordycipitaceae, Entomophthoraceae, Hypocreaceae, Ophiocorycipitaceae, Phaeophaeriaceae, Synchytriaceae, and Trichocomaceae.

In an additional feature, the at least one biological agent comprises a metabolite produced from bacteria or plant material. With regard to this feature, the metabolite can be produced from Bacillus. In another feature of this aspect, with regard to the combinatorial composition, a ratio of a minimum inhibitory concentration (MIC) of one of the compound or the biological agent alone to the MIC of the compound or the biological agent in the combinatorial composition is greater than about 1.6.

In a further feature of this aspect, the combinatorial composition is effective for treating or controlling a pathogen. With regard to this feature, the treating or controlling comprises providing a curative, inhibitive, ameliorative, reduction in, or preventative activity for phytopathogens, including fungi, bacteria or microorganisms, insects, and/or nematodes.

A combinatorial composition according to any aspect of the invention can be applied to seed, soil, plant, plant part, or plant propagation material for controlling a pathogen. In exemplary embodiments, the pathogen is an insect, nematode, bacteria, or fungi. In other exemplary embodiments, the pathogen is phytopathogenic fungi.

A combinatorial composition according to any aspect of the invention can be applied to seed, soil, plant, plant part, or plant propagation material for providing a growth effect. Additionally, the combinatorial composition can be administered to an animal and can control a pathogen. In embodiments, the pathogen can be an endoparasite and/or an ectoparasite.

A combinatorial composition according to any aspect of the invention can be applied to seed, the plant, harvested fruits and vegetables, post-harvest, the soil, the plant's locus of growth, pre-emergence, post-emergence, habitat, storage space. Additionally, the combinatorial composition can have an application that is topical, to the soil, foliar, a foliar spray, systemic, a seed coating, a soil drench, directly in-furrow dipping, drenching, soil drenching, spraying, atomizing, irrigating, evaporating, dusting, fogging, broadcasting, foaming, painting, spreading-on, watering (drenching), drip irrigating.

In a third aspect of the invention, a method of controlling a pathogen comprises applying a combinatorial composition to seed, soil, plant, plant part, harvested fruit and vegetables, or plant propagation material.

In a fourth aspect of the invention, a method of controlling a pathogen comprises applying the combinatorial composition to seed, soil, plant, plant part, harvested fruit and vegetables, or plant propagation material, wherein the combinatorial composition also induces a growth affect.

In a fourth aspect of the invention, a method of controlling a pathogen comprises administering the combinatorial composition to an animal.

### DETAILED DESCRIPTION

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

As used herein, the term “hydrocarbyl” is a short hand term for a non-aromatic group that includes straight and branched chain aliphatic as well as alicyclic groups or radicals that contain only carbon and hydrogen. Inasmuch as alicyclic groups are cyclic aliphatic groups, such substituents are deemed to be subsumed within the aliphatic groups. Thus, alkyl, alkenyl, and alkynyl groups are contemplated.

Exemplary hydrocarbyl groups contain a chain of 1 to about 6 carbon atoms, and more preferably 1 to 5 carbon atoms. Examples of hydrocarbyl radicals include methyl, ethyl, n-propyl, isopropyl, n-butyl, isobutyl, sec butyl, tert-butyl, pentyl, iso-amyl, hexyl, and the like. Examples of suitable alkenyl radicals include ethenyl (vinyl), 2-propenyl, 3-propenyl, 1,4-pentadienyl, 1,4-butadienyl, 1-butenyl, 2-butenyl, 3-butenyl, and the like. Examples of alkynyl radicals include ethynyl, 2-propynyl, 3-propynyl, decynyl, 1-butynyl, 2-butynyl, 3-butynyl, and the like.

An alkyl group is a preferred hydrocarbyl group. As a consequence, a generalized, but more preferred substituent can be recited by replacing the descriptor “hydrocarbyl” with “alkyl” in any of the substituent groups enumerated herein. Where a specific aliphatic hydrocarbyl substituent group is intended, that group is recited; e.g., C1-C4 alkyl, methyl, or dodecenyl.

A contemplated cyclohydrocarbyl substituent ring contains 3 to 6 carbon atoms. The term “cycloalkylalkyl” means an alkyl radical as defined above that is substituted by a cycloalkyl radical. Examples of such cycloalkyl radicals include cyclopropyl, cyclobutyl, cyclopentyl, cyclohexyl, and the like.

Usual chemical suffix nomenclature is followed when using the word “hydrocarbyl” except that the usual practice of removing the terminal “yl” and adding an appropriate suffix is not always followed because of the possible similarity of a resulting name to that of one or more substituents. Thus, a hydrocarbyl ether is referred to as a “hydrocarbyloxy” group rather than a “hydrocarboxy” group as may possibly be more proper when following the usual rules of chemical nomenclature. Illustrative hydrocarbyloxy groups include methoxy, ethoxy, and cyclohexenyloxy groups. On the other hand, a hydrocarbyl group containing a C(O)— functionality is referred to as a hydrocarboyl (acyl) and that containing a —C(O)O— is a hydrocarboyloxy group inasmuch as there is no ambiguity. Exemplary hydrocarboyl and hydrocarboyloxy groups include acyl and acyloxy groups, respectively, such as formyl, acetyl, propionyl, butyryl, valeryl, 4-methylvaleryl, and acetoxy, acryloyl, and acryloyloxy.

The term “halogen” or “halo” means fluorine, chlorine, bromine, or iodine. The term “halohydrocarbyl” means a hydrocarbyl radical as defined above wherein one or more hydrogens is replaced with a halogen. A halohydrocarbyl radical (group or substituent) is typically a substituted alkyl substituent. Examples of such haloalkyl radicals include chloromethyl, 1-bromoethyl, fluoromethyl, difluoromethyl, trifluoromethyl, 1,1,1-trifluoroethyl, and the like.

The term “perfluorohydrocarbyl” means an alkyl group wherein each hydrogen atom has been replaced by a fluorine atom. Examples of such perfluorohydrocarbyl groups, in addition to trifluoromethyl above, are perfluorobutyl, perfluoroisopropyl, and perfluorohexyl.

The phrase “True Fungi” is used herein for all fungal organisms discussed herein except for the Oomycota (such as Pythium, Phytophthora and, Plasmopara) The uncapitalized term “fungi” or “fungus” is used to include all fungal organisms discussed herein, including the Oomycota.

In general “pesticidal” means the ability of a substance to increase mortality or inhibit the growth rate of plant pests. The term is used herein, to describe the property of a substance to exhibit activity against insects, mites, nematodes, fungi, bacteria, viruses, and/or phytopathogens. The term “pests” include insects, mites, nematodes, fungi, bacteria, viruses, and/or phytopathogens.

As used herein, “biological agent,” “biologic control agent” or “biologic agent” is defined as a pathogen-controlling microbe, metabolite extracted from a microbe or plant, secondary metabolite extracted from a microbe or plant, biostimulant, or an agent capable of controlling a pathogen and/or insect and/or an acarid and/or a nematode by the use of a second organism. One of skill in the art will understand that the term pathogen broadly includes causative agents of disease, such as, pathogenic bacterium, fungi, virus, or other microorganism that can cause disease. Known mechanisms of biological control include enteric bacteria that control root rot by out-competing fungi for space on the surface of the root. Bacterial metabolites, such as antibiotics, have been used to control pathogens and are an example of a ‘biological agent’. The biological agent can be isolated and applied directly to seeds, plants, plant parts, plant propagation materials, or animals, or the biological agent may be administered so it produces the toxin or biological agent in situ. The “biologic agent,” “biologic control agent” or “biological agent” may also be a metabolite or a secondary metabolite that is isolated from a living organism, such as, for example, a bacteria or plant.

The term “beneficial effect” generally means providing a growth effect, improved plant health or animal health, and/or amelioration, cure, prevention, or inhibition of a pathogen. A beneficial effect relates to promoting plant performance and/or curatively or preventively controlling detrimental insects, nematodes, microorganisms, fungi, or phytopathogens on or in an animal or a plant, plant parts, harvested fruits, seeds or vegetables.

The term “plant health” generally comprises various sorts of improvements of plants that are not connected to the control of pests. For example, advantageous properties that may be mentioned are improved crop characteristics including: emergence, crop yields, protein content, oil content, starch content, more developed root system, improved root growth, improved root size maintenance, improved root effectiveness, improved stress tolerance (e.g. against drought, heat, salt, UV, water, cold), reduced ethylene (reduced production and/or inhibition of reception), tillering increase, increase in plant height, bigger leaf blade, less dead basal leaves, stronger tillers, greener leaf color, pigment content, photosynthetic activity, less input needed (such as fertilizers or water), less seeds needed, more productive tillers, earlier flowering, early grain maturity, less plant verse (lodging), increased shoot growth, enhanced plant vigor, increased plant stand, and early and better germination.

The term “animal health” generally means the achievement and maintenance of healthful homeostasis of an animal, whether the animal be commercial, livestock, wild, or human.

The term “biostimulant” generally refers to diverse formulations of compounds, substances, and/or microorganisms that are applied to plants or soils to improve crop vigor, yields, quality, and tolerance of abiotic stresses. Biostimulants foster plant growth and development throughout crop lifecycle from seed germination to plant maturity in many ways, including: improving efficiency of plant metabolism for increased yield and crop quality, increasing plant tolerance and recovery, facilitation of nutrient assimilation, enhancement of quality attributes including sugar content, color, fruit seeding, etc., more efficient water use, enhancing soil fertility, etc.

“Plant growth promoting microbes” refer to microorganisms, either natural or recombinant which, in turn, promote plant health. As used herein the term microbes and microorganisms are synonymous.

“Insecticides” as well as the term “insecticidal” refers to the ability of a substance to increase mortality or inhibit growth rate of insects. As used herein, the term “insects” includes all organisms in the class “Insecta.” The term “pre-adult” insects refers to any form of an organism prior to the adult stage, including, for example, eggs, larvae, and nymphs. Insecticides include “Acaricides” and “acaricidals” refers to the ability of a substance to increase mortality or inhibit growth rate of ectoparasites belonging to the class Arachnida, sub-class Acari.

“Nematicides” and “nematicidal” refers to the ability of a substance to increase mortality or inhibit the growth rate of nematodes. In general, the term “nematode” comprises eggs, larvae, juvenile, and mature forms of said organism.

“Fungicide” and “Fungicidal” refers to the ability of a substance to increase mortality, control or inhibit growth rate of fungi.

The term “synergistically” or “synergistic” means that the effect of the application of a combination of compounds when taken together is greater than the sum of their separate effect if applied in the same amounts. That is, the application of a combination of compounds is more effective than the purely additive (in mathematical terms) effects of the application of the respective compounds alone.

An objective of having a synergistic drug or active ingredient combination is to reduce the dose of the drug/active ingredient used, thereby reducing the toxicity while maintaining efficacy. The concept of the dose-reduction index [DRI] was formally introduced by Chou and co-workers in 1988 [Chou et al., Pharmacologist 30:A231 (1988)] and has since been used in many publications. The DRI is a measure of how many-fold the dose of each drug in a synergistic combination can be reduced at a given effect level compared with the doses of each drug alone.

Chou and Talalay in 1983 [Chou et al., Trends Pharmacol 4:450-454 (1983)] used the term combination index (CI, now often referred to as FIC index or fractional inhibitory concentration index) for quantification of synergism or antagonism for two drugs where FIC<1, =1, and >1, indicate synergism, additive effect, and antagonism, respectively. The equation for determining FIC is shown below, where D₁ and D₂ are the two doses of active agents.

$$FIC = \frac{{( D )}_{1}}{{( {D}_{x} )}_{1}} + \frac{{( D )}_{2}}{{( {D}_{x} )}_{2}}$$

In the denominator, (Dₓ)₁ is for D₁ “alone” that inhibits a system x %, and (Dₓ)₂ is for D₂ “alone” that inhibits a system x %. The (Dₓ)₁ and (Dₓ)₂ values can be calculated as discussed in Chou, Pharmacol Rev 58:621-681 (2006). In the numerators, (D)₁+(D)₂ “in combination” also inhibit x %. If the sum of these two fractional terms is equal to 1, additive action is indicated. If the FIC value is smaller than 1, synergism is indicated, and if the FIC value is greater than 1, antagonism is indicated.

The dose reduction index (DRI) is obtained by inverting each term of the above equation. Thus, for a two drug combination:

$$FIC = \frac{{( D )}_{1}}{{( {D}_{x} )}_{1}} + \frac{{( D )}_{2}}{{( {D}_{x} )}_{2}} = \frac{1}{{( DRI )}_{1}} + \frac{1}{{( DRI )}_{2}}$$

Although DRI>1 is beneficial, it does not necessarily indicate synergism because, from the above equation, an additive effect or even slight antagonism can also lead to DRI>1. As noted in Chou, Pharmacol Rev 58:621-681 (2006), Table 4 on page 637, numerical values for FIC have been developed that are indicative of synergy, additivity or antagonism. The values shown in that table are set out below. Computer software developed by Chou and co-workers is also available commercially from ComboSyn, Inc. of Paramus, N.J., for use in calculating the CI and DRI values.

Chou’s Table 4

| Range of FIC Index | Description |
|---|---|
| <0.1 | Very strong synergism |
| 0.1-0.3 | Strong synergism |
| 0.3-0.7 | Synergism |
| 0.7-0.85 | Moderate synergism |
| 0.85-0.90 | Slight synergism |
| 0.90-1.10 | Nearly additive |
| 1.10-1.20 | Slight Antagonism |
| 1.20-1.45 | Moderate Antagonism |
| 1.45-3.3 | Antagonism |
| 3.3-10 | Strong antagonism |
| >10 | Very strong antagonism |

The designations based on FIC values of Chou's Table 4, above, notwithstanding, others have taken a more conservative approach to use of such values to assert the presence of synergy. Thus, the article of Odds [J. Antimicrob. Chemother. 52:1 (2003)] notes that for several reasons, that journal will require authors submitting papers containing FIC data to use the interpretations of ‘synergy’ (FIC≤0.5), ‘antagonism’ (FIC>4.0) and ‘no interaction’ (FIC>0.5-4.0). That usage was said to also foster conservative interpretations of the data, in that some combinations of agents can exert inhibitory effects that are more than the sum of their effects alone (FIC<1.0) or less than their effects alone (FIC>1.0). Comparatively, the more conservative approach excludes the “Moderate synergism” and “Slight synergism” taught in Chou, Pharmacol Rev 58:621-681 (2006). The publication by Barbee et al. [Antimicrob. Agents Chemother., 69:1572-1578 (2014)] utilizes that measure.

A synergistic relationship between the two compounds indicates that each compound is utilized for pathogen/disease control at a concentration that is less than the MIC that is normally obtained for either compound when used individually. A synergistic result for the purposes of this disclosure takes a more moderate approach than that of Chou discussed above, where synergy is defined as an FIC value that is less than or equal to (≤) 1.0, and rather presumes that synergy is present when FIC≤0.7. In preferred embodiments of the combinatorial composition, the FIC value is ≤0.5.

Using an FIC-based synergy determination value of 0.5, each drug or active ingredient would be present at most at ¼ of its separate MIC concentration (for pathogen control) as FIC=(¼+¼)=½=0.5. Stated another way, an MIC of each anti-fungal agent alone is at least 4-times greater than that of the synergistic concentration.

Similarly, an FIC value of 0.1 obtained by the serial dilution method can be obtained from an anti-fungal composition diluted so that each anti-fungal agent is present at 1/20^{th} of its individual MIC. This is seen by FIC=( 1/20+ 1/20)=(0.05+0.05)=0.1. Here, the MIC of each compound alone is 20-times greater than the MIC of the synergistic anti-fungal composition.

It is to be understood that use of serial dilutions of an initial anti-fungal composition, each of whose anti-fungal agents is initially present at its MIC as a single anti-fungal agent, is not the only way to determine an FIC MIC value. One could also combine different sub-MIC amounts of the anti-fungal agents and obtain an FIC value that is 0.5 or less. Thus, for example, one agent could be present at 1/10^{th} of its MIC alone and the other at ⅖^{th} of its MIC alone. Here, FIC=( 1/10+⅖)=(0.1+0.4)=0.5.

Regardless of the manner of calculation of the FIC value, it is preferred that the ratio of MIC of one anti-fungal agent used alone to the concentration of that agent in an anti-fungal composition is greater than about 1.6, so that the reciprocal of that ratio is less than about 0.6. More preferably, the ratio of MIC of one anti-fungal agent used alone to the concentration of that agent in an anti-fungal composition is greater than about 2, so that the reciprocal of that ratio is less than about 0.5. Thus, the ratio of the MIC of the second anti-fungal agent to the concentration of the second anti-fungal agent in a contemplated anti-fungal composition is greater than about 10, so that the reciprocal of that ratio is less than about 0.01 and the sum of those two reciprocal values is about 0.7 or less, or 0.5 or less, respectively.

The term “control” or “controlling” refers to a combinatorial composition that provides a curative, inhibitive, ameliorative, reduction in, and/or preventative activity for phytopathogens, fungi, pathogenic bacteria and/or microorganisms, insects, nematodes, and the like.

The term “metabolite” refers to any compound, substance, extract, or byproduct of the metabolism of a microorganism. Metabolites are the intermediate products of metabolic reactions catalyzed by various enzymes that naturally occur within cells. Primary metabolites are synthesized by the cell because they are needed for cell growth. Secondary metabolites are compounds produced by an organism that are not required for primary metabolic processes. While not necessary to the cell, they can have important functions. An example of a metabolite used in the present description is a compound extracted from a plant part, products of fermentation of microorganisms, or products of metabolic reactions in microorganisms or plants.

The term “microorganism” refers to bacterium, virus, fungus, algae, and the like.

The term “mutant” refers to a variant of the parental strain as well as methods for obtaining a mutant or variant in which the pesticidal activity is greater than that expressed by the parental strain. The “parent strain” is defined herein as the original strain before mutagenesis. To obtain such mutants, the parental strain may be treated with a chemical such as N-methyl-N′-nitro-N-nitrosoguanidine, ethylmethanesulfone, or by irradiation using gamma, x-ray, or UV-irradiation, CRISPR/Cas, endonucleases, RNAi, or by other means well known to those skilled in the art.

A “variant” is a strain having all the identifying characteristics of the NRRL or ATCC Accession Numbers as indicated in this text and can be identified as having a genome that hybridizes under conditions of high stringency to the genome of the NRRL or ATCC Accession Numbers.

“Hybridization” refers to a reaction in which one or more polynucleotides react to form a complex that is stabilized via hydrogen bonding between the bases of the nucleotide residues. The hydrogen bonding may occur by Watson-Crick base pairing, Hoogstein binding, or in any other sequence-specific manner. The complex may comprise two strands forming a duplex structure, three or more strands forming a multi-stranded complex, a single self-hybridizing strand, or any combination of these. Hybridization reactions can be performed under conditions of different “stringency”. In general, a low stringency hybridization reaction is carried out at about 40° C. in 10×SSC or a solution of equivalent ionic strength/temperature. A moderate stringency hybridization is typically performed at about 50° C. in 6×SSC, and a high stringency hybridization reaction is generally performed at about 60° C. in 1×SSC.

A variant of the indicated NRRL or ATCC Accession Number may also be defined as a strain having a genomic sequence that is greater than 85%, more preferably greater than 90% or more preferably greater than 95% sequence identity to the genome of the indicated NRRL or ATCC Accession Number. A polynucleotide or polynucleotide region (or a polypeptide or polypeptide region) has a certain percentage (for example, 80%, 85%, 90%, or 95%) of “sequence identity” to another sequence means that, when aligned, that percentage of bases (or amino acids) are the same in comparing the two sequences. This alignment and the percent homology or sequence identity can be determined using software programs known in the art, for example, those described in Current Protocols in Molecular Biology (F. M. Ausubel et al., eds., 1987) Supplement 30, section 7.7.18, Table 7.7.1.

By “effective” amount of a drug, formulation, or permeant is meant a sufficient amount of an active agent to provide the desired local or systemic effect. The term “active agent” can encompass single active compounds or combinations of compounds, such as, for example, the combinatorial composition described herein. It will be appreciated that if a combination of active compounds provides a synergistic effect, the effective amount of each active compound in the combination of compounds may be less than the effective amount of each active compound if they were used individually. A “topically effective” or “therapeutically effective” amount refers to the amount of drug needed to effect the desired therapeutic result.

The term “pharmaceutically acceptable salt” is meant to include a salt of a compound of the invention which are prepared with relatively nontoxic acids or bases, depending on the particular substituents found on the compounds described herein. When compounds of the invention contain relatively acidic functionalities, base addition salts can be obtained by contacting the neutral form of such compounds with a sufficient amount of the desired base, either neat or in a suitable inert solvent. Examples of pharmaceutically acceptable base addition salts include sodium, potassium, calcium, ammonium, organic amino (such as choline or diethylamine or amino acids such as d-arginine, l-arginine, d-lysine, or l-lysine), or magnesium salt, or a similar salt. When compounds of the invention contain relatively basic functionalities, acid addition salts can be obtained by contacting the neutral form of such compounds with a sufficient amount of the desired acid, either neat or in a suitable inert solvent. Examples of pharmaceutically acceptable acid addition salts include those derived from inorganic acids like hydrochloric, hydrobromic, nitric, carbonic, monohydrogencarbonic, phosphoric, monohydrogenphosphoric, dihydrogenphosphoric, sulfuric, monohydrogensulfuric, hydriodic, or phosphorous acids and the like, as well as the salts derived from relatively nontoxic organic acids like acetic, propionic, isobutyric, maleic, malonic, benzoic, succinic, suberic, fumaric, lactic, mandelic, phthalic, benzenesulfonic, p-tolylsulfonic, citric, tartaric, methanesulfonic, and the like. Also included are salts of amino acids such as arginate and the like, and salts of organic acids like glucuronic or galactunoric acids and the like (see, for example, Berge et al., “Pharmaceutical Salts”, Journal of Pharmaceutical Science 66: 1-19 (1977)). Certain specific compounds of the invention contain both basic and acidic functionalities that allow the compounds to be converted into either base or acid addition salts.

The term “pharmaceutically acceptable carrier” or “pharmaceutically acceptable vehicle” refers to any formulation or carrier medium that provides the appropriate delivery of an effective amount of an active agent as defined herein, does not negatively interfere with the effectiveness of the biological activity of the active agent, and that is sufficiently non-toxic to the host. Representative carriers include water, oils, both vegetable and mineral, cream bases, lotion bases, ointment bases and the like. These bases include suspending agents, thickeners, penetration enhancers, and the like. Additional information concerning carriers can be found in Remington: The Science and Practice of Pharmacy, 21st Ed., Lippincott, Williams & Wilkins (2005) which is incorporated herein by reference.

The term “pharmaceutically acceptable excipient” is conventionally known to mean pharmaceutically acceptable carriers, pharmaceutically acceptable diluents and/or pharmaceutically acceptable vehicles used in formulating drug compositions effective for the desired use.

“Biological medium,” as used herein refers to both in vitro and in vivo biological milieus. Exemplary in vitro “biological media” include, but are not limited to, cell culture, tissue culture, homogenates, plasma and blood. In vivo applications are generally performed in mammals. In vivo applications may also be performed on plants, plant parts, or plant propagation material.

The term “carrier” is used herein to denote a natural or synthetic, organic, or inorganic material that constitutes a portion of the diluent medium in which the benzoxaborole and biologic are dispersed or dissolved. This carrier is inert and agriculturally acceptable, in particular to the plant being treated. The phrase “agriculturally acceptable” may be utilized herein to be analogous to “pharmaceutically acceptable” as used in pharmaceutical products to describe diluent media. A carrier can be solid (clays, natural or synthetic silicates, silica, resins, waxes, solid fertilizers, and the like) or liquid (water, alcohols, ketones, petroleum fractions, aromatic or paraffinic hydrocarbons, chlorinated hydrocarbons, liquefied gases, and the like).

NRRL is the abbreviation for the Agricultural Research Service Culture Collection, an international depositary authority for the purposes of deposing microorganism strains under the Budapest treaty on the international recognition of the deposit of microorganisms for the purposes of patent procedure, having the address National Center for Agricultural Utilization Research, Agricultural Research service, U.S. Department of Agriculture, 1815 North university Street, Peroira, Ill. 61604 USA.

ATCC is the abbreviation for the American Type Culture Collection, an international depositary authority for the purposes of deposing microorganism strains under the Budapest treaty on the international recognition of the deposit of microorganisms for the purposes of patent procedure, having the address ATCC Patent Depository, 10801 University Blvd., Manassas, Va. 10110 USA.

The combinatorial compositions described herein have several benefits and advantages: namely, reducing the amount or dosage of benzoxaborole and/or biological agent needed to achieve an effective combinatorial composition to treat pathogens; modulating the activation process of biological control, resulting in greater activity and/or longer effective duration of the biological control and/or benzoxaborole; and affording a larger treatable disease spectrum with the use of said combinatorial composition. Other advantages of said combinatorial composition include reduction of resistance development and reduction of synthetic chemical residues on plants and plant parts.

Pathogens generally describe anything that can produce disease. The term is typically used to describe an infectious microorganism such as a virus, bacterium, protozoa, and/or fungus.

With regard to fungal pathogens, anti-fungal agents have been found to act by one or more mechanisms and are frequently grouped or classed by the mechanism of action by which the agent kills fungi or inhibits fungal growth. One classification system used widely in the industry is that of FRAC, the Fungicide Resistance Action Committee. The Fungicide Resistance Action Committee (FRAC) is an international organization made up of representatives of the agrochemical industry who provide fungicide resistance management guidelines to prolong the effectiveness of fungicides and to limit crop losses should resistance occur. FRAC publishes a Code List (version updated on February 2015) of different letters (A to I, with added numbers) that are used to distinguish fungicide compositions according to their biochemical mode of action (MOA) in fungal plant pathogens. The grouping is made according to processes in metabolism. It ranges from nucleic acid synthesis (A) to secondary metabolism, e.g. melanin synthesis (I) at the end of the list, followed by host plant defense inducers (P), recent molecules with an unknown mode of action and unknown resistance risk (U, transient status, mostly not longer than 8 years, until information about mode of action and mechanism of resistance becomes available), and multi-site inhibitors (M). The benzoxaboroles have not yet been added to the official FRAC list. Moreover, there is currently no other inhibitor of leucyl-tRNA synthetase on the FRAC listing.

The combinatorial compositions described herein comprise a synthetic compound and a biological agent. The synthetic compound can be characterized according to its biochemical mode of action. In particular, the synthetic compound may be a leucyl-tRNA synthetase inhibitor. Benzoxaboroles have been shown to be exemplary leucyl-tRNA synthetase inhibitors. For example, Rock et al., Science, 316:1759-1761 (2007) reported that benzoxaboroles act to inhibit leucyl-tRNA synthetase, an enzyme involved in protein synthesis. Specifically, benzoxaboroles form an adduct with the terminal adenosine of tRNALeu in the editing active site of LeuRS. This trapping of the enzyme bound tRNALeu in the editing site prevents catalytic turnover, and synthesis of leucyl-tRNALeu is inhibited, thus blocking protein synthesis. Moreover, benzoxaboroles may disrupt the translation of DNA through the inhibition of aminoacyl tRNA synthetases or through another mode of action such as disruption of: nucleic acid syntheses, cytoskeleton and motor proteins, respiration, amino acid and protein synthesis, signal transduction, lipid synthesis or transport, membrane integrity or function, melanin synthesis in the cell wall, sterol biosynthesis in membranes, or cell wall biosynthesis, or host plant defense induction.

Accordingly, the leucyl-tRNA synthetase inhibitor in the combinatorial composition can be a benzoxaborole. With regard to treating or controlling a pathogen, this can include inhibiting, ameliorating, and/or preventing activity of a pathogen. Moreover, the combinatorial composition may provide a synergistic effect in the treating or controlling of a pathogen.

In an embodiment, the combinatorial composition comprises a benzoxaborole and at least one biological agent. Generally, a benzoxaborole has the following structure:

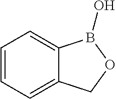

where any of the C—H bonds can be substituted.

In an embodiment, the combinatorial composition comprises a benzoxaborole and at least one biological agent. A benzoxaborole includes any bicyclic organic heterocycle having a structure in which the nitrogen of a benzoxazole has been replaced by boron. Moreover, chemical structures represented herein can be determined by those of skill in the art.

In an exemplary embodiment, the benzoxaborole of the combinatorial composition has a structure, I:

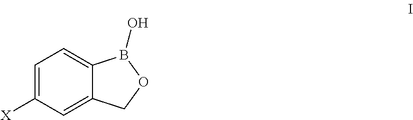

wherein:
X is a substituent having a Hammett sigma value for a meta substituent that is greater (more positive) than about −0.1, and more preferably a H, C1-C6 hydrocarbyl or a halogen.

Hammett sigma functions are well known to those skilled in organic chemistry. Lists of the values for meta and para substituents are published in many texts. See, for example, Hine, Physical Organic Chemistry, 2^{nd} ed, McGraw-Hill book Co., Inc., New York, page 87 (1962). Illustrative Hammett sigma values for meta substituents are provided in the Table below.

HAMMETT SIGMAS VALUES FOR META SUBSTITUENTS*

| Substituent | Sigma (σ)ₘₑₜₐ value |
|---|---|
| —NH₂ | −0.16 |
| —C(CH₃)₃ | −0.1 |
| —CH₃ | −0.07 |
| —C₂H₅ | −0.07 |
| —H | 0.00 |
| —OCH₃ | +0.12 |
| —NHCOCH₃ | +0.21 |
| —CO₂CH₃ | +0.32 |
| —F | +0.34 |
| —Cl | +0.37 |
| —C(O)CH₃ | +0.38 |
| —Br | +0.39 |
| —CF₃ | +0.43 |
| —CN | +0.56 |

*Values from Hine, above.

In a preferred embodiment, X is a halogen. For example, X may be chlorine, fluorine, bromine, or iodine. In another preferred embodiment, X is hydrogen.

An exemplary embodiment of a benzoxaborole includes 5-chlorobenzo[c][1,2]oxaborol-1(3H)-ol, which may be referred to herein as BAGS.

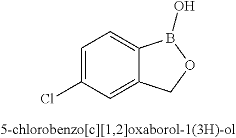 [SMILES: OB1OCc2cc(Cl)ccc21]

The compositions described herein demonstrate insecticidal and nematicidal activity, good plant tolerance, low toxicity to warm-blooded animals, and are well-tolerated by the environment. The compositions are suitable for protecting plants and plant organs, for increasing harvest yields, for improving the quality of the harvested material and for controlling animal pests, in particular insects, arachnids, helminths, nematodes and molluscs, which are encountered in agriculture, in horticulture, in animal husbandry, in forests, in gardens and leisure facilities, in protection of stored products and of materials, and in the hygiene sector. They can be preferably employed as plant protection agents. For example, the combinatorial compositions can be used as insecticides, pesticides, and/or fungicides.

The combinatorial compositions are active against normally sensitive and resistant pest species and against all or some stages of development. The abovementioned pests include: pests from the phylum Arthropoda, especially from the class Arachnida, for example, Acarus spp., Aceria sheldoni, Aculops spp., Aculus spp., Amblyomma spp., Amphitetranychus viennensis, Argas spp., Boophilus spp., Brevipalpus spp., Bryobia graminum, Bryobia praetiosa, Centruroides spp., Chorioptes spp., Dermanyssus gallinae, Dermatophagoides pteronyssinus, Dermatophagoides farinae, Dermacentor spp., Eotetranychus spp., Epitrimerus pyri, Eutetranychus spp., Eriophyes spp., Glycyphagus domesticus, Halotydeus destructor, Hemitarsonemus spp., Hyalomma spp., Ixodes spp., Latrodectus spp., Loxosceles spp., Metatetranychus spp., Neutrombicula autumnalis, Nuphersa spp., Oligonychus spp., Ornithodorus spp., Ornithonyssus spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Steneotarsonemus spp., Steneotarsonemus spinki, Tarsonemus spp., Tetranychus spp., Trombicula alfreddugesi, Vaejovis spp., Vasates lycopersici; from the class Chilopoda, for example, Geophilus spp., Scutigera spp.; from the order or the class Collembola, for example, Onychiurus armatus; from the class Diplopoda, for example, Blaniulus guttulatus;

from the class Insecta, e.g., from the order Blattodea, for example, Blattella asahinai, Blattella germanica, Blatta orientalis, Leucophaea maderae, Panchlora spp., Parcoblatta spp., Periplaneta spp., Supella longipalpa; from the order Coleoptera, for example, Acalymma vittatum, Acanthoscelides obtectus, Adoretus spp., Agelastica alni, Agriotes spp., Alphitobius diaperinus, Amphimallon solstitialis, Anobium punctatum, Anoplophora spp., Anthonomus spp., Anthrenus spp., Apion spp., Apogonia spp., Atomaria spp., Attagenus spp., Bruchidius obtectus, Bruchus spp., Cassida spp., Cerotoma trifurcata, Ceutorrhynchus spp., Chaetocnema spp., Cleonus mendicus, Conoderus spp., Cosmopolites spp., Costelytra zealandica, Ctenicera spp., Curculio spp., Cryptolestes ferrugineus, Cryptorhynchus lapathi, Cylindrocopturus spp., Dermestes spp., Diabrotica spp., Dichocrocis spp., Dicladispa armigera, Diloboderus spp., Epilachna spp., Epitrix spp., Faustinus spp., Gibbium psylloides, Gnathocerus cornutus, Hellula undalis, Heteronychus arator, Heteronyx spp., Hylamorpha elegans, Hylotrupes bajulus, Hypera postica, Hypomeces squamosus, Hypothenemus spp., Lachnosterna consanguinea, Lasioderma serricorne, Latheticus oryzae, Lathridius spp., Lema spp., Leptinotarsa decemlineata, Leucoptera spp., Lissorhoptrus oryzophilus, Lixus spp., Luperodes spp., Lyctus spp., Megascelis spp., Melanotus spp., Meligethes aeneus, Melolontha spp., Migdolus spp., Monochamus spp., Naupactus xanthographus, Necrobia spp., Niptus hololeucus, Oryctes rhinoceros, Oryzaephilus surinamensis, Oryzaphagus oryzae, Otiorrhynchus spp., Oxycetonia jucunda, Phaedon cochleariae, Phyllophaga spp., Phyllophaga helleri, Phyllotreta spp., Popillia japonica, Premnotrypes spp., Prostephanus truncatus, Psylliodes spp., Ptinus spp., Rhizobius ventralis, Rhizopertha dominica, Sitophilus spp., Sitophilus oryzae, Sphenophorus spp., Stegobium paniceum, Sternechus spp., Symphyletes spp., Tanymecus spp., Tenebrio molitor, Tenebrioides mauretanicus, Tribolium spp., Trogoderma spp., Tychius spp., Xylotrechus spp., Zabrus spp.; from the order Diptera, for example, Aedes spp., Agromyza spp., Anastrepha spp., Anopheles spp., Asphondylia spp., Bactrocera spp., Bibio hortulanus, Calliphora erythrocephala, Calliphora vicina, Ceratitis capitata, Chironomus spp., Chrysomyia spp., Chrysops spp., Chrysozona pluvialis, Cochliomyia spp., Contarinia spp., Cordylobia anthropophaga, Cricotopus sylvestris, Culex spp., Culicoides spp., Culiseta spp., Cuterebra spp., Dacus oleae, Dasyneura spp., Delia spp., Dermatobia hominis, Drosophila spp., Echinocnemus spp., Fannia spp., Gasterophilus spp., Glossina spp., Haematopota spp., Hydrellia spp., Hydrellia griseola, Hylemya spp., Hippobosca spp., Hypoderma spp., Liriomyza spp., Lucilia spp., Lutzomyia spp., Mansonia spp., Musca spp., Oestrus spp., Oscinella frit, Paratanytarsus spp., Paralauterborniella subcincta, Pegomyia spp., Phlebotomus spp., Phorbia spp., Phormia spp., Piophila casei, Prodiplosis spp., Psila rosae, Rhagoletis spp., Sarcophaga spp., Simulium spp., Stomoxys spp., Tabanus spp., Tetanops spp., Tipula spp.; from the order Heteroptera, for example, Anasa tristis, Antestiopsis spp., Boisea spp., Blissus spp., Calocoris spp., Campylomma livida, Cavelerius spp., Cimex spp., Collaria spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptocorisa varicornis, Leptoglossus phyllopus, Lygus spp., Macropes excavatus, Miridae, Monalonion atratum, Nezara spp., Oebalus spp., Pentomidae, Piesma quadrata, Piezodorus spp., Psallus spp., Pseudacysta persea, Rhodnius spp., Sahlbergella singularis, Scaptocoris castanea, Scotinophora spp., Stephanitis nashi, Tibraca spp., Triatoma spp.;

from the order Homoptera, for example, Acizzia acaciaebaileyanae, Acizzia dodonaeae, Acizzia uncatoides, Acrida turrita, Acyrthosipon spp., Acrogonia spp., Aeneolamia spp., Agonoscena spp., Aleyrodes proletella, Aleurolobus barodensis, Aleurothrixus floccosus, Allocaridara malayensis, Amrasca spp., Anuraphis cardui, Aonidiella spp., Aphanostigma piri, Aphis spp., Arboridia apicalis, Arytainilla spp., Aspidiella spp., Aspidiotus spp., Atanus spp., Aulacorthurn solani, Bemisia tabaci, Blastopsylla occidentalis, Boreioglycaspis melaleucae, Brachycaudus helichrysi, Brachycolus spp., Brevicoryne brassicae, Cacopsylla spp., Calligypona marginata, Carneocephala fulgida, Ceratovacuna lanigera, Cercopidae, Ceroplastes spp, Chaetosiphon fragaefolii, Chionaspis tegalensis, Chlorita onukii, Chondracris rosea, Chromaphis juglandicola, Chrysomphalus ficus, Cicadulina mbila, Coccomytilus halli, Coccus spp., Cryptomyzus ribis, Cryptoneossa spp., Ctenarytaina spp., Dalbulus spp., Dialeurodes citri, Diaphorina citri, Diaspis spp., Drosicha spp., Dysaphis spp., Dysmicoccus spp., Empoasca spp., Eriosoma spp., Erythroneura spp., Eucalyptolyma spp., Euphyllura spp., Euscelis bilobatus, Ferrisia spp., Geococcus coffeae, Glycaspis spp., Heteropsylla cubana, Heteropsylla spinulosa, Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Macrosteles facifrons, Mahanarva spp., Melanaphis sacchari, Metcalfiella spp., Metopolophium dirhodum, Monellia costalis, Monelliopsis pecanis, Myzus spp., Nasonovia ribisnigri, Nephotettix spp., Nettigoniclla spectra, Nilaparvata lugens, Oncometopia spp., Orthezia praelonga, Oxya chinensis, Pachypsylla spp., Parabemisia myricae, Paratrioza spp., Parlatoria spp., Pemphigus spp., Peregrinus maedis, Phenacoccus spp., Phloeomyzus passerinii, Phorodon humuli, Phylloxera spp., Pinnaspis aspidistrae, Planococcus spp., Prosopidopsylla flava, Protopulvinaria pyriformis, Pseudaulacaspis pentagona, Pseudococcus spp., Psyllopsis spp., Psylla spp., Pteromalus spp., Pyrilla spp., Quadraspidiotus spp., Quesada gigas, Rastrococcus spp., Rhopalosiphurn spp., Saissetia spp., Scaphoideus tetanus, Schizaphis graminurn, Selenaspidus articulatus, Sogata spp., Sogatella furcifera, Sogatodes spp., Stictocephala festina, Siphoninus phillyreae, Tenalaphara malayensis, Tetragonocephela spp., Tinocallis caryaefoliae, Tomaspis spp., Toxoptera spp., Trialeurodes vaporariorum, Trioza spp., Typhlocyba spp., Unaspis spp., Viteus vitifolii, Zygina spp.; from the order Hymenoptera, for example, Acromyrmex spp., Athalia spp., Atta spp., Diprion spp., Hoplocampa spp., Lasius spp., Monomorium pharaonic, Sirex spp., Solenopsis invicta, Tapinoma spp., Urocerus spp., Vespa spp., Xeris spp.;

from the order Isopoda, for example, Armadillidium vulgare, Oniscus asellus, Porcellio scaber; from the order Isoptera, for example, Coptotermes spp., Cornitermes cumulans, Cryptotermes spp., Incisitermes spp., Microtermes obesi, Odontotermes spp., Reticulitermes spp.; from the order Lepidoptera, for example, Achroia grisella, Acronicta major, Adoxophyes spp., Aedia leucomelas, Agrotis spp., Alabama spp., Amyelois transitella, Anarsia spp., Anticarsia spp., Argyroploce spp., Barathra brassicae, Borbo cinnara, Bucculatrix thurberiella, Bupalus piniarius, Busseola spp., Cacoecia spp., Caloptilia theivora, Capua reticulana, Carpocapsa pomonella, Carposina niponensis, Cheimatobia brumata, Chilo spp., Choristoneura spp., Clysia ambiguella, Cnaphalocerus spp., Cnaphalocrocis medinalis, Cnephasia spp., Conopomorpha spp., Conotrachelus spp., Copitarsia spp., Cydia spp., Dalaca noctuides, Diaphania spp., Diatraea saccharalis, Earias spp., Ecdytolopha aurantium, Elasmopalpus lignosellus, Eldana saccharina, Ephestia spp., Epinotia spp., Epiphyas postvittana, Etiella spp., Eulia spp., Eupoecilia ambiguella, Euproctis spp., Euxoa spp., Feltia spp., Galleria mellonella, Gracillaria spp., Grapholitha spp., Hedylepta spp., Helicoverpa spp., Heliothis spp., Hofmannophila pseudospretella, Homoeosoma spp., Homona spp., Hyponomeuta padella, Kakivoria flavofasciata, Laphygma spp., Laspeyresia molesta, Leucinodes orbonalis, Leucoptera spp., Lithocolletis spp., Lithophane antennata, Lobesia spp., Loxagrotis albicosta, Lymantria spp., Lyonetia spp., Malacosoma neustria, Maruca testulalis, Mamstra brassicae, Melanitis leda, Mocis spp., Monopis obviella, Mythimna separata, Nemapogon cloacellus, Nymphula spp., Oiketicus spp., Oria spp., Orthaga spp., Ostrinia spp., Oulema oryzae, Panolis flammea, Parnara spp., Pectinophora spp., Perileucoptera spp., Phthorimaea spp., Phyllocnistis citrella, Phyllonorycter spp., Pieris spp., Platynota stultana, Plodia interpunctella, Plusia spp., Plutella xylostella, Prays spp., Prodenia spp., Protoparce spp., Pseudaletia spp., Pseudaletia unipuncta, Pseudoplusia includens, Pyrausta nubilalis, Rachiplusia nu, Schoenobius spp., Scirpophaga spp., Scirpophaga innotata, Scotia segetum, Sesamia spp., Sesamia inferens, Sparganothis spp., Spodoptera spp., Spodoptera praefica, Stathmopoda spp., Stomopteryx subsecivella, Synanthedon spp., Tecia solanivora, Thermesia gemmatalis, Tinea cloacella, Tinea pellionella, Tineola bisselliella, Tortrix spp., Trichophaga tapetzella, Trichoplusia spp., Tryporyza incertulas, Tuta absoluta, Virachola spp.;

from the order Orthoptera or Saltatoria, for example, Acheta domesticus, Dichroplus spp., Gryllotalpa spp., Hieroglyphus spp., Locusta spp., Melanoplus spp., Schistocerca gregaria;

from the order Phthiraptera, for example, Damalinia spp., Haematopinus spp., Linognathus spp., Pediculus spp., Ptirus pubis, Trichodectes spp.;

from the order Psocoptera for example Lepinatus spp., Liposcelis spp.;

from the order Siphonaptera, for example, Ceratophyllus spp., Ctenocephalides spp., Pulex irritans, Tunga penetrans, Xenopsylla cheopsis;

from the order Thysanoptera, for example, Anaphothrips obscurus, Baliothrips biformis, Drepanothrips reuteri, Enneothrips flavens, Frankliniella spp., Heliothrips spp., Hercinothrips femoralis, Rhipiphorothrips cruentatus, Scirtothrips spp., Taeniothrips cardamomi, Thrips spp.;

from the order Zygentoma (=Thysanura), for example, Ctenolepisma spp., Lepisma saccharina, Lepismodes inquilinus, Thermobia domestica;

from the class Symphyla, for example, Scutigerella spp.;

pests from the phylum Mollusca, especially from the class Bivalvia, for example, Dreissena spp., and from the class Gastropoda, for example, Anion spp., Biomphalaria spp., Bulinus spp., Deroceras spp., Galba spp., Lymnaea spp., Oncomelania spp., Pomacea spp., Succinea spp.;

animal pests from the phylums Plathelminthes and Nematoda, for example, Ancylostoma duodenale, Ancylostoma ceylanicum, Acylostoma braziliensis, Ancylostoma spp., Ascaris spp., Brugia malayi, Brugia timori, Bunostomum spp., Chabertia spp., Clonorchis spp., Cooperia spp., Dicrocoelium spp., Dictyocaulus filaria, Diphyllobothrium Tatum, Dracunculus medinensis, Echinococcus granulosus, Echinococcus multilocularis, Enterobius vermicularis, Faciola spp., Haemonchus spp., Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp., Strongyloides fuelleborni, Strongyloides stercoralis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichiura, Wuchereria bancrofti;

phytoparasitic pests from the phylum Nematoda, for example, Aphelenchoides spp., Bursaphelenchus spp., Ditylenchus spp., Globodera spp., Heterodera spp., Longidorus spp., Meloidogyne spp., Pratylenchus spp., Radopholus spp., Trichodorus spp., Tylenchulus spp., Xiphinema spp., Helicotylenchus spp., Tylenchorhynchus spp., Scutellonema spp., Paratrichodorus spp., Meloinema spp., Paraphelenchus spp., Aglenchus spp., Belonolaimus spp., Nacobbus spp., Rotylenchulus spp., Rotylenchus spp., Neotylenchus spp., Paraphelenchus spp., Dolichodorus spp., Hoplolaimus spp., Punctodera spp., Criconemella spp., Quinisulcius spp., Hemicycliophora spp., Anguina spp., Subanguina spp., Hemicriconemoides spp., Psilenchus spp., Pseudohalenchus spp., Criconemoides spp., Cacopaurus spp., Hirschmaniella spp, Tetylenchus spp.

It is furthermore possible to control organisms from the subphylum Protozoa, especially from the order Coccidia, such as Eimeria spp.

### Plant Health

The combinatorial compositions described herein, can be used to control many pathogens including fungi, bacteria, insects, and parasites for the benefit of plants and/or animals. The combinatorial compositions may be administered systemically, topically, in the soil, as a seed treatment, or foliarly.

Where the pathogen to be controlled is a fungus, the taxonomy of the fungal pests may include one or more of a member of the phyla of Ascomycota, Oomycota, Basidiomycota, as well as subphylum Mucoromycotina previously classified in phylum Zygomycota. It is to be noted that members of the phylum Oomycota are not formally in the Kingdom Fungi (True Fungi), but rather are formally classified in the Kingdom Straminipila (also spelled Stramenopila), many of whose members have similarities to fungi. Both Oomycota and True Fungi are heterotrophs that break down food externally and then absorb nutrients from their surroundings.

Of the above-noted phyla, several members of the subphylum Pezizomycotina are among those that can be controlled using the contemplated combinatorial composition. Of the members of the subphylum Pezizomycotina, fungi of one or more of the Classes selected from the group consisting of Dothideomycetes, Eurotiomycetes, Leotiomycetes, and Sordariomycetes are particularly preferred for control by a contemplated combinatorial composition.

The combinatorial compositions described herein as used to control a plant pathogen may further comprise a diluent medium and may be conveniently formulated in a known manner to emulsifiable concentrates, coatable pastes, directly sprayable or dilutable solutions, dilute emulsions, wettable powders, soluble powders, dusts, granulates, and also encapsulations, e.g., in polymeric substances. As with the type of the combinatorial compositions, the methods of application, such as spraying, atomizing, dusting, scattering, coating or pouring, are chosen in accordance with the intended objectives and the prevailing circumstances. A contemplated combinatorial composition can also contain further adjuvants such as stabilizers, antifoam agents, viscosity regulators, binders or tackifiers as well as fertilizers, micronutrient donors, or other formulation additives for obtaining special effects.

Suitable diluent media and adjuvants (auxiliaries) can be solid or liquid and are substances useful in formulation technology, e.g., natural or regenerated mineral substances, solvents, dispersants, wetting agents, tackifiers, thickeners, binders, or fertilizers. Such diluent media are for example described in WO 97/33890, which is hereby incorporated by reference. Water-based (more than 50 weight percent water) diluent media are presently preferred and are used illustratively herein.

More particularly, a contemplated combinatorial composition can be employed in any conventional form, for example in the form of a powder, an emulsion, a flowable concentrate, a solution, a water dispersible powder, a capsule suspension, a gel, a cream, an emulsion concentrate, a suspension concentrate, a suspo-emulsion (an emulsion containing both solid and liquid benzoxaborole agents in an aqueous medium), a capsule suspension, a water dispersible granule, an emulsifiable granule, a water in oil emulsion, an oil in water emulsion, a micro-emulsion, an oil dispersion, an oil miscible liquid, a soluble concentrate, an ultra-low volume suspension, an ultra-low volume liquid, a technical concentrate, a dispersible concentrate, a wettable powder, or any technically feasible formulation.

While the combinatorial compositions of the present invention are able to be produced by one of skill in the art, e.g., by mixing the active ingredients with appropriate formulation ingredients that comprise the diluent medium such as solid or liquid carriers and optionally other formulating ingredients such as surface-active compounds (surfactants), biocides, anti-freeze agents, stickers, thickeners and compounds that provide adjuvancy effects, and the like, their unpredictable nature requires expert attention to achieve anti-pathogenic combinations having a synergistic effect. Some common formulation types include suspension concentrates, water dispersible concentrates, water dispersible granules, wettable powders and granules, and they can contain surfactants such as wetting and dispersing agents and other compounds that provide adjuvancy effects, e.g., the condensation product of formaldehyde with naphthalene sulphonate, an alkylarylsulphonate, a lignin sulphonate, a fatty alkyl sulphate, and ethoxylated alkylphenol, trisiloxane ethoxylate, and an ethoxylated fatty alcohol. Slow release formulations are contemplated. Further, formulations for crop protection may be applied as a spray, e.g., foliar application or directly on the soil.

Solid, particulate carriers that can be used, for example for dusts and dispersible powders, include calcite, talc, kaolin, diatomaceous earth, montmorillonite or attapulgite, and highly-dispersed silica or absorptive polymers. Illustrative particulate, adsorptive carriers for granules include pumice, crushed brick, sepiolite or bentonite, montmorillonite-type clay, and exemplary nonsorbent carrier materials are calcite or dolomite. A particulate solid formulation can also be prepared by encapsulation of a suitable mixture of fungicides, pesticides, or insecticides or by a granulation process that utilizes one or more of the above diluents or an organic diluent such as microcrystalline cellulose, rice hulls, wheat middlings, saw dust and the like. Illustrative granules can be prepared as discussed in U.S. Pat. Nos. 4,936,901, 3,708,573 and 4,672,065.

Suitable liquid carriers include: aromatic hydrocarbons, in particular the fractions C₈-C₁₂, such as xylene mixtures or substituted naphthalenes, phthalic esters such as dibutyl or dioctyl phthalate, aliphatic hydrocarbons such as cyclohexane, paraffins or limonene, alcohols and glycols as well as their ethers and esters, such as ethylene glycol monomethyl ether or benzyl alcohol, ketones such as cyclohexanone or isophorone, strongly polar solvents such as N-methyl-2-pyrrolidone, dimethyl sulfoxide or dimethylformamide, and, if appropriate, epoxidized vegetable oils such as soybean oil, and water. If appropriate, the liquid carrier can be a naturally occurring essential oil, such as oils from citronella and lemon grass.

Suitable surface-active compounds are non-ionic, cationic and/or anionic surfactants having good emulsifying, dispersing and wetting properties, depending on the water solubility of the contemplated benzoxaborole. The term “surfactants” is also to be understood as meaning mixtures of two or more surface-active compounds.

The surfactants customarily employed in formulation technology are described, inter alia, in the following publications: McCutcheon's Detergents and Emulsifiers Annual, MC Publishing Corp., Glen Rock, N.J., 1988; M. and J. Ash, Encyclopedia of Surfactants, Vol. I-Ill, Chemical Publishing Co., New York, 1980-1981.

Among the suitable illustrative surfactants there can be mentioned, e.g., high molecular weight polymers, polyacrylic acid salts, lignosulphonic acid salts, phenolsulphonic or (mono- or di-alkyl)naphthalenesulphonic acid salts, laurylsulfate salts, polycondensates of ethylene oxide with lignosulphonic acid salts, polycondensates of ethylene oxide with fatty alcohols or with fatty acids or with fatty amines, substituted phenols (in particular alkylphenols or arylphenols such as mono- and di-(polyoxyalkylene alkylphenol) phosphates, polyoxyalkylene alkylphenol carboxylates or polyoxyalkylene alkylphenol sulfates), salts of sulphosuccinic acid esters, taurine derivatives (in particular alkyltaurides), polycondensates of ethylene oxide with phosphated tristyrylphenols and polycondensates of ethylene oxide with phosphoric esters of alcohols or phenols. Additional suitable surfactants include: amine ethoxylates, alkylaryl sulphonates, alkylbenzene sulphonates, castor oil ethoxylates and polyethylene glycol derivatives of hydrogenated castor oil, sorbitan fatty acid ester ethoxylates, sorbitan fatty acid esters, non-ionic ethoxylates, branched and unbranched secondary alcohol ethoxylates, nonylphenol ethoxylates, and octylphenol ethoxylates. The presence of at least one surfactant is often where inert vehicles are not readily soluble in water and the benzoxaborole composition preferably used for the administration is water.

Furthermore, particularly useful adjuvants which enhance application are natural or synthetic phospholipids from the series of the cephalins and lecithins, for example phosphatidylethanolamine, phosphatidylserine, phosphatidylglycerine, or lysolecithin.

Contemplated combinatorial compositions can also include at least one polymer that is a water-soluble or a water-dispersible film-forming polymer that improves the adherence of at least the antifungal to the treated plant or plant propagation material. An exemplary polymer generally has an average molecular weight of at least 10,000 to about 100,000 kDa.

Typically, a coloring agent, such as a dye or pigment, is included in the combinatorial composition so that an observer can immediately determine that the plant has been treated. An antifungal composition that includes a coloring agent is a preferred embodiment of the invention, as such a combinatorial composition can improve user and consumer safety. The coloring agent is also useful to indicate to the user the degree of uniformity of application of a composition. Generally, the coloring agent tends to have a melting point above 30° C., and therefore, is suspended in a contemplated combinatorial composition. The coloring agent can also be a soluble compound.

Exemplary coloring agents include pigment red 48-2 (CAS-7023-61-2), pigment blue 15 (CAS-147-14-8), pigment green 7 (CAS-1328-53-6), pigment violet 23 (CAS-6358-30-1), pigment red 53-1 (CAS-5160-02-1), pigment red 57-1 (CAS 5281-04-9), pigment red 112 (CAS 6535-46-2) or similar coloring agents. A coloring agent is typically present at about 0.1 to about 10% by mass of the combinatorial composition.

In typical use, a combinatorial composition is formulated as a concentrate, also known as a pre-mix composition (or concentrate, formulated compound), and the end user normally employs a diluted formulation for administration to the plants of interest. Such a diluted composition is often referred to as a tank-mix composition. A tank-mix composition is generally prepared by diluting a pre-mix composition (concentrate) comprising a benzoxaborole and a biologic agent with a solvent, such as water, that can optionally also contain further auxiliaries. Moreover, the benzoxaborole and the biologic agent may be present in two separate tank mixes before application. Generally, an aqueous tank-mix is preferred.

In general, a concentrated formulation of the benzoxaborole includes about 0.01 to about 90% by weight benzoxaborole, about 0 to about 20% agriculturally acceptable surfactant and 10 to 99.99% solid or liquid carriers and adjuvant(s).

Suitable penetrants in the present context include substances that are conventionally used to enhance the penetration of active agrochemical compounds into plants. Penetrants, in this context, are defined in that, from the (generally aqueous) application liquor and/or from the spray coating, they are able to penetrate the cuticle of the plant and thereby increase the mobility of the active compounds in the cuticle. The penetration property can be determined using methods described in the literature. See Baur et al., 1997, Pesticide Science 51, 131-152). Exemplary penetrates include alcohol alkoxylates such as coconut fatty ethoxylate or isotridecyl ethoxylate, fatty acid esters such as rapeseed or soybean oil methyl esters, fatty amine alkoxylates such as tallowamine ethoxylate, or ammonium and/or phosphonium salts such as ammonium sulphate or diammonium hydrogen phosphate, for example.

Exemplary formulations of the benzoxaborole and biologic agent compositions can comprise between 0.00000001% and 98% by weight of benzoxaborole and biologic agents or, preferably, between 0.01% and 95% by weight of benzoxaborole and biologic agent, more preferably between 0.5% and 90% by weight of benzoxaborole and biologic agent.

The benzoxaborole content of the prepared formulations may vary within wide ranges. The benzoxaborole concentration of the application forms may be situated typically between 0.00000001% and 95% by weight of active compound. For example, between 0.00001% and 50%, between 0.00001% and 40%, between 0.00001% and 30%, between 0.00001% and 20%, between 0.00001% and 10%, and preferably between 0.00001% and 1% by weight, based on the weight of the application form. Application takes place in a customary manner adapted to the application forms.

### Contemplated Biologic Agents for Use in the Combinatorial Composition

In embodiments, the combinatorial compositions may comprise at least one biological agent selected from the group consisting of Bacillus chitinosporus AQ746 (NRRL Accession No. B-21618), Bacillus mycoides AQ726 (NRRL Accession No. B-21664), Bacillus pumilus (NRRL Accession No. B-30087), Bacillus pumilus AQ717 (NRRL Accession No. B-21662), Bacillus sp. AQ175 (ATCC Accession No. 55608), Bacillus sp. AQ177 (ATCC Accession No. 55609), Bacillus sp. AQ178 (ATCC Accession No. 53522), Bacillus subtilis AQ743 (NRRL Accession No. B-21665), Bacillus subtilis AQ713 (NRRL Accession No. B-21661), Bacillus subtilis AQ153 (ATCC Accession No. 55614), Bacillus thuringiensis BD#32 (NRRL Accession No. B-21530), Bacillus thuringiensis AQ52 (NRRL Accession No. B-21619), Muscodor albus 620 (NRRL Accession No. 30547), Muscodor roseus A3-5 (NRRL Accession No. 30548), Rhodococcus globerulus AQ719 (NRRL Accession No. B-21663), Streptomyces galbus (NRRL Accession No. 30232), Streptomyces sp. (NRRL Accession No. B-30145), Bacillus thuringiensis subspec. kurstaki BMP 123, Bacillus subtilis AQ30002 (NRRL Accession No. B-50421), and Bacillus subtilis AQ 30004 (NRRL Accession No. B-50455) and/or a mutant of these strains having all the identifying characteristics of the respective strain, and/or a metabolite produced by the respective strain that exhibits activity against insects, mites, nematodes and/or phytopathogens and at least one benzoxaborole.

In another embodiment, the combinatorial composition comprises at least one benzoxaborole-tolerant biological agent. Generally, antimicrobial-tolerant biological agents can be induced in the genera Bacteroides (e.g., Alistipes, Prevotella, Paraprevotella, Parabacteroides, Odoribacter), Bacillus, Bifidobacterium, Clostridioides, Eubacterium, Escherichia, Faecalibacterium, Haemophilus, Heliobacter (H. pylori), Lactobacillus, Prevotella, Streptococcus/Lactococcus. Alternaria, Ampelomyces, Aspergillus, Aureobasidium, Beauveria, Candida, Isaria, Lecanicillium, Metarhizium, Phlebiopsis, Trichoderma, Ulocladium, Phytophthora, or Fallopia. Accordingly, benzoxaborole-tolerant biological agents may be induced in the genera Bacteroides (e.g., Alistipes, Prevotella, Paraprevotella, Parabacteroides, Odoribacter), Bacillus, Bifidobacterium, Clostridioides, Eubacterium, Escherichia, Faecalibacterium, Haemophilus, Heliobacter (H. pylori), Lactobacillus, Prevotella, Streptococcus/Lactococcus. Alternaria, Ampelomyces, Aspergillus, Aureobasidium, Beauveria, Candida, Isaria, Lecanicillium, Metarhizium, Phlebiopsis, Ulocladium, Phytophthora, or Fallopia.

In some embodiments, the biological agent is a metabolite of a beneficial bacteria. In such embodiments, the biological agent can be obtained by extraction from lysed cells. A preferred bacteria is Bacillus.

In exemplary embodiments, a combinatorial composition may comprise a biological agent selected from the following commercially available biologic agents:

| | Trademark (some | |
|---|---|---|
| | registered US | |
| Organism | trademarks) | Company Name |
| Bacillus amyloliquefaciens | Serifel | BASF |
| strain MBI 600 | | |
| Bacillus amyloliquefaciens | Taegro | Novozymes |
| strain FZB 24 | | |
| Bacillus subtilis strain | Serenade | Bayer |
| QST 713 | | CropScience LP |
| Bacillus amyloliquefaciens | Monterey Complete | Monterey Lawn & |
| strain D747 | Disease Control | Garden |
| Streptomyces lydicus | Actinovate SP | Valent USA |
| WYEC 108 | | |
| Bacillus subtilis GB03 | Companion 2-3-2 | Growth Products |
| Reynoutria sachalinensis | Regalia | Marrone Bio |
| | | Innovations |

In some embodiments, the biological agent is a benzoxaborole-tolerant biological agent.

As used herein, benzoxaborole-tolerant biological agents refers to micro-organisms that can tolerate the presence of 50 ppm of benzoxaborole-based antimicrobials. In other words, the benzoxaborole-induced minimum inhibitory concentration (MIC) of the tolerant micro-organism should be about 50 ppm. Generally, an antimicrobial is understood to mean an agent that kills, ameliorates, or inhibits the growth of microorganisms.

Suitable benzoxaborole-tolerant biological agents can be generated and carefully selected from a curated collection of mutant species. The advantage of antimicrobial-tolerant biological agents is they have high compatibility in combinatorial compositions and can therefore be easily included in combinatorial compositions with other antimicrobial agents, for example, synthetic chemicals such as a benzoxaborole. Accordingly, one can prepare a combinatorial composition comprising a benzoxaborole and a benzoxaborole-tolerant biological agent, while preserving the optimal activity of the biological agent. This ability results in a combinatorial composition that can function in an additive manner or in a synergistic manner. Such a complimentary combinatorial composition reduces the amount of synthetic compound (benzoxaborole) and/or biological agent (benzoxaborole-tolerant biological agent) needed to effectively control the target pathogens.

In the combinatorial compositions, multiple antimicrobial-tolerant biological agents can be combined with multiple synthetic antimicrobial compounds to control pathogens with compatible mixing partners. For example, one can select a benzoxaborole-tolerant biological agent to combine with multiple benzoxaborole compounds. Additional synthetic compounds that do not significantly interfere with the vitality of the biological agent at mixing concentration can also be added. Similarly, multiple antimicrobial- or benzoxaborole-tolerant biological agents can be combined with a benzoxaborole provided the benzoxaborole does not significantly interfere with the vitality of the various biological agents at the mixing concentration.

In a further embodiment, the combinatorial composition further comprises at least one fungicide, pesticide, or insecticide, with the proviso that the biological agent, benzoxaborole, and fungicide, pesticide, or insecticide are not identical. Moreover, an exemplary combinatorial composition can comprise at least one biological agent, a benzoxaborole, and at least two fungicides, pesticides or insecticides that are not identical. The fungicide, pesticide, or insecticide can be present either in the biological agent component or the benzoxaborole component, being spatially separated or in both of these components. Preferably, the fungicide, pesticide, or insecticide is present in the benzoxaborole component.

Moreover, the combinatorial compositions may further comprise at least one auxiliary component selected from the group consisting of extenders, solvents, spontaneity promoters, carriers, emulsifiers, dispersants, frost protectants, thickeners and adjuvants, as mentioned above. The at least one auxiliary can be present either in the biological agent component of the composition or in the benzoxaborole component, or in both of these components.

The combinatorial composition, as it pertains to crop protection or plant health, may be applied in any desired manner, such as in the form of a seed coating, soil drench, and/or directly in-furrow and/or as a foliar spray and applied either pre-emergence, post-emergence or both. In other words, the combinatorial composition can be applied to the seed, the plant or to harvested fruits and vegetables or to the soil, wherein the plant is growing or wherein it is desired to grow (i.e., the plant's locus of growth).

Preferably, the combinatorial composition is used for treating conventional or transgenic plants or seed thereof.

In another aspect of the present invention, a method for reducing overall damage of plants and plant parts as well as losses in harvested fruits or vegetables caused by insects, mites, nematodes and/or phytopathogens is provided comprising the step of simultaneously or sequentially applying the least one biological agent(s) and the at least one benzoxaborole in the form of the combinatorial composition, as previously described.

In some embodiments, the combinatorial composition additionally comprises at least one fungicide, pesticide, or insecticide, which is a synthetic fungicide, pesticide, or insecticide. The fungicide can be selected from the group consisting of: carbendazim, thiabendazole, thiophanate, thiophanate-methyl, zoxamide, ethaboxam, benomyl, fuberidazole, azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, trifloxystrobin, dimeoxystrobin, fenamistrobin, methominostrobin, orysastrobin, famoxadone, fluoxastrobin, fenamidone, pyribencarb, cyazofamid, amisulbrom, fentin chloride, fentin acetate, fentin hydroxide, cyprodinil, mepanipyrim, pyrimethanil, quinoxyfen, proquinazid, fenpiclonil, fludioxonil, chlozolinate, dimethachlone, iprodione, procymidone, vinclozolin, triforine, pyrifenox, pyrisoxazole, fenarimol, nuarimol, imazalil, oxpoconazole, pefurazoate, prochloraz, triflumizole, azaconazole, bitertanol, bromuconazole, cyproconazole, diniconazole, epoxiconazole, etanconazole, fenbuconazole, fluquinconazole, flusilazole, flutriafol, hexaconazole, imibenconazole, ipconazole, metconazole, myclobutanil, penconazole, propiconazole, simeconazole, tebuconazole, tetraconazole, triadimefon, triadimenol, triticonazole, prothioconazole, dimethomorph, flumorph, pyrimorph, benthiavalicarb, iprovalicarb, valifenalate, mandipropamid, captan, captafol, folpet, and chlorothalonil.

The method includes the following application methods, namely both of the at least one biological control agent and the at least one benzoxaborole may be formulated into a single, stable composition with an agriculturally acceptable shelf life (so called “solo-formulation”), or may be combined before or at the time of use (so called “combined-formulations”).

If not mentioned otherwise, the expression “combination” refers to the various combinations of the at least one biological control agent and the at least one benzoxaborole, and optionally the at least one fungicide, pesticide, or insecticide, in a solo-formulation, in a single “ready-mix” form, in a combined spray mixture composed from solo-formulations, such as a “tank-mix”, and especially in a combined use of the single active ingredients when applied in a sequential manner (i.e. one after the other within a reasonably short period, such as a few hours or days, e.g., 1 hour to 7 days.). Accordingly, the term “combination” also encompasses the presence of the at least one biological agent and the at least one benzoxaborole, and optionally the at least one fungicide, pesticide, or insecticide on or in a plant to be treated or its surrounding, habitat or storage space, e.g. after simultaneously or consecutively applying the at least one biological agent and the at least one benzoxaborole, and optionally the at least one fungicide, pesticide, or insecticide to a plant its surrounding, habitat or storage space.

If the at least one biological agent and the at least one benzoxaborole, and optionally the at least one fungicide, pesticide, or insecticide are employed or used in a sequential manner, it is possible to treat the plants or plant parts (which includes seeds and plants emerging from the seed), harvested fruits and vegetables according to the following method: Firstly, applying the at least one benzoxaborole and optionally the at least one fungicide, pesticide, or insecticide on the plant or plant parts, and secondly applying the biological agent to the same plant or plant parts. The time periods between the first and the second application within a (crop) growing cycle may vary and depend on the effect to be achieved. For example, the first application can be done to prevent an infestation of the plant or plant parts with insects, mites, nematodes and/or phytopathogens (this is particularly the case when treating seeds) or to combat an infestation with insects, mites, nematodes and/or phytopathogens (this is particularly the case when treating plants and plant parts), and the second application can be done to prevent or control an infestation with insects, mites, nematodes and/or phytopathogens. The term “control” in this context means that the biological control agent is not able to fully exterminate the pests or phytopathogenic fungi but is able to keep the infestation at an acceptable level.

By following the before mentioned steps, a very low level of residues of the at least one benzoxaborole, and optionally at least one fungicide, pesticide, or insecticide on the treated plant, plant parts, and the harvested fruits and vegetables can be achieved.

It will also be appreciated that if the at least one biological agent and the at least one benzoxaborole, and optionally the at least one fungicide, pesticide, or insecticide are employed or used in a sequential manner, it is possible to treat the plants or plant parts (which includes seeds and plants emerging from the seed), harvested fruits and vegetables by firstly applying the biological agent to the plant or plant parts, and secondly applying the at least one benzoxaborole and optionally the at least one fungicide, pesticide, or insecticide to the same plant or plant parts.

If not mentioned otherwise, the treatment of plants or plant parts (which includes seeds and plants emerging from the seed), harvested fruits and vegetables with the combinatorial composition is carried out directly or by action on their surroundings, habitat or storage space using customary treatment methods, for example directly in-furrow dipping, spraying, atomizing, irrigating, evaporating, dusting, fogging, broadcasting, foaming, painting, spreading-on, watering (drenching), soil drenching, and drip irrigating. Application may be topical, for example, to the soil, foliar, a foliar spray, systemic, and/or a seed coating. The combinatorial composition can be applied post-harvest, to the soil, to the plant's locus of growth, pre-emergence, and/or post-emergence. It is furthermore possible to apply the at least one biological agent, the at least one benzoxaborole, and optionally the at least one fungicide, pesticide, or insecticide as solo-formulation or combined-formulations by the ultra-low volume method, or to inject the combinatorial composition according to the present invention as a combinatorial composition or as sole-formulations into the soil (in-furrow).

The term “plant to be treated” encompasses every part of a plant including its root system and the material—e.g., soil or nutrition medium—which is in a radius of at least 10 cm, 20 cm, 30 cm around the caulis or bole of a plant to be treated or which is at least 10 cm, 20 cm, 30 cm around the root system of said plant to be treated, respectively.

The amount of the biological agent which is used or employed in combination with the at least one benzoxaborole, optionally in the presence of at least one fungicide, pesticide, or insecticide, depends on the final formulation as well as size or type of the plant, plant parts, seeds, harvested fruits and vegetables to be treated. Usually, the biological agent to be employed or used is present in about 2% to about 80% (w/w), for example, in about 5% to about 75% (w/w), about 10% to about 70% (w/w), about 15% to about 65% (w/w), about 20% to about 60% (w/w), and about 20% to about 50% (w/w) of its solo-formulation or combined-formulation with the at least one benzoxaborole, and optionally the fungicide, pesticide, or insecticide.

In a preferred embodiment the biological agent or, e.g., their spores are present in a solo-formulation or the combined-formulation in a concentration of at least 105 colony forming units per gram preparation (e.g. cells/g preparation, spores/g preparation), such as 10⁵-10¹² cfu/g, preferably 10⁶-10¹¹ cfu/g, more preferably 10⁷-10¹⁰ cfu/g and most preferably 10⁹-10¹⁰ cfu/g at the time point of applying biological agents on a plant or plant parts such as seeds, fruits or vegetables. References to the concentration of biological agents in form of, e.g., spores or cells—when discussing ratios between the amount of a preparation of at least one biological agent and the amount of benzoxaborole—are made in view of the time point when the biological agent is applied on a plant or plant parts such as seeds, fruits, or vegetables.

Also, the amount of the at least one benzoxaborole which is used or employed in combination with the biological agent, optionally in the presence of a fungicide, pesticide, or insecticide, depends on the final formulation as well as size or type of the plant, plant parts, seeds, harvested fruit or vegetable to be treated. Usually, the benzoxaborole to be employed or used is present in about 0.1% to about 80% (w/w), preferably 1% to about 60% (w/w), more preferably about 10% to about 50% (w/w) of its solo-formulation or combined-formulation with the biological agent, and optionally the at least one fungicide, pesticide, or insecticide.

The at least one biological agent and the at least one benzoxaborole, and if present also the fungicide, pesticide, or insecticide are used or employed in a synergistic weight ratio. Moreover, the skilled person understands that these ratios refer to the ratio within a combined-formulation as well as to the calculative ratio of the at least one biological agent and the benzoxaborole when both components are applied as solo-formulations.

The synergistic weight ratio for a combinatorial composition can be calculated based on the amount of the at least one benzoxaborole, at the time point of application thereof to a plant or plant part and the amount of the biological agent shortly prior (e.g., 48 h, 24 h, 12 h, 6 h, 2 h, 1 h) or at the time point of application thereof to a plant or plant part.

The application of the at least one biological agent and the at least one benzoxaborole to a plant or a plant part can take place simultaneously or at different times as long as both components are present on or in the plant after application(s). In cases where the biological agent and the benzoxaborole are applied at different times and the benzoxaborole is applied noticeably prior to the biological agent, the skilled person can determine the concentration of benzoxaborole on/in a plant by chemical analysis methods known in the art, at the time point or shortly before the time point of applying the biological agent. Vice versa, when the biological agent is applied to a plant first, the concentration of a biological agent can be determined using analytical methods known in the art, at the time point or shortly before the time point of applying benzoxaborole.

In particular, in one embodiment the synergistic weight ratio of the at least one biological control agent/spore preparation and the at least one benzoxaborole lies in the range of 1:500 to 1000:1, preferably in the range of 1:500 to 500:1, more preferably in the range of 1:500 to 300:1. For example, the weight ratio may be 1:400, 1:300, 1:200, 1:100, 1:50, 1:20, 1:1, 20:1, 50:1 100:1, 200:1, 300:1 or any ratios within the recited range. These ratio ranges refer to the biological agent/spores preparation (to be combined with at least one benzoxaborole or a preparation of at least one benzoxaborole) of around 10¹⁰ cells/spores per gram preparation of said cells/spores. For example, a ratio of 100:1 means 100 weight parts of a biological agent/spore preparation having a cell/spore concentration of 10¹⁰ cells/spores per gram preparation and 1 weight part of benzoxaborole are combined (either as a solo formulation, a combined formulation or by separate applications to plants so that the combination is formed on the plant).

In another embodiment, the synergistic weight ratio of the at least one biological control agent/spore preparation to benzoxaborole is in the range of 1:100 to 20,000:1, preferably in the range of 1:50 to 10,000:1 or even in the range of 1:50 to 1000:1. Once again the mentioned ratio ranges refer to biological agent/spore preparations of biological agents of around 10¹⁰ cells or spores per gram preparation of said biological agent.

Still in another embodiment, the synergistic weight ratio of the at least one biological agent/spore preparation to the benzoxaborole is in the range of 1:0.0001 to 1:1, preferably in the range of 1:0.0005 to 1:0.5 or even in the range of 1:0.001 to 1:0.25. Here the mentioned ratio ranges refer to the amount in ppm of the biological agent (BCA) and the fungicide, pesticide, or insecticide, wherein the amount of the biological agent refers to the dried content of the BCA solution. In this embodiment, the biological agent preferably is Bacillus subtilis AQ30002 which is mentioned above as B19. In particular, a solution of B19 is preferred which contains 1.34% of the BCA which refers to 8.5.108 CFU/g. Most preferably, when B19 is used as a BCA, the synergistic weight ratio of at least B19 to the insecticide is 1:0.2.

The cell/spore concentration of preparations can be determined by applying methods known in the art. To compare weight ratios of the biological agent/spore preparation to benzoxaborole, the skilled person can easily determine the factor between a preparation having a biological control agent/spore concentration different from 10¹⁰ cells/spores per gram cell/spore preparation and a preparation having a biological agent/spore concentration of 10¹⁰ cells/spores per gram preparation to calculate whether a ratio of a biological agent/spore preparation to benzoxaborole is within the scope of the above listed ratio ranges.

In one embodiment of the present invention, the concentration of the biological control agent after dispersal is at least 50 g/ha, such as 50-7500 g/ha, 50-2500 g/ha, 50-1500 g/ha; at least 250 g/ha (hectare), at least 500 g/ha or at least 800 g/ha.

The application rate of the combinatorial composition may vary. Those skilled in the art can discern the appropriate application rate by way of routine experiments.

The oxoboroles of the combinatorial composition may be bactericides that can be used in crop health for control of Pseudomonadaceae, Rhizobiaceae, Enterobacteriaceae, Corynebacteriaceae and Streptomycetaceae.

Non-limiting examples of pathogens of fungal diseases which can be treated in accordance with the invention include:

diseases caused by powdery mildew pathogens, for example Blumeria species, for example Blumeria graminis; Podosphaera species, for example Podosphaera leucotricha; Sphaerotheca species, for example Sphaerotheca fuliginea; Uncinula species, for example Uncinula necator;

diseases caused by rust disease pathogens, for example Gymnosporangium species, for example Gymnosporangium sabinae; Hemileia species, for example Hemileia vastatrix; Phakopsora species, for example Phakopsora pachyrhizi and Phakopsora meibomiae; Puccinia species, for example Puccinia recondite, P. triticina, P. graminis or P. striiformis; Uromyces species, for example Uromyces appendiculatus;

diseases caused by pathogens from the group of the Oomycetes, for example Albugo species, for example Algubo candida; Bremia species, for example Bremia lactucae; Peronospora species, for example Peronospora pisi or P. brassicae; Phytophthora species, for example Phytophthora infestans; Plasmopara species, for example Plasmopara viticola; Pseudoperonospora species, for example Pseudoperonospora humuli or Pseudoperonospora cubensis; Pythium species, for example Pythium ultimurn;

leaf blotch diseases and leaf wilt diseases caused, for example, by Alternaria species, for example Alternaria solani; Cercospora species, for example Cercospora beticola; Cladiosporium species, for example Cladiosporium cucumerinum; Cochliobolus species, for example Cochliobolus sativus (conidia form: Drechslera, Syn: Helminthosporium), Cochliobolus miyabeanus; Colletotrichum species, for example Colletotrichum lindemuthanium; Cycloconium species, for example Cycloconium oleaginum; Diaporthe species, for example Diaporthe citri; Elsinoe species, for example Elsinoe fawcettii; Gloeosporium species, for example Gloeosporium laeticolor; Glomerella species, for example Glomerella cingulata; Guignardia species, for example Guignardia bidwelli; Leptosphaeria species, for example Leptosphaeria maculans, Leptosphaeria nodorum; Magnaporthe species, for example Magnaporthe grisea; Microdochium species, for example Microdochium nivale; Mycosphaerella species, for example Mycosphaerella graminicola, M. arachidicola and M. fijiensis; Phaeosphaeria species, for example Phaeosphaeria nodorum; Pyrenophora species, for example Pyrenophora teres, Pyrenophora tritici repentis; Ramularia species, for example Ramularia collo-cygni, Ramularia areola; Rhynchosporium species, for example Rhynchosporium secalis; Septoria species, for example Septoria apii, Septoria lycopersil; Typhula species, for example Typhula incarnata; Venturia species, for example Venturia inaequalis;

root and stem diseases caused, for example, by Corticium species, for example Corticium graminearum; Fusarium species, for example Fusarium oxysporum; Gaeumannomyces species, for example Gaeumannomyces graminis; Rhizoctonia species, such as, for example Rhizoctonia solani; Sarocladium diseases caused for example by Sarocladium oryzae; Sclerotium diseases caused for example by Sclerotium oryzae; Tapesia species, for example Tapesia acuformis; Thielaviopsis species, for example Thielaviopsis basicola;

ear and panicle diseases (including corn cobs) caused, for example, by Alternaria species, for example Alternaria spp.; Aspergillus species, for example Aspergillus flavus; Cladosporium species, for example Cladosporium cladosporioides; Claviceps species, for example Claviceps purpurea; Fusarium species, for example Fusarium culmorum; Gibberella species, for example Gibberella zeae; Monographella species, for example Monographella nivalis; Septoria species, for example Septoria nodorum;

diseases caused by smut fungi, for example Sphacelotheca species, for example Sphacelotheca reiliana; Tilletia species, for example Tilletia caries, T. controversa; Urocystis species, for example Urocystis occulta; Ustilago species, for example Ustilago nuda, U. nuda tritici;

fruit rot caused, for example, by Aspergillus species, for example Aspergillus flavus; Botrytis species, for example Botrytis cinerea; Penicillium species, for example Penicillium expansum and P. purpurogenum; Sclerotinia species, for example Sclerotinia sclerotiorum; Verticilium species, for example Verticilium alboatrum;

seed and soilborne decay, mold, wilt, rot and damping-off diseases caused, for example, by Alternaria species, caused for example by Alternaria brassicicola; Aphanomyces species, caused for example by Aphanomyces euteiches; Ascochyta species, caused for example by Ascochyta lentis; Aspergillus species, caused for example by Aspergillus flavus; Cladosporium species, caused for example by Cladosporium herbarum; Cochliobolus species, caused for example by Cochliobolus sativus; (Conidiaform: Drechslera, Bipolaris Syn: Helminthosporium); Colletotrichum species, caused for example by Colletotrichum coccodes; Fusarium species, caused for example by Fusarium culmorum; Gibberella species, caused for example by Gibberella zeae; Macrophomina species, caused for example by Macrophomina phaseolina; Monographella species, caused for example by Monographella nivalis; Penicillium species, caused for example by Penicillium expansum; Phoma species, caused for example by Phoma lingam; Phomopsis species, caused for example by Phomopsis sojae; Phytophthora species, caused for example by Phytophthora cactorum; Pyrenophora species, caused for example by Pyrenophora graminea; Pyricularia species, caused for example by Pyricularia oryzae; Pythium species, caused for example by Pythium ultimum; Rhizoctonia species, caused for example by Rhizoctonia solani; Rhizopus species, caused for example by Rhizopus oryzae; Sclerotium species, caused for example by Sclerotium rolfsii; Septoria species, caused for example by Septoria nodorum; Typhula species, caused for example by Typhula incarnata; Verticillium species, caused for example by Verticillium dahliae;

cankers, galls and witches' broom caused, for example, by Nectria species, for example Nectria galligena;

wilt diseases caused, for example, by Monilinia species, for example Monilinia laxa;

leaf blister or leaf curl diseases caused, for example, by Exobasidium species, for example Exobasidium vexans;

Taphrina species, for example Taphrina deformans;

decline diseases of wooden plants caused, for example, by Esca disease, caused for example by Phaemoniella clamydospora, Phaeoacremonium aleophilum and Fomitiporia mediterranea; Eutypa dyeback, caused for example by Eutypa lata; Ganoderma diseases caused for example by Ganoderma boninense; Rigidoporus diseases caused for example by Rigidoporus lignosus;

diseases of flowers and seeds caused, for example, by Botrytis species, for example Botrytis cinerea;

diseases of plant tubers caused, for example, by Rhizoctonia species, for example Rhizoctonia solani; Helminthosporium species, for example Helminthosporium solani;

club root caused, for example, by Plasmodiophora species, for example Plamodiophora brassicae; and

diseases caused by bacterial pathogens, for example Xanthomonas species, for example Xanthomonas campestris pv. oryzae; Pseudomonas species, for example Pseudomonas syringae pv. lachrymans; Erwinia species, for example Erwinia amylovora.

The following diseases of soy beans can be controlled with preference:

fungal diseases on leaves, stems, pods and seeds caused, for example, by Alternaria leaf spot (Alternaria spec. atrans tenuissima), Anthracnose (Colletotrichum gloeosporoides dematium var. truncatum), brown spot (Septoria glycines), cercospora leaf spot and blight (Cercospora kikuchii), choanephora leaf blight (Choanephora infundibulifera trispora (Syn.)), dactuliophora leaf spot (Dactuliophora glycines), downy mildew (Peronospora manshurica), drechslera blight (Drechslera glycini), frogeye leaf spot (Cercospora sojina), leptosphaerulina leaf spot (Leptosphaerulina trifolii), phyllostica leaf spot (Phyllosticta sojaecola), pod and stem blight (Phomopsis sojae), powdery mildew (Microsphaera diffusa), pyrenochaeta leaf spot (Pyrenochaeta glycines), rhizoctonia aerial, foliage, and web blight (Rhizoctonia solani), rust (Phakopsora pachyrhizi, Phakopsora meibomiae), scab (Sphaceloma glycines), stemphylium leaf blight (Stemphylium botryosum), target spot (Corynespora cassiicola).

Fungal diseases on roots and the stem base caused, for example, by black root rot (Calonectria crotalariae), charcoal rot (Macrophomina phaseolina), fusarium blight or wilt, root rot, and pod and collar rot (Fusarium oxysporum, Fusarium orthoceras, Fusarium semitectum, Fusarium equiseti), mycoleptodiscus root rot (Mycoleptodiscus terrestris), neocosmospora (Neocosmospora vasinfecta), pod and stem blight (Diaporthe phaseolorum), stem canker (Diaporthe phaseolorum var. caulivora), phytophthora rot (Phytophthora megasperma), brown stem rot (Phialophora gregata), pythium rot (Pythium aphanidermatum, Pythium irregulare, Pythium debaryanum, Pythium myriotylum, Pythium ultimum), rhizoctonia root rot, stem decay, and damping-off (Rhizoctonia solani), sclerotinia stem decay (Sclerotinia sclerotiorum), sclerotinia southern blight (Sclerotinia rolfsii), thielaviopsis root rot (Thielaviopsis basicola).

The combinatorial compositions can be used for curative or protective/preventive control of phytopathogenic fungi. Thus, exemplary methods of the invention also relate to curative and protective methods for controlling phytopathogenic fungi by the use of the combinatorial composition, which is applied to the seed, the plant or plant parts, the fruit or the soil in which the plants grow.

According to aspects of the invention, all plants and plant parts can be treated. By plants is meant all plants and plant populations such as desirable and undesirable wild plants, cultivars and plant varieties (whether or not protectable by plant variety or plant breeder's rights). Cultivars and plant varieties can be plants obtained by conventional propagation and breeding methods which can be assisted or supplemented by one or more biotechnological methods such as by use of double haploids, protoplast fusion, random and directed mutagenesis, CRISPR/Cas, grafting, RNAi molecular or genetic markers or by bioengineering and genetic engineering methods. By plant parts is meant all above ground and below ground parts and organs of plants such as shoot, leaf, blossom and root, whereby for example leaves, needles, stems, branches, blossoms, fruiting bodies, fruits and seed as well as roots, corms and rhizomes are listed. Crops and vegetative and generative propagating material, for example cuttings, corms, rhizomes, runners and seeds also belong to plant parts.

The combinatorial compositions, are well tolerated by plants, and have favorable homeotherm toxicity, are well tolerated by the environment, suitable for protecting plants and plant organs, for enhancing harvest yields and for improving the quality of the harvested material. They can preferably be used as crop protection compositions. The compositions are active against normally sensitive and tolerant species and against all or some stages of development.

Plants which can be treated include the following crop plants: maize, soya bean, alfalfa, cotton, sunflower, Brassica oil seeds such as Brassica napus (e.g., canola, rapeseed), Brassica rapa, B. juncea (e.g., (field) mustard) and Brassica carinata, Arecaceae sp. (e.g., oilpalm, coconut), rice, wheat, sugar beet, sugar cane, oats, rye, barley, millet and sorghum, triticale, flax, nuts, grapes and vine and various fruit and vegetables from various botanic taxa, e.g., Rosaceae sp. (e.g., pome fruits such as apples and pears, but also stone fruits such as apricots, cherries, almonds, plums and peaches, and berry fruits such as strawberries, raspberries, red and black currant and gooseberry), Ribesioidae sp., Juglandaceae sp., Betulaceae sp., Anacardiaceae sp., Fagaceae sp., Moraceae sp., Oleaceae sp. (e.g., olive tree), Actinidaceae sp., Lauraceae sp. (e.g., avocado, cinnamon, camphor), Musaceae sp. (e.g., banana trees and plantations), Rubiaceae sp. (e.g., coffee), Theaceae sp. (e.g., tea), Sterculiceae sp., Rutaceae sp. (e.g., lemons, oranges, mandarins and grapefruit); Solanaceae sp. (e.g., tomatoes, potatoes, peppers, capsicum, aubergines, tobacco), Liliaceae sp., Cornpositae sp. (e.g., lettuce, artichokes and chicory—including root chicory, endive or common chicory), Umbelliferae sp. (e.g., carrots, parsley, celery and celeriac), Cucurbitaceae sp. (e.g., cucumbers—including gherkins, pumpkins, watermelons, calabashes and melons), Alliaceae sp. (e.g., leeks and onions), Cruciferae sp. (e.g., white cabbage, red cabbage, broccoli, cauliflower, Brussels sprouts, pak choi, kohlrabi, radishes, horseradish, cress and chinese cabbage), Leguminosae sp. (e.g., peanuts, peas, lentils and beans—e.g. common beans and broad beans), Chenopodiaceae sp. (e.g., Swiss chard, fodder beet, spinach, beetroot), Linaceae sp. (e.g., hemp), Cannabeacea sp. (e.g., cannabis), Malvaceae sp. (e.g., okra, cocoa), Papaveraceae (e.g., poppy), Asparagaceae (e.g., asparagus); useful plants and ornamental plants in the garden and woods including turf, lawn, grass and Stevia rebaudiana; and in each case genetically modified types of these plants.

Preferably, plants which can be treated include those selected from the group consisting of fruits, vegetables, grains, and nuts from various botanic taxa, e.g., Rosaceae sp. (e.g., pome fruits such as apples and pears, but also stone fruits such as apricots, cherries, almonds, plums and peaches, and berry fruits such as strawberries, raspberries, red and black currant and gooseberry), Ribesioidae sp., Juglandaceae sp., Betulaceae sp., Anacardiaceae sp., Fagaceae sp., Moraceae sp., Oleaceae sp. (e.g., olive tree), Actinidaceae sp., Lauraceae sp. (e.g., avocado, cinnamon, camphor), Musaceae sp. (e.g., banana trees and plantations), Rubiaceae sp. (e.g., coffee), Theaceae sp. (e.g., tea), Sterculiceae sp., Rutaceae sp. (e.g., lemons, oranges, mandarins and grapefruit); Solanaceae sp. (e.g., tomatoes, potatoes, peppers, capsicum, aubergines, tobacco), Liliaceae sp., Compositae sp. (e.g., lettuce, artichokes and chicory—including root chicory, endive or common chicory), Umbelliferae sp. (e.g., carrots, parsley, celery and celeriac), Cucurbitaceae sp. (e.g., cucumbers—including gherkins, pumpkins, watermelons, calabashes and melons), Alliaceae sp. (e.g., leeks and onions), Cruciferae sp. (e.g., white cabbage, red cabbage, broccoli, cauliflower, Brussels sprouts, pak choi, kohlrabi, radishes, horseradish, cress and chinese cabbage), Leguminosae sp. (e.g., peanuts, peas, lentils and beans—e.g., common beans and broad beans), Chenopodiaceae sp. (e.g., Swiss chard, fodder beet, spinach, beetroot), Linaceae sp. (e.g., hemp), Cannabeacea sp. (e.g., cannabis), Malvaceae sp. (e.g., okra, cocoa), Papaveraceae (e.g., poppy), Asparagaceae (e.g., asparagus); useful plants and ornamental plants in the garden and woods including turf, lawn, grass and Stevia rebaudiana; and in each case genetically modified types of these plants.

More preferably, plants which can be treated include species: wheat, corn, soybean, banana, canola, potato, grapes, peanut, barley, rice, wheat, sugar beet, sugar cane, oats, rye, millet, sorghum, cotton, strawberry, and grapes.

Depending on the plant species or plant cultivars, their location and growth conditions (soils, climate, vegetation period, diet), using or employing the combinatorial composition may also result in super-additive (“synergistic”) effects. Thus, for example, by using or employing the combinatorial composition in the described methods of treatment, reduced application rates and/or a widening of the activity spectrum and/or an increase in the activity, better plant growth and/or extending the duration of the disease control between treatment applications, increased tolerance to high or low temperatures, increased tolerance to drought or to water or soil salt content, increased flowering performance, easier harvesting, accelerated maturation, higher harvest yields, bigger fruits, larger plant height, greener leaf color, earlier flowering, higher quality and/or a higher nutritional value of the harvested products, higher sugar concentration within the fruits, better storage stability and/or processability of the harvested products are possible, which exceed the effects which were actually to be expected.

At certain application rates of the combinatorial compositions, the treatment may also have a strengthening effect in plants. The defense system of the plant against attack by phytopathogenic fungi and/or microorganisms and/or viruses is mobilized. Plant-strengthening (resistance-inducing) substances are to be understood as meaning, in the present context, those substances or combinations of substances which are capable of stimulating the defense system of plants in such a way that, when subsequently inoculated with unwanted phytopathogenic fungi and/or microorganisms and/or viruses, the treated plants display a substantial degree of resistance to these phytopathogenic fungi and/or microorganisms and/or viruses. Thus, by using or employing combinatorial compositions in the described treatment, plants can be protected against attack by the abovementioned pathogens within a certain period of time after the treatment. The period of time within which protection is effected generally extends from 1 to 21 days, preferably 1 to 10 days, after the treatment of the plants with the combinatorial composition.

Plants and plant cultivars which are also preferably to be treated are resistant against one or more biotic stresses, i.e., said plants show a better defense against animal and microbial pests, such as against nematodes, insects, mites, phytopathogenic fungi, bacteria, viruses, and/or viroids.

Plants and plant cultivars which may also be treated are those plants which are resistant to one or more abiotic stresses, i.e., that already exhibit an increased plant health with respect to stress tolerance. Abiotic stress conditions may include, for example, drought, cold temperature exposure, heat exposure, osmotic stress, flooding, increased soil salinity, increased mineral exposure, ozone exposure, high light exposure, limited availability of nitrogen nutrients, limited availability of phosphorus nutrients, and shade avoidance. Preferably, the treatment of these plants and cultivars with the combinatorial compositions of the present invention additionally increases the overall plant health (cf. above).

Plants and plant cultivars which may also be treated, are those plants characterized by enhanced yield characteristics, i.e., that already exhibit an increased plant health with respect to this feature. Increased yield in said plants can be the result of, for example, improved plant physiology, growth and development, such as water use efficiency, water retention efficiency, improved nitrogen use, enhanced carbon assimilation, improved photosynthesis, increased germination efficiency and accelerated maturation. Yield can furthermore be affected by improved plant architecture (under stress and non-stress conditions), including but not limited to, early flowering, flowering control for hybrid seed production, seedling vigor, plant size, internode number and distance, root growth, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content, protein content, oil content and composition, nutritional value, reduction in anti-nutritional compounds, improved processability and better storage stability. Preferably, the treatment of these plants and cultivars with the combinatorial composition additionally increases the overall plant health (cf. above).

Plants or plant cultivars (obtained by plant biotechnology methods such as genetic engineering) which may be treated with the combinatorial compositions include herbicide-tolerant plants, i.e., plants made tolerant to one or more given herbicides. Such plants can be obtained either by genetic manipulation, or by selection of plants containing a mutation imparting such herbicide tolerance.

Herbicide-tolerant plants are for example glyphosate-tolerant plants, i.e. plants made tolerant to the herbicide glyphosate or salts thereof. Other herbicide resistant plants are for example plants that are made tolerant to herbicides inhibiting the enzyme glutamine synthase, such as bialaphos, phosphinothricin, or glufosinate. Further herbicide-tolerant plants are also plants that are made tolerant to the herbicides inhibiting the enzyme hydroxyphenylpyruvatedioxygenase (HPPD). Hydroxyphenylpyruvatedioxygenases are enzymes that catalyze the reaction in which para-hydroxyphenylpyruvate (HPP) is transformed into homogentisate. Plants tolerant to HPPD-inhibitors can be created by methods known by those of skill a naturally-occurring resistant HPPD enzyme, or a gene encoding a mutated HPPD enzyme.

Still further herbicide resistant plants are plants that are made tolerant to acetolactate synthase (ALS) inhibitors. Known ALS-inhibitors include, for example, sulfonylurea, imidazolinone, triazolopyrimidines, pyrimidinyoxy(thio)benzoates, and/or sulfonylaminocarbonyltriazolinone herbicides. Different mutations in the ALS enzyme (also known as acetohydroxyacid synthase, AHAS) are known to confer tolerance to different herbicides and groups of herbicides.

Other plants tolerant to imidazolinone and/or sulfonylurea can be obtained by induced mutagenesis, selection in cell cultures in the presence of the herbicide or mutation breeding as described for example for soybeans, for rice, for sugar beet, for lettuce, or for sunflower.

Plants or plant cultivars (obtained by plant biotechnology methods such as genetic engineering) which may also be treated according to the invention are insect-resistant transgenic plants. Such plants can be obtained by genetic manipulation, or by selection of plants containing a mutation imparting such insect resistance.

An “insect-resistant transgenic plant”, as used herein, includes any plant containing at least one transgene comprising a coding sequence encoding:

1) an insecticidal crystal protein from Bacillus thuringiensis or an insecticidal portion thereof, such as the insecticidal crystal proteins listed online at: http://www.lifesci.sussex.ac.uk/Home/Neil_Crickmore/Bt/, or insecticidal portions thereof, e.g., proteins of the Cry protein classes Cry1Ab, Cry1Ac, Cry1F, Cry2Ab, Cry3Aa, or Cry3Bb or insecticidal portions thereof; or

2) a crystal protein from Bacillus thuringiensis or a portion thereof which is insecticidal in the presence of a second other crystal protein from Bacillus thuringiensis or a portion thereof, such as the binary toxin made up of the Cry34 and Cry35 crystal proteins; or

3) a hybrid insecticidal protein comprising parts of different insecticidal crystal proteins from Bacillus thuringiensis, such as a hybrid of the proteins of 1) above or a hybrid of the proteins of 2) above, e.g., the Cry1 A.105 protein produced by corn event MON98034 (WO 2007/027777); or

4) a protein of any one of 1) to 3) above wherein some, particularly 1 to 10, amino acids have been replaced by another amino acid to obtain a higher insecticidal activity to a target insect species, and/or to expand the range of target insect species affected, and/or because of changes introduced into the encoding DNA during cloning or transformation, such as the Cry3Bb1 protein in corn events MON863 or MON88017, or the Cry3A protein in corn event MIR604; or

5) an insecticidal secreted protein from Bacillus thuringiensis or Bacillus cereus, or an insecticidal portion thereof, such as the vegetative insecticidal (VIP) proteins listed at: http://www.lifesci.sussex.ac.uk/home/Neil_Crickmore/Bt/vip.html, e.g. proteins from the VIP3Aa protein class; or

6) secreted protein from Bacillus thuringiensis or Bacillus cereus which is insecticidal in the presence of a second secreted protein from Bacillus thuringiensis or B. cereus, such as the binary toxin made up of the VIP1A and VIP2A proteins; or

7) hybrid insecticidal protein comprising parts from different secreted proteins from Bacillus thuringiensis or Bacillus cereus, such as a hybrid of the proteins in 1) above or a hybrid of the proteins in 2) above; or

8) protein of any one of 1) to 3) above wherein some, particularly 1 to 10, amino acids have been replaced by another amino acid to obtain a higher insecticidal activity to a target insect species, and/or to expand the range of target insect species affected, and/or because of changes introduced into the encoding DNA during cloning or transformation (while still encoding an insecticidal protein), such as the VIP3Aa protein in cotton event COT102.

Of course, an insect-resistant transgenic plant, as used herein, also includes any plant comprising a combination of genes encoding the proteins of any one of the above classes 1 to 8. In one embodiment, an insect-resistant plant contains more than one transgene encoding a protein of any one of the above classes 1 to 8, to expand the range of target insect species affected when using different proteins directed at different target insect species, or to delay insect resistance development to the plants by using different proteins insecticidal to the same target insect species but having a different mode of action, such as binding to different receptor binding sites in the insect.

Plants or plant cultivars (obtained by plant biotechnology methods such as genetic engineering) which may also be treated with the combinatorial compositions are tolerant to abiotic stresses. Such plants can be obtained by genetic transformation, or by selection of plants containing a mutation imparting such stress resistance. Particularly useful stress tolerance plants include: a. plants which contain a transgene capable of reducing the expression and/or the activity of poly(ADP-ribose)polymerase (PARP) gene in the plant cells or plants, b. plants which contain a stress tolerance enhancing transgene capable of reducing the expression and/or the activity of the poly(ADP-ribose) glycohydrolase (PARG) encoding genes of the plants or plants cells, and c. plants which contain a stress tolerance enhancing transgene coding for a plant-functional enzyme of the nicotinamide adenine dinucleotide salvage synthesis pathway including nicotinamidase, nicotinate phosphoribosyltransferase, nicotinic acid mononucleotide adenyl transferase, nicotinamide adenine dinucleotide synthetase or nicotine amide phosphorybosyltransferase.

Plants or plant cultivars (obtained by plant biotechnology methods such as genetic engineering) which may also be treated with the combinatorial compositions show altered quantity, quality and/or storage-stability of the harvested product and/or altered properties of specific ingredients of the harvested product such as: 1) transgenic plants which synthesize a modified starch, which in its physical-chemical characteristics, in particular the amylose content or the amylose/amylopectin ratio, the degree of branching, the average chain length, the side chain distribution, the viscosity behavior, the gelling strength, the starch grain size and/or the starch grain morphology, is changed in comparison with the synthesized starch in wild type plant cells or plants, so it is better suited for special applications, 2) transgenic plants which synthesize non starch carbohydrate polymers or which synthesize non starch carbohydrate polymers with altered properties in comparison to wild type plants without genetic modification. Examples are plants producing polyfructose, especially of the inulin and levan-type, plants producing alpha 1,4-glucans, plants producing alpha-1,6 branched alpha-1,4-glucans, plants producing alternan, and 3) transgenic plants which produce hyaluronan.

Plants or plant cultivars (that can be obtained by plant biotechnology methods such as genetic engineering) which may also be treated with the combinatorial compositions are plants, such as cotton plants, with altered fiber characteristics. Such plants can be obtained by genetic transformation or by selection of plants that contain a mutation imparting such altered fiber characteristics and include: a) plants, such as cotton plants, containing an altered form of cellulose synthase genes, b) plants, such as cotton plants, containing an altered form of rsw2 or rsw3 homologous nucleic acids, c) plants, such as cotton plants, with increased expression of sucrose phosphate synthase, d) plants, such as cotton plants, with increased expression of sucrose synthase, e) plants, such as cotton plants, wherein the timing of the plasmodesmatal gating at the basis of the fiber cell is altered, e.g. through downregulation of fiberselective β1,3-glucanase, and f) plants, such as cotton plants, having fibers with altered reactivity, e.g. through the expression of N-acteylglucosaminetransferase gene including nodC and chitinsynthase genes.

Plants or plant cultivars (that can be obtained by plant biotechnology methods such as genetic engineering) which may also be treated with combinatorial compositions are plants, such as oilseed rape or related Brassica plants, with altered oil profile characteristics. Such plants can be obtained by genetic transformation or by selection of plants contain a mutation imparting such altered oil characteristics and include: a) plants, such as oilseed rape plants, producing oil having a high oleic acid content, b) plants such as oilseed rape plants, producing oil having a low linolenic acid content, c) plant such as oilseed rape plants, producing oil having a low level of saturated fatty acids.

Particularly useful transgenic plants which may be treated with combinatorial compositions are plants which comprise one or more genes which encode one or more toxins, such as the following which are sold under the trade names YIELD GARD® (for example maize, cotton, soya beans), KnockOut® (for example maize), BiteGard® (for example maize), Bt-Xtra® (for example maize), StarLink® (for example maize), Bollgard® (cotton), Nucotn® (cotton), Nucotn 33B® (cotton), NatureGard® (for example maize), Protecta® and NewLeaf® (potato). Examples of herbicide-tolerant plants which may be mentioned are maize varieties, cotton varieties and soy bean varieties which are sold under the trade names Roundup Ready® (tolerance to glyphosate, for example maize, cotton, soya bean), Liberty Link® (tolerance to phosphinotricin, for example oilseed rape), IMI® (tolerance to imidazolinones) and STS® (tolerance to sulphonylureas, for example maize). Herbicide-resistant plants (plants bred in a conventional manner for herbicide tolerance) which may be mentioned include the varieties sold under the name Clearfield® (for example maize).

Particularly useful transgenic plants which may be treated with combinatorial compositions are plants containing transformation events, or combination of transformation events, that are listed for example in the databases from various national or regional regulatory agencies (see for example http://gmoinfo.jrc.it/gmp_browse.aspx and http://www.agbios.com/dbase.php).

### Seed Treatment

In another aspect of the present invention a seed treated with the combinatorial composition is provided.

The control of insects, mites, nematodes, and/or phytopathogens by treating the seed of plants has been known for a long time and is a subject of continual improvements. Nevertheless, the treatment of seed entails a series of problems which cannot always be solved in a satisfactory manner. Thus, it is desirable to develop methods for protecting the seed and the germinating plant that remove the need for, or at least significantly reduce, the additional delivery of crop protection compositions in the course of storage, after sowing or after the emergence of the plants. It is desirable, furthermore, to optimize the amount of active ingredient employed in such a way as to provide the best-possible protection to the seed and the germinating plant from attack by insects, mites, nematodes and/or phytopathogens, but without causing damage to the plant itself by the active ingredient employed. In particular, methods for treating seed should take into consideration the intrinsic insecticidal and/or nematicidal properties of pest-resistant or pest-tolerant transgenic plants, in order to achieve optimum protection of the seed and of the germinating plant with a minimal use of crop protection compositions.

Also described herein is a method for protecting seed and germinating plants from attack by pests, by treating the seed with at least one biological agent as defined above and/or a mutant of it having all identifying characteristics of the respective strain, and/or a metabolite produced by the respective strain that exhibits activity against insects, mites, nematodes and/or phytopathogens and at least one benzoxaborole and optionally at least one fungicide, pesticide, or insecticide. The method for protecting seed and germinating plants from attack by pests encompasses a method in which the seed is treated simultaneously in one operation with the at least one biological agent and the at least one benzoxaborole, and optionally the at least one fungicide, pesticide, or insecticide. It also encompasses a method in which the seed is treated at different times with the at least one biological agent and the at least one benzoxaborole, and optionally the at least one fungicide, pesticide, or insecticide.

The invention likewise relates to the use of the combinatorial composition for treating seed for the purpose of protecting the seed and the resultant plant against insects, mites, nematodes and/or phytopathogens.

The invention also relates to seed which at the same time has been treated with the at least one biological agent and the at least one benzoxaborole, and optionally at least one fungicide, pesticide, or insecticide. The invention further relates to seed which has been treated at different times with the at least one biological agent and the at least one benzoxaborole and optionally the at least one fungicide, pesticide, or insecticide. In the case of seed which has been treated at different times with the at least one biological agent and the at least one benzoxaborole, and optionally the at least one fungicide, pesticide, or insecticide, the individual active ingredients in the combinatorial composition may be present in different layers on the seed.

Furthermore, the invention relates to seed which, following treatment with the combinatorial composition of the invention, is subjected to a film-coating process in order to prevent dust abrasion of the seed.

One of the advantages of the present invention is that, owing to the particular systemic properties of the combinatorial compositions, the treatment of the seed with the combinatorial compositions provides protection from insects, mites, nematodes and/or phytopathogens not only to the seed itself but also to the plants originating from the seed, after they have emerged. In this way, it may not be necessary to treat the crop directly at the time of sowing or shortly thereafter.

A further advantage is that, through the treatment of the seed with the combinatorial composition, germination and emergence of the treated seed may be promoted.

It is likewise considered to be advantageous that the combinatorial composition may also be used, in particular, on transgenic seed.

Furthermore, the combinatorial composition may be used in combination with agents of phosphate technology, as a result of which, for example, colonization with symbionts is improved, such as rhizobia, mycorrhiza and/or endophytic bacteria, for example, is enhanced, and/or nitrogen fixation is optimized.

The combinatorial compositions are suitable for protecting seed of any variety of plant which is used in agriculture, in greenhouses, in forestry or in horticulture. For example, the seed may be that of cereals (e.g. wheat, barley, rye, oats and millet), maize, cotton, soybeans, rice, potatoes, sunflower, coffee, tobacco, canola, oilseed rape, beets (e.g. sugar beet and fodder beet), peanuts, vegetables (e.g. tomato, cucumber, bean, brassicas, onions and lettuce), fruit plants, lawns and ornamentals. In an exemplary embodiment, the treatment of the seed of cereals (such as wheat, barley, rye and oats) maize, soybeans, cotton, canola, oilseed rape and rice, is particularly important.

As already mentioned above, the treatment of transgenic seed with the combinatorial compositions can be particularly important. The seed in question here is that of plants which generally contain at least one heterologous gene that controls the expression of a polypeptide having, in particular, insecticidal and/or nematicidal properties. The heterologous genes in transgenic seed may come from microorganisms such as Bacillus, Rhizobium, Pseudomonas, Serratia, Trichoderma, Clavibacter, Glomus or Gliocladium. The combinatorial compositions can be particularly suitable for the treatment of transgenic seed that contains at least one heterologous gene from Bacillus sp. With particular preference, the heterologous gene in question comes from Bacillus thuringiensis.

The combinatorial composition can be applied alone or in a suitable formulation to the seed. The seed is preferably treated in a condition in which its stability is such that no damage occurs in the course of the treatment. Generally speaking, the seed may be treated at any point in time between harvesting and sowing. Typically, seed is used which has been separated from the plant and has had cobs, hulls, stems, husks, hair, or pulp removed. Thus, for example, seed may be used that has been harvested, cleaned and dried to a moisture content of less than 15% by weight. Alternatively, seed can also be used that after drying has been treated with water, for example, and then dried again.

When treating seed, the amount of the combinatorial composition and/or of other additives that is applied to the seed should be selected such that the germination of the seed is not adversely affected and/or the plant which emerges from the seed is not damaged. Amount selection is particularly important with active ingredients that may exhibit phytotoxic effects at certain application rates.

The combinatorial compositions can be applied directly (i.e., without comprising further components and without having been diluted). In exemplary embodiments, it is preferable to apply the combinatorial compositions in the form of a suitable formulation to the seed. Suitable formulations and methods for seed treatment are known to the skilled person and are described in, for example, the following documents: U.S. Pat. Nos. 4,272,417; 4,245,432; 4,808,430; 5,876,739; U.S. Application Publication No. 2003/0176428, and International Application Publication Nos. WO 2002/080675 A1 and WO 2002/028186 A2.

The combinatorial compositions described herein can be formulated into customary seed-dressing formulations, such as solutions, emulsions, suspensions, powders, foams, slurries or other coating compositions for seed, and also Ultralow Volume (“ULV”) formulations.

The formulations are prepared by mixing the combinatorial composition with customary adjuvants, such as, for example, customary extenders and also solvents or diluents, colorants, wetters, dispersants, emulsifiers, antifoams, antioxidants, preservatives, secondary thickeners, stickers, gibberellins, and also water.

Colorants, which also may be present in the seed-dressing formulations, include all colorants that are customary for such purposes. In this context it is possible to use not only pigments, which are of low solubility in water, but also water-soluble dyes. Examples include the colorants known under the designations Rhodamin B, C.I. Pigment Red 112 and C.I. Solvent Red 1.

Wetters, which also may be present in the seed-dressing formulations, include all of the substances that promote wetting and are customary in the formulation of active agrochemical ingredients. Use may be made preferably of alkylnaphthalenesulphonates, such as diisopropyl- or diisobutyl-naphthalenesulphonates.

Dispersants and/or emulsifiers, which also may be present in the seed-dressing formulations, include all of the nonionic, anionic and cationic dispersants that are customary in the formulation of active agrochemical ingredients. Use may be made preferably of nonionic or anionic dispersants or of mixtures of nonionic or anionic dispersants. Suitable nonionic dispersants are, in particular, ethylene oxide-propylene oxide block polymers, alkylphenol polyglycol ethers and also tristryrylphenol polyglycol ethers, and the phosphateor sulphated derivatives of these. Suitable anionic dispersants are, in particular, lignosulphonates, salts of polyacrylic acid, and arylsulphonate-formaldehyde condensates.

Antifoams, which also may be present in the seed-dressing formulations, include all of the foam inhibitors that are customary in the formulation of active agrochemical ingredients. Use may be made preferably of silicone antifoams and magnesium stearate.

Antioxidants, which may be present in the seed-dressing, systemic, soil drench, and foliar spray formulations, are preferably those that have a low level of phytotoxicity. It is also preferred that the antioxidant that is used in the present method and combinatorial compositions be one that is approved for use in food, feed, or cosmetics. Examples of approval include approval by a regulatory body, such as the U.S. Food and Drug Administration for use in food or cosmetics, or approval by the U.S. Department of Agriculture for use in animal feed. Antioxidants that have GRAS (Generally Recognized As Safe) status are examples of preferred antioxidants. In some embodiments of the present invention, it is preferred that the antioxidant is one that is added to the seed, as opposed to an antioxidant that is a natural component of the seed. However, such preferred antioxidants can include natural antioxidants that are added to the seed during the present treatment process.

Examples of materials that can serve as an antioxidant include: glycine, glycinebetaine, choline salts, in particular choline chloride, 2(3)-tert-butyl-4-hydroxyanisole (BHA), tert-butylhydroxyquinone (TBHQ), dilauryl thiodipropionate (DLTDP), tris(nonylphenyl))phosphite (TNPP), 2,6-dihydroxybenzoic acid (DHBA), acetylsalicylic acid (ASA), salicylic acid (SA), Irganox 1076 (Ciba Geigy), Ethanox 330 (Ethyl Corp.), Tinuvin 144 (Ciba Geigy), Ambiol (2-methyl-4-[dimethylaminomethyl]-5-hydroxybenzimidazole), propyl gallate, trihydroxybutyrophenone (THBP), thiodipropionic acid and dilauryl thiodipropionate, betaines (see, AU-B-27071/95 to Bodapati, and EO 0 493 670 A1 to Lunkenheimer et al.), amines (aromatic amines and hindered amines), methionine, cysteine, proline, mannitol, phosphites, thioesters, lecithin, gum or resin guiac, Vitamin E, polyphenols, Vitamin A, carotenoids (beta-carotene), Vitamin B, Vitamin C, tocopherols, alpha-lipoic acid, coenzyme Q10 CoQ10), grape seed extract, green tea, lutein, N-acetyl Cysteine (NAC), OPCs (pycnogenols), selenium, zinc, 2,6-di-tert-para-benzoquinone, abscisic acid, bioflavonoids, DMAE (N,N-Dimethylethanolamine, precursor of choline), metronidazole, 2-methyl-5-nitroimidazole, glyoxal, polymerized 2,2,4-trimethyl-1,2-dihydroquinoline, 2-mercaptobenzimidazol, 5-tert-butyl-4-hydroxy-2-methyl-phenyl sulfide (CAS RN 96-69-5), 4-tert-butylphenol (CAS RN 98-54-4), catechol (CAS RN 120-80-9), 2-naphthol (2-hydroxynaphthalene) (CAS RN 135-19-3), octadecyl-3-(3′,5′-di-tert-butyl-4-hydroxyphenyl)propionate (CAS RN 2082-79-3), 1,3,5-trimethyl-2,4,6-tris(3,5-di-tert-butyl-4-hydroxybenzyl)benzene (CAS RN 1709-70-2), and tris-(2,4,-di-tert-butylphenyl)phosphite (CAS RN 31570-04-4).

In some embodiments, hindered phenol antioxidants are preferred. Examples of hindered phenol antioxidants include: 2,6-di-tert-butyl-p-cresol (BHT) (CAS RN 128-37-0), 2(3)-tert-butyl-4-hydroxyanisole (BHA), isobutylenated methylstyrenated phenol (CAS RN 68457-74-9), styrenated phenol (CAS RN 61788-44-1), 2,6-di-tert-butyl-4-(octadecanoxycarbonylethyl)phenol (CAS RN 2082-79-3), 4,4′-thiobis-6-(t-butyl-m-cresol) (CAS RN 96-69-5), 4,4′-butylidenebis(6-t-butyl-m-cresol) (CAS RN 85-60-9), 4,4′-(1-methylethylidene)bis[2-(1,1-dimethylethyl)]phenol (CAS RN 79-96-9), 2,2′-methylenebis(4-methyl-6-nonyl)phenol (CAS RN 7786-17-6), 4-methyl-phenol reaction products with dicyclopentadiene and isobutylene (CAS RN 68610-51-5), tetrakis-(methylene-(3,5-di-tertbutyl-4-hydrocinnamate) methane (CAS RN 6683-19-8), tert-butylhydroxyquinone (TBHQ), Irganox 1076, Ethanox 330, and 1,3,5-tris(3,5-di-tert-butyl-4-hydroxybenzyl-)-1,3,5-triazine-2,4,6(1H,3H,5H)-trione (CAS RN 27676-62-6).

Preservatives, which may be present in the seed-dressing formulations, include all of the substances that can be employed for such purposes in agrochemical compositions. Examples include dichlorophen and benzyl alcohol hemiformal.

Secondary thickeners, which may be present in the seed-dressing formulations, include all substances that can be used for such purposes in agrochemical compositions. Those contemplated with preference include cellulose derivatives, acrylic acid derivatives, xanthan, modified clays and highly disperse silica.

Stickers, which may be present in the seed-dressing formulations, include all customary binders that can be used in seed-dressing products. Preferred mention may be made of polyvinylpyrrolidone, polyvinyl acetate, polyvinyl alcohol and tylose.

Gibberellins, which may be present in the seed-dressing formulations, include preferably the gibberellins A1, A3 (=gibberellic acid), A4 and A7, with gibberellic acid being used with particular preference. The gibberellins are known (cf. R. Wegler, “Chemie der Pflanzenschutz-und Schädlingsbekampfungsmittel”, Volume 2, Springer Verlag, 1970, pp. 401-412).

The seed-dressing formulations may be used, either directly or after prior dilution with water, to treat seed of any of a wide variety of types. Accordingly, the concentrates or the preparations obtainable from them by dilution with water may be employed to dress the seed of cereals, such as wheat, barley, rye, oats and triticale, and also the seed of maize, rice, oilseed rape, peas, beans, cotton, sunflowers and beets, or else the seed of any of a very wide variety of vegetables. The seed-dressing formulations or their diluted preparations may also be used to dress seed of transgenic plants. In that case, additional synergistic effects may occur in interaction with the substances formed through expression.

For the treatment of seed with the seed-dressing formulations or with the preparations produced from them by addition of water, suitable mixing equipment includes all such equipment which can typically be employed for seed dressing. More particularly, the procedure when carrying out seed dressing is to place the seed in a mixer, to add the particular desired amount of seed-dressing formulations, either as such or following dilution with water beforehand, and to carry out mixing until the distribution of the formulation on the seed is uniform. This may be followed by a drying operation.

The application rate of the seed-dressing formulations may be varied within a relatively wide range. It is guided by the particular amount of the at least one biological agent and the at least one benzoxaborole in the formulations, and by the seed. The application rates in the case of the composition are situated generally between 0.001 and 50 g per kilogram of seed, preferably between 0.01 and 15 g per kilogram of seed.

### Combinatorial Compositions in Animal Health

The benzoxaborole and biologic combinatorial compositions described herein also have a curative and/or preventative effect in the treatment of animals including humans. In particular, the combinatorial compositions are useful in the control of parasitical, bacterial, or fungal pathogens.

The combinatorial compositions may be used in combination with a second therapeutic agent active against the same pathogenic or dysbiotic state. The dosage of each composition/active agent may differ from the dosage used when the composition is used alone. Appropriate doses will be readily appreciated by those skilled in the art.

It will be appreciated that the amount of the combinatorial composition used in treatment will vary with the nature of the condition being treated and the age and the condition of the patient and will be ultimately at the discretion of the attendant physician or veterinarian. In an exemplary embodiment, the additional therapeutic agent is an acaricide, ixodicide, miticide, pyrethrine, permethin or pyrethrum or phenothrin, a chloride channel inhibitor, an avermectin, selamectin or doramectin or abamectin, ivermectin, a milbemycin, milbemectin or moxidectin or nemadectin, or milbemycin oxime. In an exemplary embodiment, a first additional therapeutic agent is milbemycin oxime and a second additional therapeutic agent is a spinosad. In an additional exemplary embodiment, the additional therapeutic agent is an organophosphate, malathion, lindane, disulfuram, benzyl benzoate, fipronil, an isoxazoline moiety, or Nissan A1443.

In a further exemplary embodiment, the additional therapeutic agent is spinetoram, spinosyn, or spinosyn A or a salt, (e.g., pharmaceutically acceptable salt), prodrug, solvate or hydrate thereof. In a further exemplary embodiment, the additional therapeutic agent is spinosyn D, or spinosyn D or a salt, (e.g. pharmaceutically acceptable salt), prodrug, solvate or hydrate thereof. In exemplary embodiments, Comforts® is administered in combination with a compound described herein, optionally with a pharmaceutically acceptable excipient. In exemplary embodiments, any pharmaceutical formulation comprising a spinosad (e.g., a pharmaceutical formulation comprising (a) a pharmaceutically acceptable excipient; (b) a compound of the invention and (c) a spinosad (e.g., spinosyn A or spinosyn D) is administered orally. In exemplary embodiments, any pharmaceutical formulation comprising a spinosad is administered to kill or inhibit the growth of fleas. In exemplary embodiments, any pharmaceutical formulation comprising a spinosad is administered to kill or inhibit the growth of ticks.

The individual components of the combinatorial compositions may be administered either simultaneously or sequentially in a unit dosage form. The unit dosage form may be a single or multiple unit dosage forms. In an exemplary embodiment, the combinatorial composition may be provided in a single unit dosage form. An example of a single unit dosage form is a capsule wherein both the benzoxaborole and the at least one biologic agent are contained within the same capsule. Other embodiments may contain the combinatorial composition in a dip, topical, foam, bath, or injectable form. In an exemplary embodiment, the combinatorial composition is provided in a two unit dosage form. An example of a two unit dosage form is a first capsule which contains the benzoxaborole and a second capsule which contains the at least one biologic agent. Thus the term ‘single unit’ or ‘two units’ or ‘multiple unit’ refers to the object being applied to the plant or plant materials rather than to the interior components of the object. Appropriate doses of benzoxaborole and biologic agents will be readily appreciated by those skilled in the art.

The combinatorial compositions referred to herein may be presented for use as a pharmaceutical formulation. Thus, an exemplary embodiment of the invention is a pharmaceutical formulation comprising a) a benzoxaborole; b) a biologic agent, and c) a pharmaceutically acceptable excipient. Thus, an exemplary embodiment of the invention is a pharmaceutical formulation comprising a) a benzoxaborole; b) a biologic agent; c) a therapeutic agent; and d) a pharmaceutically acceptable excipient. In an exemplary embodiment, the pharmaceutical formulation is a unit dosage form. In an exemplary embodiment, the pharmaceutical formulation is a single unit dosage form. In an exemplary embodiment, the pharmaceutical formulation is a two-unit dosage form. In an exemplary embodiment, the pharmaceutical formulation is a two unit dosage form comprising a first unit dosage form and a second unit dosage form, wherein the first unit dosage form includes: a) a benzoxaborole and b) a first pharmaceutically acceptable excipient; and the second unit dosage form includes c) a biologic agent and d) a second pharmaceutically acceptable excipient.

It is to be understood that the invention covers all combinations of aspects and/or embodiments, as well as suitable, convenient and preferred groups described herein.

In a further aspect, the invention provides a method of killing and/or inhibiting the growth of an ectoparasite, said method comprising: contacting said ectoparasite with an effective amount of a combinatorial composition comprising a benzoxaborole and biologic agent, thereby killing and/or inhibiting the growth of the ectoparasite. In an exemplary embodiment, the ectoparasite is an acari, a tick, or a mite.

In an exemplary embodiment, the benzoxaborole of the combinatorial composition is as described herein, or is a salt, prodrug, hydrate or solvate thereof, or a combination thereof. In an exemplary embodiment, the invention provides a benzoxaborole of the combinatorial composition described herein, or a salt, hydrate or solvate thereof. In an exemplary embodiment, the invention provides a compound described herein, or a prodrug thereof. In an exemplary embodiment, the invention provides a compound described herein, or a salt thereof. In another exemplary embodiment, the benzoxaborole of the combinatorial composition is a benzoxaborole described above, or a pharmaceutically acceptable salt thereof. In another exemplary embodiment, the benzoxaborole of the combinatorial composition is described by a formula listed above, or a pharmaceutically acceptable salt thereof. In an exemplary embodiment, the benzoxaborole of the combinatorial composition is part of a pharmaceutical formulation described herein. In another exemplary embodiment, the contacting occurs under conditions which permit entry of the benzoxaborole of the combinatorial composition into the organism.

In another aspect, the ectoparasite is on the surface of an animal. In another aspect, the ectoparasite is in an animal. In an exemplary embodiment, the animal is selected from the group consisting of human, cattle, deer, reindeer, goat, honey bee, pig, sheep, horse, cow, bull, dog, guinea pig, gerbil, rabbit, cat, camel, yak, elephant, ostrich, otter, chicken, duck, goose, guinea fowl, pigeon, swan, and turkey. In another exemplary embodiment, the animal is a human. In an exemplary embodiment, the animal is a warm-blooded animal.

In an exemplary embodiment, the ectoparasite is killed or its growth is inhibited through oral administration of the combinatorial composition. In an exemplary embodiment, the ectoparasite is killed or its growth is inhibited through subcutaneous administration of the combinatorial composition.

In an exemplary embodiment, the ectoparasite is an insect. In an exemplary embodiment, the insect is selected from the group consisting of Lepidoptera, Coleoptera, Homoptera, Hemiptera, Heteroptera, Diptera, Dictyoptera, Thysanoptera, Orthoptera, Anoplura, Siphonaptera, Mallophaga, Thysanura, Isoptera, Psocoptera and Hymenoptera. However, the ectoparasites which may be mentioned in particular are those which trouble humans or animals and carry pathogens, for example flies such as Musca domestica, Musca vetustissima, Musca autumnalis, Fannie canicularis, Sarcophage carnaria, Lucilia cuprina, Lucilia sericata, Hypoderma bovis, Hypoderma lineatum, Chrysomyia chloropyga, Dermatobie hominis, Cochliomyia hominivorax, Gasterophilus intestinalis, Oestrus ovis, biting flies such as Haematobia irritans irritans, Haematobia irritans exigua, Stomoxys calcitrans, horse-flies (Tabanids) with the sublarnilies of Tabanidae such as Haematopota spp. (e.g., Haematopota pluvialis) and Tabanus spp, e.g., Tabanus nigrovittatus) and Chrysopsinee such as Chrysops spp. (e.g., Chrysops caecutlens); Hippoboscids such as Melophagus ovinus (sheep ked); tsetse flies, such as Glossinia sop,; other biting insects like midges, such as Ceratopogonidae (biting midges), Simuliidse (Blackflies), Psychodidae (Sandflies); but also blood-sucking insects, for example mosquitoes, such as Anopheles spp., Aedes sop and Culex spp., fleas, such as Ctenocephalides fells and Ctenocephalides canis (cat and dog fleas, respectively), Xenopsylla cheopis, Pulex irritans, Ceratophyilus galfinae, Dermatophilus penetrans, blood-sucking lice (Anoplura) such as Linognathus spp., Haematopinus spp., Olenopotes spp., Pediculus humanis; but also chewing lice (Mallophaga) such as Bovicola (Damalinia) ovis, Bovicola (Darnalinia) bovis and other Bovicola spp. Ectoparasites also include members of the order Acarina, such as mites (e.g. Chorioptes bovis, Cheyletiella spp., Dermanyasus galiinae, Ortnithonyssus spp., Demodex cants, Sarcoptes scabiei, Psoroptes ovis and Psorergates spp.). In an exemplary embodiment, the insect is a flea.

In an exemplary embodiment, the ectoparasite is a fly. In an exemplary embodiment, the ectoparasite is a member of the Oestridae family. In an exemplary embodiment, the ectoparasite is a bot. In an exemplary embodiment, the ectoparasite is a horse bot. In an exemplary embodiment, the insect is a member of the Gasterophilus genus. In an exemplary embodiment, the insect is Gasterophilus nasalis, Gasterophilus intestinalis, Gasterophilus haemorrhoidalis, Gasterophilus inermis, Gasterophilus nigricomis, or Gasterophilus pecorum. In an exemplary embodiment, the insect is Gasterophilus nasalis, Gasterophilus intestinalis, or Gasterophilus haemorrhoidalis.

In an exemplary embodiment, the tick is a hard tick. In an exemplary embodiment, the tick is a soft tick. In an exemplary embodiment, the tick is a Nuttalliellidae, Argasidae, Antricola, Argas, Nothaspis, Ornithodoros, Otobius, Ixodidae, Amblyomma, Rhipicephalus, or Rhipicephalus. In an exemplary embodiment, the tick is an Anomalohimalaya tick, Bothriocroton tick, Cosmiomma tick, Cornupalpatum tick, Compluriscutula tick, Haemaphysalis tick, Hyalomma tick, Ixodes tick, Margaropus tick, Nosomma tick, Rhipicentor tick, or Ornithodorus tick. In an exemplary embodiment, the ectoparasite is a Boophilus tick or an Anocentor tick. In an exemplary embodiment, the ectoparasite is a tick which is selected from the group consisting of Ixodes scapularis, Ixodes holocyclus, Ixodes pacificus, Rhiphicephalus sanguineus, Dermacentor andersoni, Dermacentor variabilis, Amblyomma americanurn, Amblyomma maculaturn, Ornithodorus hermsi, and Ornithodorus turicata.

In an exemplary embodiment, the ectoparasite is a mite which is selected from the group consisting of Parasitiformes and Mesostigmata. In an exemplary embodiment, the ectoparasite is a mite which is Ornithonyssus bacoti or Dermanyssus gallinae.

In an exemplary embodiment, the ectoparasite is a mite. In an exemplary embodiment, the mite is Arcarina or Tetranychidae. In an exemplary embodiment, the mite is Tetranychus spp., or Panonychus spp. In an exemplary embodiment, the mite is a trombiculid mite. In an exemplary embodiment, the mite is chigger.

In an exemplary embodiment, the ectoparasite is a flea. In an exemplary embodiment, the flea (Siphonaptera) is Ctenocephalides, Xenopsylla, Pulex, Tunga, Dasypsyllus, or Nosopsyllus. In an exemplary embodiment, the flea (Siphonaptera) is Ctenocephalides fells, Ctenocephalides canis, Xenopsylla cheopis, Pulex irritant, Tunga penetrans, Dasypsyllus gallinulae, or Nosopsyllus fasciatus.

Moreover, the benzoxaborole and biologic agent combinatorial compositions can be used in controlling endoparasite infestations. The host animal may be a mammal or non-mammal, such as a bird (turkeys, chickens) or fish. Where the host animal is a mammal, it may be a human or non-human mammal. Non-human mammals include domestic animals, such as livestock animals and/or companion animals. Livestock animals include, but are not limited to, cattle, camellids, poultry, pigs, sheep, goats, and horses. Companion animals include, but are not limited to, dogs, rabbits, cats, and other pets owned and maintained in close association with humans as part of the human-animal bond.

Endoparasites include helminth pests, which commonly infect animals, and include the egg, larval, and adult stages thereof. Such pests include nematodes, cestodes, and trematodes, particularly ruminant (blood-feeding) and/or pathogenic nematodes, as well as hookworms, tapeworms, and heartworms. Such endoparasite are commercially relevant because these pests cause serious diseases in animals, e.g. in sheep, pigs, goats, cattle, horses, donkeys, camels, dogs, cats, rabbits, guinea-pigs, hamsters, chicken, turkeys, guinea fowls and other farmed birds, as well as exotic birds. Typical nematode Genera include: Haemonchus, Trichostrongylus, Fasciola, Ostertagia, Nematodirus, Cooperia, Ascaris, Bunostonum, Oesophagostonum, Charbertia, Trichuris, Strongylus, Trichonema, Dictyocaulus, Capillaria, Heterakis, Toxocara, Ascaridia, Oxyuris, Ancylostoma, Uncinaria, Toxascaris, and Parascaris. The trematodes include, in particular, the family of Fasciolideae, especially Fasciola hepatica. Of particular note are those nematodes which infect the gastrointestinal tracts of animals, such as Ostertagia, Trichostrongylus, Haemonchus, and Cooperia.

In an embodiment, the worm is a parasitic worm. In an embodiment, the worm is a helminth. In an embodiment, the worm is a roundworm (Nematode). In another embodiment, the worm is a segmented flatworm (Cestode). In yet another embodiment, the worm is a non-segmented flatworms (Trematode). Killing or inhibiting the growth of these worms is commercially and medically important because they cause serious diseases in a broad spectrum of animals, such as those animals described herein. In an embodiment, the worm is a member of Haemonchus spp., Trichostrongylus spp., Teladorsagia (Ostertagia) spp., Nematodirus leporis, Cooperia oncophora, Cooperia punctate, Ascaris spp., Oesophagostomum spp., Bunostomum spp., Charbertia spp., Trichuris spp., Strongylus spp., Trichonema spp., Triodontophorus spp., Dictyocaulus spp., Heterakis spp., Toxocara spp., Ascaridia spp., Enterobius (formerly Oxyuris) spp., Ancylostoma spp., Uncinaria spp., Necator spp., Toxascaris leonine, Parascaris equorum, Taenia spp., Hymenolepsis spp., Eichonicoccus spp., Pseudophyllid cestodes, liver flukes, lung flukes, blood flukes, the family of Fasciolideae, especially Fasciola hepatica, Schistosoma spp., Filarioidea including Dirofilaria spp., Litomosoides spp., Onchocerca spp., Brugia spp., or Wuchereria spp. In an embodiment, the worm is an ascarid, filarid, hookworm, pinworm, or whipworm. In an embodiment, the worm is Litomosoides sigmodontis, Haemonchus contortus, Trichostrongylus colubriformis, or Dirofilaria immitis. In an embodiment, the worm is Wuchereria bancrofti, Brugia malayi, Brugia timori, or Schistosoma mansoni.

The combinatorial compositions described herein are also active against all or individual development stages of animal pests showing normal sensitivity, as well as those showing resistance to widely used parasiticides. This is especially true for resistant insects and members of the order Acarina. The insecticidal, ovicidal and/or acaricidal effect of the active substances described herein can manifest itself directly, i.e., killing the pests either immediately or after some time has elapsed, for example when moulting occurs, or by destroying their eggs, or indirectly, e.g., reducing the number of eggs laid and/or the hatching rate.

The combinatorial compositions described herein can also be used against hygiene pests, especially of the order Diptera of the families Muscidae, Saroophagidae, Anophilidae and Cuticidae; the orders Orthoptera, Dictyoptera (e.g., the family Blattidae (cockroaches), such as Blatella germanica, Blatta onentalis, Periplaneta americana), and Hymenoptera (e.g., the families Formicidae (ants) and Vespidae (wasps)).

The combinatorial compositions have high activity against sucking insects of the order Hornoptera, especially against pests of the families Aphididee, Delphacidae, Cicadellidea Psyllidae, Diaspididae and Eriophydidae (e.g. rust mite on citrus fruits); the orders Hemiptera, Hetsroptera and Thysenoptera, and on the plant-eating insects of the orders Lepidoptera, Coleoptera, Diptera and Orthoptera. In an exemplary embodiment, the combinatorial compositions have high activity against Cimicidae, Cimex lectularius, or a bed bug.

In an exemplary embodiment, the ectoparasite is lice. In an exemplary embodiment, the lice (Phthiraptera), e.g., Pediculus humanus capitis, Pediculus humanus corporis, Pthirus pubis, Haematopinus eurysternus, Haematopinus suis, Linognathus vituli, Bovicola bovis, Menopon gallinae, Menacanthus stramineus, and Solenopotes capillatus.

In an exemplary embodiment, the ectoparasite is an ectoparasite of fishes. In an exemplary embodiment, the ectoparasite is Copepoda (e.g., order of Siphonostomatoidae) (sea lice).

Diseases transmitted through parasites, particularly blood-feeding ectoparasites such as ticks, biting and muscoid flies, reduvid bugs, mosquitoes and fleas, include, for example, bacterial, viral and protozoal diseases. Non-vector born pathological conditions associated with ectoparasite infestations include, for example, flea-allergy dermatitis (FAD) associated with flea infestations; secondary dermatological infections associated with heavy ectoparasite burden (i.e., face-fly infestations in cattle herds and ear-mite induced otitis externa in dogs), and tick paralysis associated with various tick species. Mites are implicated in scabies and rosacea.

The combinatorial compositions described herein are effective in the treatment and control of ectoparasites implicated or suspected in development of diseases in animals, such as mammals and birds, and therefore have the potential to indirectly ameliorate, reduce or prevent such diseases associated with ectoparasite infestations in the animals described herein. The combinatorial compositions are effective in the treatment and control of ectoparasites implicated or suspected in development of diseases in plants, and therefore have the potential to indirectly ameliorate, reduce or prevent such diseases associated with ectoparasite infestations in the plants described herein.

In one embodiment, arbovirus (arthropod-borne virus) diseases associated with an ectoparasite include, for example, Crimean-Congo Hemmorhagic Fever (CCHF), Febrile illness, Papataci fever, Encephalitis and Meningitis, which are caused by Bunyaviridae such as Bunyavirus, Nairovirus and Phlebovirus; Bluetongue, meningoencephalits, Febrile illness, hemorhagic fever, which are caused by Reoviridae such as Orbivirus and Colitivirus; Febrile illness, rash, encephalitis, polyarthritis, lymphadenitis which are caused by Togaviridae, such as Sindbisvirus and Chikungunya Virus; tick-borne meningoencephalitis, Dengue hemmorhagic fever, encephalitis, Febrile illness or West Nile Fever, and Yellow fever which are caused by Flaviviridae, such as Flavivirus (including diverse sub-groups); West Nile virus. In another embodiment, bacterial diseases transmitted by ectoparasites include, for example, Rocky Mountain spotted fever, tick typhus caused by infection through Rickettsia spp; Q-fever caused by Coxiella burnetii; Tularemia caused by infection through Francisella tularensis; Borreliosis or Spirochaetosis, such as Lyme disease, or relapsing fever, caused by infection through Borrelia spp.; Ehrlichiosis caused by infection through Ehrlichia spp.; Plague, caused by infection through Yersinia pestis. In yet another embodiment, protozoan or rickettsial diseases transmitted by ectoparasites include, for example, Babesiosis, such as Texas fever, red water disease, caused by infection through Babesia spp.; Theileriosis, such as east coast fever, Mediterranean coast fever, caused by infection through Theileria spp.; Nagana disease, Sleeping sickness caused by infection through Trypanosoma spp., Anaplasmosis caused by infection through Anaplasma spp.; Malaria caused by infection through Plasmodium spp.; Leishmaniasis caused by infection through Leishmania spp.

In an exemplary embodiment, application of the combinatorial compositions provides a method of reducing the size of an endo- or ectoparasitic infestation in or on an animal in need of treatment thereof. The method includes administering to the animal a therapeutically effective amount of the benzoxaborole and biologic combinatorial composition, sufficient to reduce the size of the endo- or ectoparasitic infestation. In an exemplary embodiment, application of the combinatorial compositions provides a method of reducing the size of an endo- or ectoparasitic infestation in or on a plant in need of treatment thereof. The method includes administering to the plant a therapeutically effective amount of the combinatorial composition, sufficient to reduce the size of the endo- or ectoparasitic infestation.

In an exemplary embodiment, application of the combinatorial compositions provides a method of controlling an endo- or ectoparasitic infestation in or on an animal in need of treatment thereof. The method includes administering to the animal a therapeutically effective amount of the combinatorial composition, sufficient to control the endo- or ectoparasitic infestation. In an exemplary embodiment, controlling an endo- or ectoparasitic infestation is reducing the number of ectoparasites in or on an animal. In an exemplary embodiment, application of the combinatorial compositions provides a method of controlling an endo- or ectoparasitic infestation in or on a plant in need of treatment thereof. The method includes administering to the plant a therapeutically effective amount of the benzoxaborole and biologic combinatorial composition of the invention, sufficient to control the endo- or ectoparasitic infestation. In an exemplary embodiment, controlling an endo- or ectoparasitic infestation is reducing the number of ectoparasites in or on a plant.

In an exemplary embodiment, application of the combinatorial compositions provides a method of preventing an endo- or ectoparasitic infestation in or on an animal in need of treatment thereof. The method includes administering to the animal a prophylactically effective amount of the benzoxaborole and biologic combinatorial composition, sufficient to prevent the endo- or ectoparasitic infestation. In an exemplary embodiment, application of the combinatorial compositions provides a method of preventing an endo- or ectoparasitic infestation in or on a plant in need of treatment thereof.

In an exemplary embodiment, application of the combinatorial compositions provides a method of reducing the transmission, in an animal, of a disease transmitted through an endo- or ectoparasite. The method includes administering to the animal in need thereof a therapeutically effective amount of the benzoxaborole and biological combinatorial composition, sufficient to reduce the spread of the disease-causing agent from the endo- or ectoparasite to the animal.

In an exemplary embodiment, the benzoxaborole and biological agent combinatorial composition is described herein, or a salt, prodrug, hydrate or solvate thereof, or a combination thereof. In an exemplary embodiment, the invention provides a benzoxaborole and biological agent combinatorial composition described herein, or a salt, hydrate or solvate thereof. In an exemplary embodiment, the invention provides a compound described herein, or a prodrug thereof. In an exemplary embodiment, the invention provides a compound described herein, or a salt thereof. In another exemplary embodiment, the benzoxaborole includes a benzoxaborole described herein, or a pharmaceutically acceptable salt thereof. In another exemplary embodiment, the benzoxaborole compound is described by a formula listed herein, or a pharmaceutically acceptable salt thereof. In an exemplary embodiment, the compound is part of a pharmaceutical formulation described herein. Such conditions are known to one skilled in the art and specific conditions are set forth in the Examples appended hereto.

In another exemplary embodiment, the animal is a member selected from human, cattle, deer, reindeer, goat, honey bee, pig, sheep, horse, cow, bull, dog, guinea pig, gerbil, rabbit, cat, camel, yak, elephant, ostrich, otter, chicken, duck, goose, guinea fowl, pigeon, swan, and turkey. In another exemplary embodiment, the animal is a human. In another exemplary embodiment, the animal is a non-human mammal. In another exemplary embodiment, the animal is a mammal. In another exemplary embodiment, the animal is a domestic animal. In another exemplary embodiment, the animal is a domestic mammal. In another exemplary embodiment, the animal is a companion animal. In another exemplary embodiment, the animal is a companion mammal. In another exemplary embodiment, the animal is a dog. In another exemplary embodiment, the animal is a cat. In another exemplary embodiment, the animal is a rodent. In another exemplary embodiment, the animal is a rat. In another exemplary embodiment, the animal is a mouse. In another exemplary embodiment, the animal is a member selected from goat, pig, sheep, horse, cow, bull, dog, guinea pig, gerbil, rabbit, cat, chicken and turkey. In another exemplary embodiment, the animal is an ungulate. In another exemplary embodiment, the ungulate is selected from the group consisting of horse, zebra, donkey, cattle/bison, rhinoceros, camel, hippopotamus, goat, pig, sheep, giraffe, okapi, moose, elk, deer, tapir, antelope, and gazelle. In another exemplary embodiment, the ungulate is cattle. In another exemplary embodiment, the ungulate is selected from the group consisting of goat, pig, and sheep. In another exemplary embodiment, the animal is a ruminant. In another exemplary embodiment, the ruminant is selected from the group consisting of cattle, goats, sheep, giraffes, bison, yaks, water buffalo, deer, camels, alpacas, llamas, wildebeast, antelope, pronghorn, and nilgai. In another exemplary embodiment, the cattle is a cow, bull, or calf. In another exemplary embodiment, the animal is an equine. In another exemplary embodiment, the animal is selected from the group consisting of horse, donkey, caribou and reindeer. In another exemplary embodiment, the animal is a horse. In another exemplary embodiment, the animal is a snail. In another exemplary embodiment, the animal is an insect. In another exemplary embodiment, the animal is a mosquito. In another exemplary embodiment, the animal is a fly.

In an exemplary embodiment, the disease is treated through oral, intravenous, topical, intradermal, intraperitoneal, or subcutaneous injection in an effective amount. The pharmaceutical formulations containing benzoxaborole and biologic agent combinatorial compositions can be in a form suitable for oral use, for example, as tablets, troches, lozenges, aqueous or oily suspensions, dispersible powders or granules, emulsion, hard or soft capsules, or syrups or elixirs.

Combinatorial compositions intended for oral use may be prepared according to any method known in the art for the manufacture of pharmaceutical formulations, and such combinatorial compositions may contain one or more agents selected from the group consisting of sweetening agents, flavoring agents, coloring agents and preserving agents in order to provide pharmaceutically elegant and palatable preparations. Tablets may contain the active ingredient in admixture with non-toxic pharmaceutically acceptable excipients that are suitable for the manufacture of tablets. These excipients may be for example, inert diluents, such as calcium carbonate, sodium carbonate, lactose, calcium phosphate, or sodium phosphate; granulating and disintegrating agents, for example, corn starch, or alginic acid; binding agents, for example starch, gelatin or acacia; and lubricating agents, for example magnesium stearate, stearic acid, or talc. The tablets may be uncoated or they may be coated by known techniques to delay disintegration and absorption in the gastrointestinal tract and thereby provide a sustained action over a longer period. For example, a time delay material such as glyceryl monostearate or glyceryl distearate may be employed.

Formulations for oral use may also be presented as hard gelatin capsules wherein the combinatorial composition is mixed with an inert solid diluent, for example, calcium carbonate, calcium phosphate or kaolin, or as soft gelatin capsules wherein the combinatorial composition is mixed with water or an oil medium, for example peanut oil, liquid paraffin or olive oil.

Aqueous suspensions contain the combinatorial composition in admixture with pharmaceutically acceptable excipients suitable for the manufacture of aqueous suspensions. Such excipients are suspending agents, for example sodium carboxymethylcellulose, methylcellulose, hydroxypropylmethylcellulose, sodium alginate, polyvinylpyrrolidone, gum tragacanth and gum acacia; and dispersing or wetting agents, which may be a naturally-occurring phosphatide, for example, lecithin, or condensation products of an alkylene oxide with fatty acids, for example polyoxyethylene stearate, or condensation products of ethylene oxide with long chain aliphatic alcohols, for example heptadecaethyleneoxycetanol, or condensation products of ethylene oxide with partial esters derived from fatty acids and a hexitol such as polyoxyethylene sorbitol monooleate, or condensation products of ethylene oxide with partial esters derived from fatty acids and hexitol anhydrides, for example polyethylene sorbitan monooleate. The aqueous suspensions may also contain one or more preservatives, for example ethyl, or n-propyl-p-hydroxybenzoate, one or more coloring agents, one or more flavoring agents, and one or more sweetening agents, such as sucrose or saccharin.

Oily suspensions may be formulated by suspending the combinatorial composition in a vegetable oil, for example arachis oil, olive oil, sesame oil or coconut oil, or in a mineral oil such as liquid paraffin. The oily suspensions may contain a thickening agent, for example beeswax, hard paraffin, or cetyl alcohol. Sweetening agents such as those set forth above, and flavoring agents may be added to provide palatable oral preparations. These combinatorial compositions may be preserved by the addition of an anti-oxidant such as ascorbic acid.

Dispersible powders and granules suitable for preparation of an aqueous suspension by the addition of water provide the combinatorial composition in admixture with a dispersing or wetting agent, suspending agent and one or more preservatives. Suitable dispersing or wetting agents and suspending agents are exemplified by those already mentioned above. Additional pharmaceutically acceptable excipients, for example sweetening, flavoring and coloring agents, may also be present.

Pharmaceutical formulations comprising the combinatorial composition may also be in the form of oil-in-water emulsions and water-in-oil emulsions. The oily phase may be a vegetable oil, for example olive oil or arachis oil, or a mineral oil, for example liquid paraffin, or mixtures of these. Suitable emulsifying agents may be naturally-occurring gums, for example gum acacia or gum tragacanth; naturally-occurring phosphatides, for example soy bean, lecithin, and esters or partial esters derived from fatty acids and hexitol; anhydrides, for example sorbitan monooleate; and condensation products of the said partial esters with ethylene oxide, for example polyoxyethylene sorbitan monooleate. The emulsions may also contain sweetening and flavoring agents.

Syrups and elixirs may be formulated with sweetening agents, for example glycerol, propylene glycol, sorbitol, or sucrose. Such formulations may also contain a demulcent, a preservative, and flavoring and coloring agents. The pharmaceutical formulations may be in the form of a sterile injectable aqueous or oleaginous suspension. This suspension may be formulated according to the known art using suitable dispersing or wetting agents and suspending agents, which have been mentioned above. The sterile injectable preparation may also be a sterile injectable solution or suspension in a non-toxic parenterally acceptable diluent or solvent, for example as a solution in 1,3-butanediol. Among the acceptable vehicles and solvents that may be employed are water, Ringer's solution and isotonic sodium chloride solution. In addition, sterile, fixed oils are conventionally employed as a solvent or suspending medium. For this purpose, any bland fixed oil may be employed including synthetic mono- or diglycerides. In addition, fatty acids such as oleic acid find use in the preparation of injectables.

The combinatorial compositions may also be administered in the form of suppositories, e.g., for rectal administration of the combinatorial composition. They can be prepared by mixing the combinatorial composition with a suitable non-irritating pharmaceutically acceptable excipient that is solid at ordinary temperatures but liquid at the rectal temperature and will therefore melt in the rectum to release the drug. Exemplary excipients include cocoa butter and polyethylene glycols.

Alternatively, the combinatorial compositions can be administered parenterally in a sterile medium. The combinatorial composition, depending on the vehicle and concentration used, can either be suspended or dissolved in the vehicle.

For administration to non-human animals, the combinatorial composition containing the benzoxaborole and biologic agent may be added to the animal's feed or drinking water. Also, it will be convenient to formulate animal feed and drinking water products so that the animal takes in an appropriate quantity of the combinatorial composition in its diet. It will further be convenient to present the benzoxaborole and biologic agent in a combinatorial composition as a premix for addition to the feed or drinking water. The combinatorial composition can also be added as a food or drink supplement for humans.

Dosage levels of the order of from about 0.01 mg to about 3500 mg per kilogram of body weight per day, about 0.01 mg to about 1000 mg per kilogram of body weight per day, or from about 0.1 mg to about 100 mg per kilogram of body weight per day, or from about 5 mg to about 250 mg per kilogram of body weight per day, or from about 25 mg to about 150 mg per kilogram of body weight per day, are useful in the treatment of the above-indicated conditions. The amount of benzoxaborole and biological agent that may be combined with the carrier materials to produce a unit dosage form will vary depending upon the condition being treated and the particular mode of administration. Unit dosage forms will generally contain between from about 1 mg to about 3500 mg of combinatorial composition. In an exemplary embodiment, an effective amount can be selected from a dosage range provided in this document. In an exemplary embodiment, a therapeutically effective amount can be selected from a dosage range provided in this document. In an exemplary embodiment, a prophylactically effective amount can be selected from a dosage range provided in this document. In an exemplary embodiment, an orally effective amount can be selected from a dosage range provided in this document. In an exemplary embodiment, a topically effective amount can be selected from a dosage range provided in this document.

Frequency of dosage may also vary depending on the benzoxaborole and biologic agent used and the particular disease treated. In an exemplary embodiment, the combinatorial composition is administered once a day or twice a day or three times a day or four times a day. In an exemplary embodiment, the combinatorial composition is administered once a week or twice a week or three times a week or four times a week. In an exemplary embodiment, the combinatorial composition is administered once a month or twice a month or three times a month or four times a month. It will be understood, however, that the specific dose level for any particular animal or plant will depend upon a variety of factors including the activity of the specific compound employed, the age, body weight, general health, sex, diet, time of administration, route of administration and rate of excretion, drug combination, and the severity of the particular disease undergoing therapy.

The amount of the combinatorial composition required for use in treatment will vary not only with the particular active components selected but also with the route of administration, the nature of the condition being treated and the age and condition of the animal or plant and will ultimately be at the discretion of the attendant physician or veterinarian or agronomist.

Preferred benzoxaborole compounds for use in the formulations described herein will have certain pharmacological properties apart from the properties conferred as a benzoxaborole and biological agent combinatorial composition. Such properties include, but are not limited to, low toxicity, low serum protein binding and desirable in vitro and in vivo half-lives. Assays may be used to predict these desirable pharmacological properties. Assays used to predict bioavailability include transport across human intestinal cell monolayers, including Caco-2 cell monolayers. Serum protein binding may be predicted from albumin binding assays. Such assays are described in a review by Oravcova et al. (1996, J. Chromat. B677: 1-27). Compound half-life is inversely proportional to the frequency of dosage of a compound. In vitro half-lives of compounds may be predicted from assays of microsomal half-life as described by Kuhnz and Gleschen (Drug Metabolism and Disposition, (1998) volume 26, pages 1120-1127).

Toxicity and therapeutic efficacy of such benzoxaborole compounds can be determined by standard pharmaceutical procedures in cell cultures or experimental animals, e.g., for determining the LD50 (the dose lethal to 50% of the population) and the ED50 (the dose therapeutically effective in 50% of the population). The dose ratio between toxic and therapeutic effects is the therapeutic index, and it can be expressed as the ratio between LD50 and ED50. Compounds that exhibit high therapeutic indices are preferred. The data obtained from these cell culture assays and animal studies can be used in formulating a range of dosage for use in animals (such as humans) or plants. The dosage of such benzoxaborole compounds can lie within a range of circulating concentrations that include the ED50 with little or no toxicity. The dosage can vary within this range depending upon the unit dosage form employed and the route of administration utilized. The exact formulation, route of administration and dosage can be chosen by the individual physician in view of the patient's condition. (See, e.g., Fingl et al., 1975, in “The Pharmacological Basis of Therapeutics”, Ch. 1, p. 1).

For a compound or combinatorial composition utilized for a method described herein, the therapeutically effective dose can be estimated initially from in vitro assays, as disclosed herein. For example, a dose can be formulated in animal models to achieve a circulating concentration range that includes the EC50 (effective dose for 50% increase) as determined in vitro, i.e., the concentration of the test compound which achieves a half-maximal lethality toward a parasite, pest or other organism of interest. Such information can be used to more accurately determine useful doses.

In general, the combinatorial compositions prepared by the methods, and from the intermediates, described herein will be administered in a therapeutically effective amount by any of the accepted modes of administration for agents that serve similar utilities. It will be understood, however, that the specific dose level for any particular animal or plant will depend upon a variety of factors including the activity of the specific compound employed, the age, body weight, general health, sex, diet, time of administration, route of administration, and rate of excretion, drug combination, the severity of the particular disease undergoing therapy and the judgment of the prescribing entity. The benzoxaborole and biologic agent combinatorial compositions can be administered once a day or twice a day or three times a day or four times a day, or once a week or twice a week or three times a week or four times a week or once a month or twice a month or three times a month or four times a month.

Dosage amount and interval can be adjusted individually to provide plasma levels of the active moiety that are sufficient to maintain therapeutic effects.

The amount of the combinatorial composition in a formulation can vary within the full range employed by those skilled in the art. Exemplary formulations of the benzoxaborole and biologic agent compositions can comprise between 0.00000001% and 98% by weight of benzoxaborole and biologic agents or, preferably, between 0.01% and 95% by weight of benzoxaborole and biologic agent, more preferably between 0.5% and 90% by weight of benzoxaborole and biologic agent. For example, the formulation may comprise between 1% and 80%, 2% and 70%, 5% and 60%, 5% and 50%, and 5% and 40% by weight of benzoxaborole and biologic agent, with the balance being one or more suitable pharmaceutically acceptable excipients.

The biological agent can be selected from the group consisting of: Acetobacteraceae, Bacillacaeae, Bacteriodaceae, Bifidobacteriaceae, Burkholderiaceae, Clostridiaceae, Enterobacteriaceae, Eubacteriaceae, Lactobacillaceae, Methanobacteriaceae, Nocardiaceae, Paenibacillaceae, Pasteuriaceae, Prevotellaceae, Pseudomonadaceae, Rhizobiaceae, Ruminococcaceae, Saccharomycetaceae, Sphingomonadaceae, Streptoccaceae, and/or Clavicipitaceae, Cordycipitaceae, Entomophthoraceae, Hypocreaceae, Ophiocorycipitaceae, Phaeophaeriaceae, Synchytriaceae, Trichocomaceae, a mutant of these strains having the identifying characteristics of the respective strain, an/or a metabolite produced by the respective strain that exhibits activity against pathogens. In some embodiments, the biologic agent can comprise a Bacillus, Lactobaccillus, Streptomyces, Salmonella, or E. coli. In other embodiments the biological agent can be a Streptococcus, Rothia, Neisseria, Candida, Corynebacterium, Veillonella, Actinomyceis, Propionibacterium, Staphylococcus, Corynebacterium, Moraxella, Malassezia, Lactobacillus, Gardnerella, or Mycoplasma/Ureaplasma. In yet other embodiments, the biological agent can be selected from group consisting of the phyla: Firmicutes, Actinobacteria, Bacteroidetes, Proteobacteria, Fusobacteria, Tenericutes, Spirochaetes, Cyanobacteria, Verrucomicrobia, and TM7.

The biological agent can be selected from the group consisting of the genera Bacteroides (e.g., Alistipes, Prevotella, Paraprevotella, Parabacteroides, Odoribacter), Bacillus, Bifidobacterium, Clostridioides, Eubacterium, Escherichia, Faecalibacterium, Haemophilus, Heliobacter (H. pylori), Lactobacillus, Prevotella, Streptococcus/Lactococcus. Alternaria, Ampelomyces, Aspergillus, Aureobasidium, Beauveria, Candida, Isaria, Lecanicillium, Metarhizium, Phlebiopsis, Trichoderma, Ulocladium, Phytophthora, or Fallopia.

The biological agent of the combinatorial compositions can be derived from archaea, viruses, fungi, algae, as well as other prokaryotes and eukaryotes. For instance, the biological agent can be a Methanobrevibacter, such as Methanobrevibacter smithii, a bacteriophage, Blastocystis. Eukaryotic biological agents may include helminths, nematodes, and the like.

The biological agent may be a recombinant bacteriophage, fungi, or bacterium.

### EXAMPLES

The advanced fungicidal activity of the benzoxaborole and biologic agent combinatorial composition is evident from the examples below. While the individual active compounds exhibit fungicidal activity, the combinatorial compositions have an activity which exceeds a simple addition of activities.

A synergistic effect is considered to be present when the fungicidal activity of a combination of active compounds exceeds the total of the activities of the active compounds when applied individually. The expected activity for a given combination of two active compounds can be calculated as follows (according to Colby's formula) (cf. Colby, S. R., “Calculating Synergistic and Antagonistic Responses of Herbicide Combinations”, Weeds 1967, 15, 20-22):

If X is the efficacy when active compound A is applied at an application rate of m ppm (or g/ha), Y is the efficacy when active compound B is applied at an application rate of n ppm (or g/ha), E is the efficacy when the active compounds A and B are applied at application rates of m and n ppm (or g/ha), respectively, and then:

E=X+Y−X·Y 100

The degree of efficacy, expressed in % is denoted. 0% means an efficacy which corresponds to that of the control while an efficacy of 100% means that no disease is observed.

If the actual fungicidal activity exceeds the calculated value, then the activity of the combination is superadditive, i.e., a synergistic effect exists. That is, the efficacy which is actually observed is greater than the value for the efficacy (E) calculated from the abovementioned formula.

A further way of demonstrating a synergistic effect is the method of Tammes (cf. “Isoboles, a graphic representation of synergism in pesticides” in Neth. J. Plant Path., 1964, 70, 73-80).

Aspects of the invention are illustrated by the following examples. However, the invention is not limited to the examples.

### Prophetic Example A: In Planta Efficacy Study (Greenhouse & Growth Chamber)

The benzoxaborole compound can be dissolved in acetone, acetone/dimethylacetamide (1:1 ratio by weight), acetonitrile, ethanol, ethanol/dimethylacetamide (1:1 ratio by weight), and alkylaryl polyglycol ether (<1% by weight). The prepared compound can be diluted with water to the desired concentration.

The application rate of biologic agent refers to the amount of dried Bacillus subtilis (NRRL Accession No. B-0000). A solution comprising 8.5.108 CFU/g (1.34%) of this strain can be used.

To test for preventive activity, young plants can be sprayed with a combinatorial composition comprising benzoxaborole and biologic agent, benzoxaborole alone, or biologic agent alone at the stated rate of application (e.g., tomatoes, wheat, soy, etc.). After the spray coating is dry, the plants or plant materials are inoculated with an aqueous spore suspension of phytopathogenic fungi. The plants or plant materials are then placed in an incubation environment (e.g., growth chamber or greenhouse) at approximately 20-30° C. and a relative atmospheric humidity of 75-95%.

In a separate experiment, varying rates of benzoxaborole are sprayed on the plants or plant materials first. After ˜12-24 hours, allowing for the application to dry, varying rates of biological controls are applied. In this particular arrangement, phytopathogenic fungal inoculum can be applied 24 hours before the application of the benzoxaborole (curative study) or applied 24 hours after the application of the biological control (preventative study). The plants or plant materials are then placed in an incubation environment (eg. growth chamber or greenhouse) at approximately 20-30° C. and a relative atmospheric humidity of 75-95%.

The above tests can be evaluated at 7, 14, and 24 days after the inoculation. 0% means an efficacy which corresponds to that of the untreated control while an efficacy of 100% means that no disease is observed.

### Prophetic Example B: Materials and Methods

Fungal isolates and cultures: Mycosphaerella zeae-maydis, Alternaria solani, Aureobasidium pullulans, Aspergillus flavus, Aspergillus fumigatus, Aspergillus niger, Sclerotinia homoeocarpa, Botrytis cinerea 10-1728, Botrytis cinerea B17, Botrytis cinerea B16, Candida albicans, Entyloma ageratinae, Fusarium graminearum, Fusarium verticillioides, Fusarium solani f.sp. pisi (MP VI), Fusarium oxysporum f sp. cubense, Fusarium oxysporum ST33, Fusarium oxysporum f sp. lycopersici, Colletotrichurn orbiculare, Penicillium chrysogenurn, Septoria nodorum, Septoria tritici, Stachybotrys chartarum, Magnaporthe grisea, Mucor sp., Rhizoctonia solani, Rhizopus sp., Pseudocercosora angolensis, Phytophthora pini, Pyrenophora tritici-repentis, Ustilago tritici, and Pythium aphanidermatum are cultured from either cryogenic storage stock, silica gel storage stock, or lyophilized (with skim milk) stocks.

### Prophetic Example C: Antifungal and Stock Solutions

Stock solutions (concentrations of between 4000 μg/mL to 10,000 μg/mL; stored at −18° C.) of the above antifungals are prepared in acetone/dimethylacetamide mixture or DMSO, except for kasugamycin, which is prepared in sterile distilled water. The stock solutions are further diluted into sterile potato dextrose broth (PDB) so that the diluted solutions can be used for the antifungal susceptibility testing.

### Prophetic Inoculum Preparation

Unless specified, most of the organisms are maintained on potato dextrose agar (PDA), and sufficient asexual spores are isolated from the cultures after 1-2 weeks of incubation at room temperature (22-24° C.) with 12ON/12OFF (12 hours on and 12 hours off) fluorescent light+darklight photoperiod using fluorescent (Philips, F40LW) and blacklight (F40T12) bulbs.

Mycosphaerella zeae-maydis, Alternaria solani, Aspergillus flavus, Aspergillus niger, Sclerotinia homoeocarpa, Botrytis cinereal, Fusarium solani fsp. pisi (MP VI), Fusarium oxysporum f sp. cubense, Fusarium oxysporum f sp. lycopersici, Colletotrichurn orbiculare, Septoria nodorum, Septoria tritici, Magnaporthe grisea, Rhizoctonia solani, Rhizopus sp., Phytophthora pini, Pyrenophora tritici-repentis, and Ustilago tritici, are maintained and encouraged to sporulate on Potato Dextrose Agar (4 g potato extract, 20 g dextrose, 15 g agar per liter; full, ½ or ¼ strength), or V8 agar (20%-200 mL V8 juice, 2 g CaCO₃, 15 g Agar, 800 mL distilled water) or water agar to encourage sporulation. Fusarium verticillioides is maintained on synthetischer nährstoffarmer agar (SNA), and spore suspensions are prepared from those cultures. Spore inocula are prepared in sterile distilled water with 0.1% Tween® 20, and a hemocytometer is used to determine the spore density. Typically, the spore inoculum is prepared fresh prior to each study, and the inoculum is appropriately diluted to a final concentration of 0.4-1×10⁵ spores/mL or CFU/mL in each study.

In cases where a sufficient spore suspension cannot be readily prepared, inocula are prepared as mycelium smoothies according an established procedure [Büttner et al., (2004) Plant Breeding. 123: 158-166]. Magnaporthe grisea cultures are maintained on oatmeal agar (OMA). After 2 weeks of growth, four agar blocks (1 inch long and 1 inch wide) are extracted and added to a flask containing 100 mL of autoclaved Complete Media (0.6 g yeast extract, 0.6 g casein hydrolysate, and 1 g sucrose in 100 mL distilled water). After 1-2 weeks of incubation at 22-24° C. in the dark, the mycelium smoothie inoculum is prepared.

Alternaria solani cultures are maintained on PDA. After 1 week of growth, four agar blocks (1 inch long and 1 inch wide) are extracted and added to a flask containing 100 mL autoclaved potato dextrose broth (PDB). After 1-2 weeks of incubation at 27° C. with constant agitation (120 rpm), the mycelium smoothie inoculum is prepared. Rhizoctonia solani mycelium inoculum is prepared by the same method.

Sclerotinia homoeocarpa cultures are maintained on PDA. After 1 week of growth, four agar blocks (1 inch long and 1 inch wide) are extracted and added to a flask containing 100 mL autoclaved PDB. After 1-2 weeks of incubation at 27° C. with constant agitation (120 rpm), the mycelium smoothie inoculum is prepared.

Fusarium graminearum cultures are maintained on carnation leaf water agar (CLA). After 1 week of growth, four agar blocks (1 inch long and 1 inch wide) are extracted and added to a flask containing 100 mL autoclaved 25% PDB. After 1-2 weeks of incubation at 27° C. with constant agitation (120 rpm), the mycelium smoothie inoculum is prepared.

Pythium aphanodermatum cultures are maintained on PDA. After 1 week of growth, four agar blocks (1 inch long and 1 inch wide) are extracted and added to a flask containing 100 mL autoclaved 25% PDB. After 1-2 weeks of incubation at 27° C. with constant agitation (120 rpm), the mycelium smoothie inoculum is prepared. Alternatively, Pythium zoospores can be obtained by first covering a healthy agar culture of Pythium with 2 mM autoclaved sodium phosphate buffer for 2 hours at 10° C. before gently scraping the surface with a cell scraper. The zoospores can be collected by passing the liquid suspension through a filter paper with about 100 micro pore size. Phytophthora pini zoospores are collected this way.

Mycelium smoothie inocula are typically prepared fresh prior to the studies or stored at 4° C. for one week. For the antifungal susceptibility assays, the mycelium smoothies are carefully blended and vortexed to achieve a homogenous suspension in sterile distilled water with 0.1% Tween® 20. The inocula are appropriately diluted into 25% PDB so that when 40 μL of the inoculum is added to 160 μL of 25% PDB (final volume=200 mL) the optical density (OD) at 630 nm is about 0.02-0.04 (value determined before each study) absorbance after correcting for the intrinsic absorbance from the medium and the microtiter plate.

### Prophetic Example D: Antifungal Susceptibility Testing, Synergy Testing, and Interpretation

The efficacies for each benzoxaborole and biologic agent combinatorial composition can be determined by following an agar-based in vitro, detached-leaf-based in vitro or in vivo experimental assay.

Agar-Based In Vitro Experimental Assay.

Varying concentrations and ratios of each benzoxaborole-biological agent combination is evenly spread onto PDA petri-dish plates. The benzoxaborole and biologic agent combinatorial composition PDA petri-dish plates are cultured at 25° C. for 1-2 days, followed by inoculation with 10 uL spore inocula of tested pathogenic fungi (4×10⁵ Cfu/mL) or agar plugs with fresh pathogenic fungal mycilia (diameter 3/16 inch) on the PDA petri-dishes. The resultant plates are placed at room temperature (20-25° C.) for 1 to 7 days. The efficacies are evaluated by the lesions of pathogenic fungi formed on the plates.

Detached-Leaf-Based In Vitro Experimental Assay.

Varying concentrations and ratios of each benzoxaborole and biologic agent combinatorial composition are sprayed onto relevant host detached leaves. The detached leaves are placed in trays with domes to maintain the moisture at room temperature (20-25° C.) for overnight, followed by inoculating spore inocula (10 uL 4×10⁵CFU/mL) or agar plugs ( 3/16 inch diameter). The efficacies of each benzoxaborole and biologic agent combinatorial composition are evaluated by the lesions of pathogenic fungi formed on the detached leaves.

In Vivo Experimental Assay.

Varying levels of each benzoxaborole and biologic agent combinatorial composition are sprayed onto relevant host plants, followed by inoculation of spore inocula (10 mL of 4×10⁵CFU/mL per plant or per pot) or agar plugs ( 3/16 inch diameter) in a dew chamber for 24 hours. Plants are moved to greenhouse for disease development until disease rating. The efficacies of the benzoxaborole and biologic agent combinatorial compositions are evaluated by disease indexes on plants.

Checkboard Synergistic Assay.

Using Lorian methodology, the checkboard assay determines the effect on potency of the combination of tested compounds in comparison to their individual activities, represented as the Fractional Inhibitory Concentration (FIC) index value. To quantify the interactions between the tested compounds, the FIC index (the combinatorial composition that produced the greatest change from the individual compound's MIC) value is calculated for each strain and combinatorial composition: ΣFIC=FIC A+FIC B, where the FIC values are calculated according to the method described herein.

### Prophetic Example E: Animal Health

The following non-limiting examples further illustrate the invention. In the description that follows, ‘DAT’ means days after treatment; ‘WAT’ means Weeks after Treatment; ‘HPT’ means hours after exposure; ‘DPT’ means days after exposure; ‘ppm’ means parts per million; ‘a.i.’ means active ingredient; ‘Dboard’ means plywood.

### Example 1: Haematobia irritans

The following test illustrates the activity of exemplary combinatorial compositions against Horn fly, Haematobia irritans. Solutions are applied as a pour-on to cattle and evaluated for the presence or absence of horn fly, expressed as percent efficacy in keeping the animals fly-free. The benzoxaborole and biologic agent combinatorial compositions are applied as 1% (10 mg/ml) solutions with an average of 29.5 ml per animal, giving a dosage of about 1 mg a.i. per kg bodyweight of animal.

### Example 2: Rhipicephalus sanguineus

The following experiment illustrates the activity of the benzoxaborole and biologic agent combinatorial compositions against brown dog ticks (Rhipicephalus sanguineus). Dogs are given an oral dose of combinatorial composition in corn oil:DMSO (1:1) at 10 mg/kg body weight, and assessed for the percentage mortality of fleas and ticks (which had dropped off the dog's body) at 1, 9, 16, 23, 30, and 37 days following treatment (DPT).

### Example 3: Pediculus Lice

A simulated shampoo treatment is undertaken for benzoxaborole and biologic agent combinatorial compositions, in which solutions are made up in water and adult head lice (Pediculus humanus) are exposed to the solutions for 10 minutes. Head lice mortality is recorded at 24 hours.

### Example 4: Lepephtherius Salmonis

In-vitro screening of the benzoxaborole and biologic agent combinatorial composition is carried out on the motile stages of Salmon Sea Lice, (Lepeophtheirus salmonis). The benzoxaborole and biologic agent combinatorial composition is dissolved in propylene glycol and diluted in sea water to give doses of 0.001, 0.01, 0.10, 1.0, 10.0 mg/l. Two replicates of twenty lice each are maintained in the treatments for seventy-two hours. Treatments are compared to sea water controls, and to a DMF solution at 1 hour and 1, 2 and 3 DAT.

### Example 1: Fungicidal Activity

The fungicidal activity of the combinatorial compositions was evaluated as described in the examples below. While the individual active compounds exhibited weaknesses relating to fungicidal activity, the combinatorial compositions had an activity that exceeded a simple addition of individual activities.

In the following examples, Farnesol, extract of Reynoutria sachalinensis, and the strain Bacillus subtilis QST 713 were used as the exemplary biologic agents that were combined with the exemplary benzoxaborole (BAG8).

The efficacy of each of the exemplary combinatorial compositions was tested on Botrytis cinerea B05.10 (B05.10), Fusarium oxysporum f sp. cubense tropical race 4 (FOC.TR4), Mycosphaerella graminicola (SLB), and Sclerotinia sclerotiorum 1980 (Ss1980).

### Example 2: Combination of the Oxaborole Compound with Bioactive Agents

BAG8 was used as the exemplary oxaborole compound. The BAG8 compound was dissolved in dimethylacetamide (50,000 ppm), or combinations thereof were diluted with water to the desired concentration.

Farnesol obtained from sigma-aldrich (Cat #: F203-25G) was prepared in dimethylacetamide (128,000 ppm). or combinations thereof were diluted with water to the desired concentration.

Extract of Reynoutria sachalinensis (5%) was purchased from Marrone Bio Innovations (Regalia Biofungicide). combinations thereof were diluted with water to the desired concentration.

### Fungal Spore Inoculum Preparation

In example 1, the spore inoculum of Botrytis cinerea B05.10 (B05.10) and Fusarium oxysporum f. sp. cubense tropical race 4 (FOC.TR4) were produced as follows:

Conidial suspensions of Botrytis cinerea B05.10 (B05.10) and Fusarium oxysporum f. sp. cubense tropical race 4 (FOC.TR4) were withdrawn from −80° C. glycerol stock (30%). In the microbiological safety cabinet, a sterilized pipette tip was used to prick out conidia (10 μl) on a PDA Petri dish. It was inoculated for 4-7 days at room temperature in 12/12 hour (light/dark);

A piece of fungal agar from PDA medium was cut and transferred onto sporulation medium (PDA) and incubated for 14 to 21 days at 22° C. under continuous light for sporulation (near UV light is better for sporulation);

10 ml of suspension solution was put on sporulated fungi, which was then scraped with a sterile spreader to dislodge the conidia and mycelium;

The mixture of mycelium and conidia were transferred into a 50 ml conical tube, which was then shaken by vortexing several times to obtain conidia;

The obtained suspension was filtered using sterilized miracloth or cheesecloth to remove mycelium;

The concentration of conidia in the suspension was measured using a counting chamber and was diluted to a concentration of 1×10⁶ conidia per ml suspension solution.

### Fungal Visible Fragmented Mycelia Inoculum Preparation

In example 1, the visible fragmented mycelia of Sclerotinia sclerotiorum 1980 (Ss1980) was produced as follows:

5-10 small (ca. 2 mm²) agar-mycelia plugs was added to 50 ml potato dextrose broth (PDB) media in a 125 ml long neck flask;

The inoculation was cultured at room temperature, with shaking at 180 rpm, for 4-10 days;

Mycelia was harvested by vacuum filtration through a Buchner funnel lined with 4 layers of cheesecloth;

The mycelia was rinsed using sterilized H₂O and blended with a sterilized blender for 10 seconds;

The blend was filtered using 4 layers of cheesecloth;

The visible fragmented mycelia were counted under microscope and diluted to 1×10⁶ CFU/mL.

### Checkboard Assay for Synergistic/Additive Effects

A checkboard assay was employed to determine the effect on potency of exemplary embodiments of the combinatorial compositions in comparison to activities of the individual components. The potency was represented as the Fractional Inhibitory Concentration (FIC) index value.

To quantify the interactions between the tested compounds, the FIC index value was calculated for each strain and combinatorial composition: ΣFIC=FIC A+FIC B, where FIC A is the MIC of compound A in the combination/MIC of compound A alone, and FIC B is the MIC of compound B in the combination/MIC of compound B alone. The FIC index value indicates which combinatorial composition produced the greatest change from the individual compound's MIC. For the present example, compound A was BAG8 and compound B was the biological agent.

### Fractional Inhibitory Concentration Determination for Combinations of Oxaborole and Farnesol as Biologic Agent

Initially, the Fractional Inhibitory Concentration (FICs) were determined in a final volume of 0.2 mL/well on 96-well plates with the oxaborole compound concentrations of 0-12.8 μg/mL (9 serial dilutions starting from left at 12.8 μg/mL [12.8, 6.4, 3.2, 1.6, 0.8, 0.4, 0.2, 0.1, and 0 μg/mL], Farnesol concentration of 0-128 μg/mL (7 serial dilutions starting from top at 128, 64, 32, 16, 8, 4, and 0 μg/mL]. Final concentration of fungal spores/visible fragment mycelia was 5×10⁴ CFU/mL. There were three replicates per assay.

Plates sealed with clear polyester film (VWR) were incubated at a temperature of about 25° C. The progress of fungal growth was monitored at 72 hours. The MICs were determined as the lowest antifungal concentrations that completely inhibited fungal growth (no visible growth) or the concentrations that inhibited fungal growth by greater than 95% (determined as relative absorbance using the Bio-Tek® PowerWave™ HT microplate reader at 600 nm) relative to the corresponding antifungal-free control.

Fractional Inhibitory Concentration Determination for Combinations of Oxaborole and Extract of Bacillus subtilis as Biologic Agent

Extract of Bacillus subtilis was prepared as follows: the bacteria Bacillus subtilis QST 713 (NRRL B-21661) was cultured in 2 liters of half-strength LB broth. After 3-4 days of growth, the culture was centrifuged at 8,000 rpm for 10 minutes. The supernatant and pellet were collected separately. The pellet was resuspended in a small amount of supernatant (5 mL per gram fresh weight) and homogenized in a blender, followed by centrifugation at 8,000 rpm for 10 minutes. The supernatant was filtered through a sterilized filter (0.25 μm). The bacillus subtilis extract was diluted with water to the desired concentration for the FIC determination.

The Fractional Inhibitory Concentration (FICs) were determined in a final volume of 0.2 mL/well on 96-well plates with the oxaborole compound concentrations of 0-12.8 μg/mL (9 serial dilutions starting from left at 12.8 μg/mL [12.8, 6.4, 3.2, 1.6, 0.8, 0.4, 0.2, 0.1, and 0 μg/mL], Bacillus subtilis extract of concentration of 0-80% (6 serial dilutions starting from top at 80%, 40%, 20%, 10%, 5%, and 0%]. Final concentration of fungal spores/visible fragment mycelia was 5×10⁴ CFU/mL. There were three replicates per assay.

Plates sealed with clear polyester film (VWR) were incubated at a temperature of about 25° C. The progress of fungal growth was monitored at 72 hours. The MICs were determined as the lowest antifungal concentrations that completely inhibited fungal growth (no visible growth) or the concentrations that inhibited fungal growth by greater than 95% (determined as relative absorbance using the Bio-Tek® PowerWave™ HT microplate reader at 600 nm) relative to the corresponding antifungal-free control.

### Fractional Inhibitory Concentration Determination for Combinations of Oxaborole and Extract of Trichoderma Harzianumas Biologic Agent

Extract of Trichoderma harzianum was prepared as follows: the beneficial Trichoderma harzianum Rifai T-22 (NRRL 22850) was cultured in 2 litres of half-strength PDB broth. After 5-7 days of growth, the culture was centrifuged at 8,000 rpm for 10 minutes. The supernatant and pellet were collected separately. The pellet was resuspended in a small amount of supernatant (5 mL per gram fresh weight) and homogenized in a blender, followed by centrifugation at 8,000 rpm for 10 minutes. The supernatant was filtered through a sterilized filter (0.25 μm). The Trichoderma harzianum extract was diluted with water to the desired concentration for the FIC determination.

The Fractional Inhibitory Concentration (FICs) were determined in a final volume of 0.2 mL/well on 96-well plates with the oxaborole compound concentrations of 0-12.8 μg/mL (9 serial dilutions starting from left at 12.8 μg/mL [12.8, 6.4, 3.2, 1.6, 0.8, 0.4, 0.2, 0.1, and 0 μg/mL], Trichoderma harzianum extract of concentration of 0-80% (6 serial dilutions starting from top at 80%, 40%, 20%, 10%, 5%, and 0%]. Final concentration of fungal spores/visible fragment mycelia was 5×10⁴ CFU/mL. There were three replicates per assay.

Plates sealed with clear polyester film (VWR) were incubated at a temperature of about 25° C. The progress of fungal growth was monitored at 72 hours. The MICs were determined as the lowest antifungal concentrations that completely inhibited fungal growth (no visible growth) or the concentrations that inhibited fungal growth by greater than 95% (determined as relative absorbance using the Bio-Tek® PowerWave™ HT microplate reader at 600 nm) relative to the corresponding antifungal-free control.

Fractional Inhibitory Concentration Determination for Combinations of Oxaborole and Extract of Reynoutria sachalinensis as Biologic Agent

Extract of Reynoutria sachalinensis was purchased from Marrone Bio Innovations (Regalia Biofungicide). The Reynoutria sachalinensis extract was diluted with water to the desired concentration for the FIC determination.

The Fractional Inhibitory Concentration (FICs) were determined in a final volume of 0.2 mL/well on 96-well plates with the oxaborole compound concentrations of 0-12.8 μg/mL (9 serial dilutions starting from left at 12.8 μg/mL [12.8, 6.4, 3.2, 1.6, 0.8, 0.4, 0.2, 0.1, and 0 μg/mL], Reynoutria sachalinensis extract of concentration of 0-1% (6 serial dilutions starting from top at 1%, 0.5%, 0.25%, 0.125%, 0.0625%, and 0%]. Final concentration of fungal spores/visible fragment mycelia was 5×10⁴ CFU/mL. There were three replicates per assay.

Plates sealed with clear polyester film (VWR) were incubated at a temperature of about 25° C. The progress of fungal growth was monitored at 72 hours. The MICs were determined as the lowest antifungal concentrations that completely inhibited fungal growth (no visible growth) or the concentrations that inhibited fungal growth by greater than 95% (determined as relative absorbance using the Bio-Tek® PowerWave™ HT microplate reader at 600 nm) relative to the corresponding antifungal-free control.

The table below lists the FIC values calculated for different combinations of BAG8 and biologic agents, and it shows that the observed activity of the combinatorial compositions (i.e. BAG8 and Farnesol, BAG8 and extract of Reynotria sachalinensis, BAG8 and extract of Bacillus subtilis) is not greater than the calculated FIC of 1, indicating the combination of oxaborole and extraction from plants (i.e. Farnesol and Reynotria sachalinensis) and beneficial microbes (i.e. Bacillus subtilis) provide synergistic or additive activities against fungal pathogens. More specifically, the combinatorial mixture of BAG8 and extract of Reynotria sachalinensis demonstrated clear synergistic effect for inhibiting the growth of FOC.TR4 and B05.10 fungi, and moderate synergistic effect for Ss1980 fungi strain. The combinatorial mixture of BAG8 and extract of Bacillus subtilis demonstrated clear synergistic effect for inhibiting the growth of SLB and Ss1980 fungi strains, and moderate synergistic effect for FOC.TR4 fungi strain. The combinatorial mixture of BAG8 and farnesol demonstrated clear synergistic effect for inhibiting the growth of SLB fungi, and moderate synergistic effect for other three fungal species. Interestingly, the combinatorial mixture of BAG8 and extract of Trichoderma harzianum (a fungi) demonstrated no synergistic effect in controlling the growth of all the fungi species tested. In fact, BAG8 seemed to have an antagonistic effect with extract of Trichoderma harzianum.

Overall, the results show that a combinatorial composition of BAG8 with extracts from bacteria (eg. Bacillus subtilis) or plants (eg. as farnesol or from Reynoutria sachalinensis) can achieve synergistic and beneficial effect for controlling the growth of fungal pathogens. However, a combinatorial composition of BAG8 with extracts from fungi (eg. Trichoderma harzianum) generates antagonistic and undesirable effects for the ability to control the growth of fungal pathogens.

| | SLB | FOC.TR4 | Ss1980 | B05.10 |
|---|---|---|---|---|
| BAG8/Farnesol | 0.50 | 0.75 | 0.88 | 0.75 |
| BAG8 and extract of | 0.50 | 0.75 | 0.56 | 1.00 |
| Bacillus subtilis | | | | |
| BAG8 and extract of | 1.00 | 0.50 | 0.75 | 0.56 |
| Reynoutria sachalinensis | | | | |
| BAG8 and extract of | 1.25 | 1.75 | 1.50 | 2.13 |
| Trichoderma harzianum | | | | |

### Example 3: Combination of the Oxaborole Compound with Live Beneficial Bacterium, Bacillus subtilis

The synergistic or additive effect of Bacillus subtilis in combination with an oxaborole compound on fungicidal compounds was evaluated by determining the inhibition rate of fungal growth on a petri dish. The oxaborole compound used for the example was BAG8. The inhibition rate was calculated as: inhibition %=(X−Y)/X*100, where X is the diameter of fungal hyphae grown on control without any fungicidal compound or beneficial bacteria. Inhibition rate of 100% means that the fungus did not grow on PDA medium.

Preparation of Bacillus subtilis Culture

Bacillus subtilis culture was prepared as follows: cryogenic bacteria Bacillus subtilis QST 713 (NRRL B-21661) was streaked on LB agar medium and incubated at 37° C. overnight. One colony on LB agar medium was picked and cultured in 1 liter of half-strength LB broth. After 1 days of growth, the culture was centrifuged at 8,000 rpm for 10 minutes. The pellet was collected and rinsed twice in sterilized water, followed by resuspension in sterilized water at 1×10⁸ CFU/mL.

Determination of the Toxicity of Oxaborole Compound on Bacillus subtilis

The MIC was determined in triplicate in a final volume of 0.2 mL/well with oxaborole concentrations of 0-25 μg/mL (8 serial dilutions down from 25 μg/mL [25, 12.5, 6.25, 3.25, 1.56, 0.78, 0.39 and 0.20 μg/mL].) Control studies with 0 μg/mL of the BAG8 compound were performed in parallel for each plate. The final concentration of Bacillus subtilis was 1×10⁵ CFU/mL.

Plates sealed with clear polyester film (VWR) were incubated at a temperature of about 37° C. The progress of Bacillus subtilis growth was monitored at 48 hours. The MICs were determined as the lowest inhibition concentration that completely inhibited bacterial growth by greater than 95% (determined as relative absorbance using the Bio-Tek® PowerWave™ HT microplate reader at 600 nm) relative to the corresponding antibacterial-free control.

The tested oxaborole compound was barely toxic to Bacillus subtilis, but the MIC was above 25 ug/mL. Therefore, the tested combination concentration of oxaborole compound is less than 10 ug/mL which allows Bacillus subtilis to grow on the PDA medium.

### Preparation of Agar Plug Inoculum

In the example, fresh agar plugs of Botrytis cinerea B05.10 (B05.10), Fusarium oxysporum f sp. cubense tropical race 4 (FOC.TR4), Mycosphaerella graminicola (SLB), and Sclerotinia sclerotiorum 1980 (Ss1980) were prepared as follows:

Cryogenic fungal stocks were withdrawn from −80° C., the stocks were streaked on PDA petri dishes in the microbiological safety cabinet and inoculated for 4-7 days at room temperature in 12/12 hour (light/dark);

A piece of fungal agar was cut from PDA medium and transferred onto new PDA petri dishes, and incubated for 4 to 7 days at 22° C. under continuous light;

Fresh agar plug inoculum were produced by cutting the edge of the hypha on PDA petri dishes using coker borer (diameter of 3/16 inch).

Growth Inhibition of Bacillus subtilis on Fungal Pathogens

The ability of Bacillus subtilis to inhibit growth of the four example fungal pathogens was evaluated by determining the inhibition rate of fungal hyphae on the PDA petri dishes (diameter of 100 mm) with the bacteria (initial bacterial cells: 2000CFU). 0.2 mL of Bacillus subtilis (lx 10³, 1×10⁴, 1×10⁵, 1×10⁶FU/mL) was spread on the PDA plates. The plates were cultured at 37° C. overnight, followed by inoculating the fresh fungal agar plugs ( 3/16 inch, diameter). The PDA plates with fungal agar plugs were cultured at 25° C. for 4-7 days, and then diameters of hyphae were measured. The inhibition rate was calculated as: inhibition %=(X−Y)/X*100, where X is the diameter of fungal hyphae grown on control without the bacteria. Inhibition rate of 100% means that the fungus cannot grow on PDA medium.

Bacillus subtilis [0.2 mL of 1×10³, 1×10⁴CFU/mL on the 100 mm (diameter) petri dish] doesn't completely inhibit the growth of the tested fungal pathogens (<50% inhibition) on PDA plates. Since 0.2 mL of 1×10⁴CFU/mL Bacillus subtilis subtilis formed even bacterial lawns on the 100 mm (diameter) petri dishes after 24 hours incubate at 25 0C, 0.2 mL of 1×10⁴ CFU/mL Bacillus subtilis per 100 mm petri dish was used in the combination assay.

Bacillus subtilis inhibited all four example fungal pathogens. The inhibition rates of Bacillus subtilis on Botrytis cinerea B05.10 (B05.10), Fusarium oxysporum f sp. cubense tropical race 4 (FOC.TR4), Mycosphaerella graminicola (SLB), Sclerotinia sclerotiorum 1980 (Ss1980) were 45%, 53%, 24% and 38%, respectively.

### Fungal Growth Inhibition of the Combinatorial Compositions

Testing was performed to compare inhibition performance of BAG8 by itself versus BAG8 in combination with Bacillis subtilis. Initially, the PDA plates (diameter of 100 mm) were prepared with various concentrations (0, 0.2, 0.5, 1, 2, 5 and 10 ug/mL) of the BAG8 compound;

Then, 0.2 mL of Bacillus subtilis (1×10⁴CFU/mL) were spread onto some of the PDA plates with fungicide compounds. The fungicide compounds were Botrytis cinerea, Fusarium oxysporum f sp. Cubense, Mycosphaerella graminicola, and Sclerotinia sclerotiorum.

The PDA plates with the combined BAG8 and Bacillus subtilis were inoculated with the fresh fungal agar plugs ( 3/16 inch, diameters) and the plates were cultured at 25° C. for 4-7 days, and then diameters of hyphae were measured. The inhibition rate was calculated as: inhibition %=(X−Y)/X*100, where X is the diameter of fungal hyphae grown on control without the bacteria. Inhibition rate of 100% means that the fungus did not grow on PDA medium.

The table below shows that the inhibition rates of the combination of oxaborole (≤0.5 ug/mL) and Bacillus subtilis on four example fungal pathogens are greater than the individual inhibition rates. Therefore, the addition of Bacillus subtilis to create a mixture significantly improves the efficacy of the synthetic oxaborole compounds such that the MIC is below the MIC of the oxaborole compound alone. For example, for Sclerotinia sclerotiorum, when the concentration of BAG8 was 2 ug/mL, the inhibition rate was essentially the same whether BAG8 was combined with Bacillus subtilis or not (98% vs. 99%). Remarkably, when the concentration of BAG8 was 0.2 ug/mL, the inhibition rate was only 12%; however, when BAG8 was combined with Bacillus subtilis, the inhibition rate increased to 99%.

| | Botrytis | | Fusarium | | | | | |
|---|---|---|---|---|---|---|---|---|
| | cinerea | | oxysporum f. sp. | | Mycosphaerella | | Sclerotinia | |
| | Bacillus | | cubense | | graminicola | | sclerotiorum | |
| BAG8 | Subtilis | | Bacillus Subtilis | | Bacillus Subtilis | | Bacillus Subtilis | |
| (ug/mL) | − | + | − | + | − | + | − | + |
| 2 | 98 | 95 | 94 | 94 | 96 | 95 | 98 | 99 |
| 1 | 69 | 94 | 95 | 93 | 93 | 94 | 94 | 99 |
| 0.5 | 23 | 93 | 47 | 94 | 38 | 95 | 48 | 98 |
| 0.2 | 10 | 85 | 9 | 79 | 6 | 78 | 12 | 99 |

*Note:
the values in the above table are % inhibition of fungal growth. The values have an uncertainty of plus or minus 2%.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combinations.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

A number of embodiments of the present disclosure have been described. While this specification contains many specific implementation details, the specific implementation details should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

In certain implementations, multitasking and parallel processing may be advantageous. Nevertheless, it will be understood that various modifications may be made without departing from the spirit and scope of the claimed disclosure.

1. A combinatorial composition comprising a compound that is a leucyl-tRNA synthetase inhibitor and at least one biological agent, wherein the combinatorial composition is effective for treating or controlling a pathogen.

2. The combinatorial composition of claim 1, wherein the at least one biological agent is selected from the group consisting of: Acetobacteraceae, Bacillacaeae, Bacteriodaceae, Bifidobacteriaceae, Burkholderiaceae, Clostridiaceae, Enterobacteriaceae, Eubacteriaceae, Lactobacillaceae, Methanobacteriaceae, Nocardiaceae, Paenibacillaceae, Pasteuriaceae, Prevotellaceae, Pseudomonadaceae, Rhizobiaceae, Ruminococcaceae, Saccharomycetaceae, Sphingomonadaceae, Streptoccaceae, Clavicipitaceae, Cordycipitaceae, Entomophthoraceae, Hypocreaceae, Ophiocorycipitaceae, Phaeophaeriaceae, Synchytriaceae, and Trichocomaceae, or a metabolite or a secondary metabolite produced therefrom.

3. The combinatorial composition of claim 1, wherein the at least one biological agent is selected from the group consisting of Bacteroides (e.g., Alistipes, Prevotella, Paraprevotella, Parabacteroides, Odoribacter), Bacillus, Bifidobacterium, Clostridioides, Eubacterium, Escherichia, Faecalibacterium, Haemophilus, Heliobacter (H. pylori), Lactobacillus, Prevotella, Streptococcus/Lactococcus. Alternaria, Ampelomyces, Aspergillus, Aureobasidium, Beauveria, Candida, Isaria, Lecanicillium, Metarhizium, Phlebiopsis, Ulocladium, Phytophthora, and Fallopia, or a metabolite or a secondary metabolite produced therefrom.

4. The combinatorial composition of claim 1, wherein the at least one biological agent is selected from Bacillacaeae, and metabolites or secondary metabolites produced therefrom.

5. The combinatorial composition of claim 1, wherein the at least one biological agent comprises the metabolite or the secondary metabolite.

6. The combinatorial composition of claim 1, wherein the compound is a benzoxaborole.

7. The combinatorial composition of claim 1, wherein treating or controlling comprises providing a curative, inhibitive, ameliorative, reduction in, or preventative activity for phytopathogens, including fungi, bacteria, microorganisms, insects, and/or nematodes.

8. The combinatorial composition of claim 1, wherein:
a ratio of the minimum inhibitory concentration (MIC) of the compound alone to the concentration of the compound in the combinatorial composition is greater than about 1.6, or
a ratio of the minimum inhibitory concentration (MIC) of the at least one biological agent alone to the concentration of the at least one biological agent in the combinatorial composition is greater than about 1.6.

9. A combinatorial composition comprising a benzoxaborole and at least one biological agent.

10. The combinatorial composition of claim 9, wherein the benzoxaborole has a structure, I: 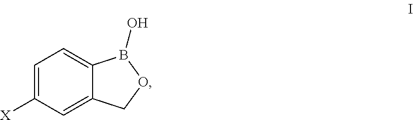
wherein:
X is a substituent having a Hammett sigma value for a meta substituent that is greater (more positive) than about −0.1,
or a salt, agricultural chemical salt, pharmaceutical salt, stereoisomer, enantiomer, or tautomer thereof.

11. The combinatorial composition of claim 10, wherein X is H, C1-C6 hydrocarbyl or a halogen, or a salt, agricultural chemical salt, pharmaceutical salt, stereoisomer, enantiomer, or tautomer thereof.

12. The combinatorial composition of claim 10, wherein X is a halogen or hydrogen, or a salt, agricultural chemical salt, pharmaceutical salt, stereoisomer, enantiomer, or tautomer thereof.

13. The combinational composition of claim 10, wherein the halogen is Cl, Br, I, or F, or a salt, agricultural chemical salt, pharmaceutical salt, stereoisomer, enantiomer, or tautomer thereof.

14. The combinatorial composition of claim 9, wherein the at least one biological agent is selected from the group consisting of: Acetobacteraceae, Bacillacaeae, Bacteriodaceae, Bifidobacteriaceae, Burkholderiaceae, Clostridiaceae, Enterobacteriaceae, Eubacteriaceae, Lactobacillaceae, Methanobacteriaceae, Nocardiaceae, Paenibacillaceae, Pasteuriaceae, Prevotellaceae, Pseudomonadaceae, Rhizobiaceae, Ruminococcaceae, Saccharomycetaceae, Sphingomonadaceae, Streptoccaceae, Clavicipitaceae, Cordycipitaceae, Entomophthoraceae, Hypocreaceae, Ophiocorycipitaceae, Phaeophaeriaceae, Synchytriaceae, and Trichocomaceae, or a metabolite or a secondary metabolite produced therefrom.

15. The combinatorial composition of claim 9, wherein the at least one biological agent is selected from the group consisting of Bacteroides (e.g., Alistipes, Prevotella, Paraprevotella, Parabacteroides, Odoribacter), Bacillus, Bifidobacterium, Clostridioides, Eubacterium, Escherichia, Faecalibacterium, Haemophilus, Heliobacter (H. pylori), Lactobacillus, Prevotella, Streptococcus/Lactococcus. Alternaria, Ampelomyces, Aspergillus, Aureobasidium, Beauveria, Candida, Isaria, Lecanicillium, Metarhizium, Phlebiopsis, Ulocladium, Phytophthora, and Fallopia, or a metabolite or a secondary metabolite produced therefrom.

16. The combinatorial composition of claim 9, wherein the at least one biological agent is selected from the group consisting of a metabolite or secondary metabolite produced from one or more of the following: Acetobacteraceae, Bacillacaeae, Bacteriodaceae, Bifidobacteriaceae, Burkholderiaceae, Clostridiaceae, Enterobacteriaceae, Eubacteriaceae, Lactobacillaceae, Methanobacteriaceae, Nocardiaceae, Paenibacillaceae, Pasteuriaceae, Prevotellaceae, Pseudomonadaceae, Rhizobiaceae, Ruminococcaceae, Saccharomycetaceae, Sphingomonadaceae, Streptoccaceae, Propionibacteriaceae, Syncephalastraceae, Fucaceae, Caulerpaceae, Chlorellaceae, Durvillaeaceae, Lessoniaceae, Ulvaceae, Gelidiaceae, Gracilariaceae, Himanthaliaceae, Cystocloniaceae, Solieriaceae, Laminariaceae, Dictyotaceae, Sargassaceae, Spirulinaceae, Clavicipitaceae, Cordycipitaceae, Entomophthoraceae, Hypocreaceae, Ophiocorycipitaceae, Phaeophaeriaceae, Synchytriaceae, and Trichocomaceae.

17. The combinatorial composition of claim 9, wherein the at least one biological agent comprises a metabolite produced from bacteria, fungi, microorganisms, or plant material.

18. The combinatorial composition of claim 15, wherein the metabolite is produced from Bacillus.

19. The combinatorial composition of claim 9, wherein:
a ratio of a minimum inhibitory concentration (MIC) of the compound alone to the concentration of the compound in the combinatorial composition is greater than about 1.6, or
a ratio of the minimum inhibitory concentration (MIC) of the at least one biological agent alone to the concentration of the at least one biological agent in the combinatorial composition is greater than about 1.6.

20. The combinatorial composition of claim 9, which is effective for treating or controlling a pathogen.

21. The combinatorial composition of claim 20, wherein treating or controlling comprises providing a curative, inhibitive, ameliorative, reduction in, or preventative activity for phytopathogens, including fungi, bacteria or microorganisms, insects, and/or nematodes.

22. The combinatorial composition of claim 1, wherein the composition is applied to seed, soil, plant, plant part, or plant propagation material, and controls a pathogen.

23. The combinatorial composition of claim 22, wherein the pathogen is an insect, nematode, bacteria, or fungi.

24. The combinatorial composition of claim 22, wherein the pathogen is phytopathogenic fungi.

25. The combinatorial composition of claim 1, wherein the composition is applied to seed, soil, plant, plant part, or plant propagation material, and provides a growth effect.

26. The combinatorial composition of claim 1, wherein the composition is administered to an animal and controls a pathogen.

27. The combinatorial composition of claim 26, wherein the pathogen is an endoparasite and/or an ectoparasite.

28. The combinatorial composition of claim 1, wherein the composition is applied to seed, plant, harvested fruits and vegetables, post-harvest, the soil, the plant's locus of growth, pre-emergence, post-emergence, habitat, or storage space.

29. The combinatorial composition of claim 1, wherein the application of the composition is topical, to the soil, foliar, a foliar spray, systemic, seed coating, soil drench, direct in-furrow dipping, drenching, soil drenching, spraying, atomizing, irrigating, evaporating, dusting, fogging, broadcasting, foaming, painting, spreading-on, watering (drenching), or drip irrigating.

30. A method of controlling a pathogen comprising applying the combinatorial composition of claim 1 to seed, soil, plant, plant part, harvested fruit and vegetables, or plant propagation material.

31. A method of controlling a pathogen comprising applying the combinatorial composition of claim 1 to seed, soil, plant, plant part, harvested fruit and vegetables, or plant propagation material, and provides a growth affect.

32. A method of controlling a pathogen comprising administering an effective amount of the combinatorial composition of claim 1 to an animal.
